(19) United States
(12) Patent Application Publication
(10) Pub. No.: US 2023/0297684 A1
(43) Pub. Date: Sep. 21, 2023

(54) GENERATION OF DESIRED DATA FOR EVALUATION OF AT LEAST A PORTION OF A SYSTEM

(71) Applicant: UncommonX Inc., Chicago, IL (US)

(72) Inventors: Raymond Hicks, Chicago, IL (US); Ryan Michael Pisani, Burlington, WI (US)

(73) Assignee: UncommonX Inc., Chicago, IL (US)

(21) Appl. No.: 17/651,551

(22) Filed: Feb. 17, 2022

(51) Int. Cl. G06F 21/57; G06F 21/62

(52) U.S. Cl. CPC G06F 21/577; G06F 21/6227

(57) ABSTRACT

A method includes obtaining data gathering parameters regarding an analysis of a system. The method further includes identifying a system aspect and an evaluation viewpoint of desired for the system aspect from the data gathering parameters. The method further includes identifying one or more types of proficiency data regarding the system aspect and the evaluation viewpoint of desired. The method further includes identifying one or more sources for retrieving the one or more types of proficiency data to produce source identification parameters and establishing proficiency data retrieval parameters based on the one or more types of proficiency data and the source identification parameters. The method further includes obtaining proficiency data based on the proficiency data retrieval parameters, analyzing the proficiency data to determine relevant characteristics of the relevant proficiency data, and generating desired data based on the relevant characteristics. The desired data includes relevant characteristics of the relevant proficiency data.

### STATEMENT REGARDING FEDERALLY SPONSORED RESEARCH OR DEVELOPMENT

Not Applicable.

### INCORPORATION-BY-REFERENCE OF MATERIAL SUBMITTED ON A COMPACT DISC

Not Applicable.

### BACKGROUND OF THE INVENTION

### Technical Field of the Invention

This disclosure relates to computer systems and more particularly to evaluation of a computer system.

### DESCRIPTION OF RELATED ART

The structure and operation of the Internet and other publicly available networks are well known and support computer systems (systems) of multitudes of companies, organizations, and individuals. A typical system includes networking equipment, end point devices such as computer servers, user computers, storage devices, printing devices, security devices, and point of service devices, among other types of devices. The networking equipment includes routers, switches, edge devices, wireless access points, and other types of communication devices that intercouple in a wired or wireless fashion. The networking equipment facilitates the creation of one or more networks that are tasked to service all or a portion of a company’s communication needs, e.g., Wide Area Networks, Local Area Networks, Virtual Private Networks, etc.

Each device within a system includes hardware components and software components. Hardware components degrade over time and eventually are incapable of performing their intended functions. Software components must be updated regularly to ensure their proper functionality. Some software components are simply replaced by newer and better software even though they remain operational within a system.

Many companies and larger organizations have their own Information Technology (IT) departments. Others outsource their IT needs to third party providers. The knowledge requirements for servicing a system typically outstrip the abilities of the IT department or third-party provider. Thus, hardware and software may not be functioning properly and can adversely affect the overall system.

Cyber-attacks are initiated by individuals or entities with the bad intent of stealing sensitive information such as login/password information, stealing proprietary information such as trade secrets or important new technology, interfering with the operation of a system, and/or holding the system hostage until a ransom is paid, among other improper purposes. A single cyber-attack can make a large system inoperable and cost the system owner many millions of dollars to restore and remedy.

### BRIEF DESCRIPTION OF THE SEVERAL VIEWS OF THE DRAWING(S)

The patent or application file contains at least one drawing executed in color. Copies of this patent or patent application publication with color drawing(s) will be provided by the Office upon request and payment of the necessary fee.

FIG. 1 is a schematic block diagram of an embodiment of a networked environment that includes systems coupled to an analysis system;

FIGS. 2A - 2D are schematic block diagrams of embodiments of a computing device;

FIGS. 3A - 3E are schematic block diagrams of embodiments of a computing entity;

FIG. 4 is a schematic block diagram of another embodiment of a networked environment that includes a system coupled to an analysis system;

FIG. 5 is a schematic block diagram of another embodiment of a networked environment that includes a system coupled to an analysis system;

FIG. 6 is a schematic block diagram of another embodiment of a networked environment that includes a system coupled to an analysis system;

FIG. 7 is a schematic block diagram of another embodiment of a networked environment that includes a system coupled to an analysis system;

FIG. 8 is a schematic block diagram of another embodiment of a networked environment having a system that includes a plurality of system elements;

FIG. 9 is a schematic block diagram of an example of a system section of a system selected for evaluation;

FIG. 10 is a schematic block diagram of another example of a system section of a system selected for evaluation;

FIG. 11 is a schematic block diagram of an embodiment of a networked environment having a system that includes a plurality of system assets coupled to an analysis system;

FIG. 12 is a schematic block diagram of an embodiment of a system that includes a plurality of physical assets coupled to an analysis system;

FIG. 13 is a schematic block diagram of another embodiment of a networked environment having a system that includes a plurality of system assets coupled to an analysis system;

FIG. 14 is a schematic block diagram of another embodiment of a system that includes a plurality of physical assets coupled to an analysis system;

FIG. 15 is a schematic block diagram of another embodiment of a system that includes a plurality of physical assets coupled to an analysis system;

FIG. 16 is a schematic block diagram of another embodiment of a system that includes a plurality of physical assets;

FIG. 17 is a schematic block diagram of an embodiment of a user computing device;

FIG. 18 is a schematic block diagram of an embodiment of a server;

FIG. 19 is a schematic block diagram of another embodiment of a networked environment having a system that includes a plurality of system functions coupled to an analysis system;

FIG. 20 is a schematic block diagram of another embodiment of a system that includes divisions, departments, and groups;

FIG. 21 is a schematic block diagram of another embodiment of a system that includes divisions and departments, which include system elements;

FIG. 22 is a schematic block diagram of another embodiment of a division of a system having departments, which include system elements;

FIG. 23 is a schematic block diagram of another embodiment of a networked environment having a system that includes a plurality of security functions coupled to an analysis system;

FIG. 24 is a schematic block diagram of an embodiment an engineering department of a division that reports to a corporate department of a system;

FIG. 25 is a schematic block diagram of an example of the functioning of an analysis system evaluating a system element under test of a system;

FIG. 26 is a schematic block diagram of another example of the functioning of an analysis system evaluating a system element under test of a system;

FIG. 27 is a diagram of another example of evaluation options of an analysis system for evaluating a system element under test of a system;

FIG. 28 is a diagram of another example of evaluation options of an analysis system for evaluating a system element under test of a system;

FIG. 29 is a diagram of another example of evaluation options of an analysis system for evaluating a system element under test of a system;

FIG. 30 is a schematic block diagram of an embodiment of an analysis system coupled to a system;

FIG. 31 is a schematic block diagram of an embodiment of a data analysis module of an analysis system;

FIG. 32 is a schematic block diagram of an embodiment of an analyze and score module of an analysis system;

FIG. 33 is a diagram of an example of system aspects, evaluation aspects, evaluation rating metrics, and analysis system output options of an analysis system for analyzing a section of a system;

FIG. 34 is a schematic block diagram of an embodiment of an analysis system;

FIG. 35 is a schematic block diagram of an embodiment of a data input module of an analysis system;

FIG. 36 is a logic diagram of an example of a method of generating desired data for an evaluation of a system aspect;

FIG. 37 is a diagram of an example of system aspect, evaluation aspect, evaluation rating metric, and analysis system output options of an analysis system;

FIG. 38 is a diagram of an example of generating proficiency data retrieval parameters;

FIG. 39 is a diagram of an example of extracting system proficiency data;

FIG. 40 is a diagram of an example of generating desired data for an evaluation;

FIG. 41 is a schematic block diagram of an embodiment of a data input module;

FIG. 42 is a logic diagram of an example of a method of generating desired data for an evaluation of a system aspect;

FIG. 43 is a schematic diagram of an embodiment of a proficiency data retrieval parameter module;

FIG. 44 is a logic diagram of an example of a method of determining whether to gather general proficiency data or situational proficiency data for an evaluation of a system aspect;

FIG. 45 is a schematic block diagram of an embodiment of a normalized model generation module;

FIG. 46 is a schematic block diagram of an embodiment of a normalized model characteristics generation module;

FIG. 47 is a schematic block diagram of an embodiment of a system aspect characteristic identification module;

FIG. 48 is a schematic block diagram of an embodiment of a comparison module of a situational or general proficiency data determination module;

FIG. 49 is a schematic block diagram of an embodiment of a system aspect characteristic identification module;

FIG. 50 is a schematic block diagram of an embodiment of a comparison module of a situational or general proficiency data determination module;

FIG. 51 is a schematic block diagram of an embodiment of a system aspect characteristic identification module;

FIG. 52 is a schematic block diagram of an embodiment of a comparison module of a situational or general proficiency data determination module;

FIG. 53 is a flowchart of an example of a method of identifying desired data parameters for desired data generation;

FIGS. 54A-54B are flowcharts of an example of a method of identifying desired data parameters for desired data generation;

FIG. 55 is a diagram of an example of a proficiency data retrieval parameter module;

FIG. 56 is a diagram of an example of a proficiency data retrieval parameter module;

FIG. 57 is a diagram of an example of a proficiency data retrieval parameter module;

FIG. 58 is a diagram of an example of a proficiency data retrieval parameter module;

FIG. 59 is a diagram of an example of a proficiency data retrieval parameter module;

FIG. 60 is a diagram of an example of a proficiency data retrieval parameter module;

FIG. 61 is a diagram of an example of a proficiency data retrieval parameter module;

FIG. 62 is a diagram of an example of a proficiency data retrieval parameter module;

FIG. 63 is a schematic block diagram of an embodiment of a data input module;

FIG. 64 is a schematic diagram of an example of a data input module;

FIG. 65 is a diagram of an example of determining trustworthiness of proficiency data;

FIGS. 66A-66B are diagrams of an example of adjusting an untrustworthy data set;

FIG. 67 is a flowchart of an example of a method of determining trustworthiness of proficiency data;

FIG. 68 is a diagram of an example of system aspect, evaluation aspect, evaluation rating metric, and analysis system output options of an analysis system;

FIG. 69 is a diagram of system elements, system modes, evaluation categories, and evaluation viewpoints for an evaluation;

FIG. 70 is a diagram of an example of an identify evaluation category;

FIG. 71 is a diagram of an example of a protect evaluation category;

FIG. 72 is a diagram of an example of a detect evaluation category;

FIG. 73 is a diagram of an example of a respond evaluation category;

FIG. 74 is a diagram of an example of a recover evaluation category;

FIG. 75 is a diagram of an example of extracting system proficiency data;

FIG. 76 is a diagram of an example of generating desired data for an evaluation;

FIG. 77 is a logic diagram of an example of a method of generating desired data for an evaluation of one or more security functions of a system element with respect to a set of evaluation categories; and

FIG. 78 is a logic diagram of an example of a method of generating desired data for an evaluation of one or more security functions of a system element with respect to a set of evaluation categories.

### DETAILED DESCRIPTION OF THE INVENTION

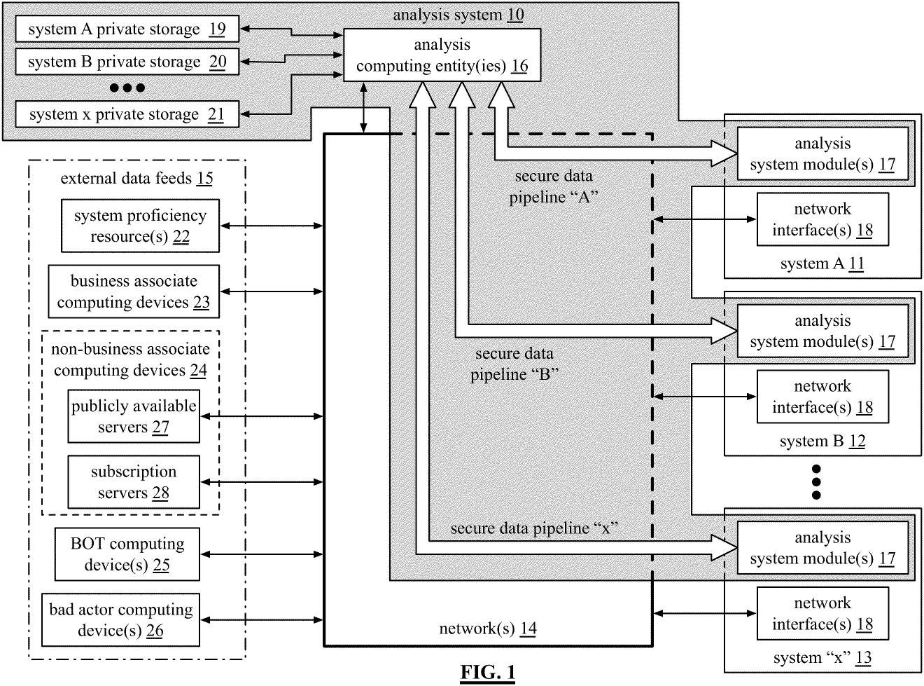

FIG. 1 is a schematic block diagram of an embodiment of a networked environment that includes one or more networks 14, external data feeds sources 15, a plurality of systems 11-13, and an analysis system 10. The external data feed sources 15 includes one or more system proficiency resources 22, one or more business associated computing devices 23, one or more non-business associated computing devices 24 (e.g., publicly available servers 27 and subscription-based servers 28), one or more BOT (i.e., internet robot) computing devices 25, and one or more bad actor computing devices 26. The analysis system 10 includes one or more analysis computing entities 16, a plurality of analysis system modules 17 (one or more in each of the systems 11-13), and a plurality of storage systems 19-21 (e.g., system A private storage 19, system B private storage 20, through system x private storage 21, and other storage). Each of the systems 11-13 includes one or more network interfaces 18 and many more elements not shown in FIG. 1.

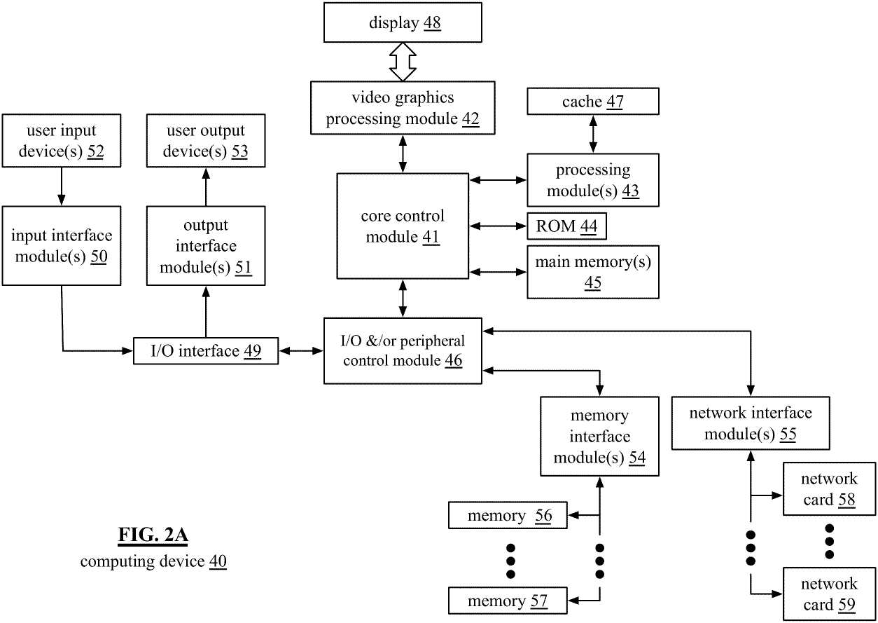

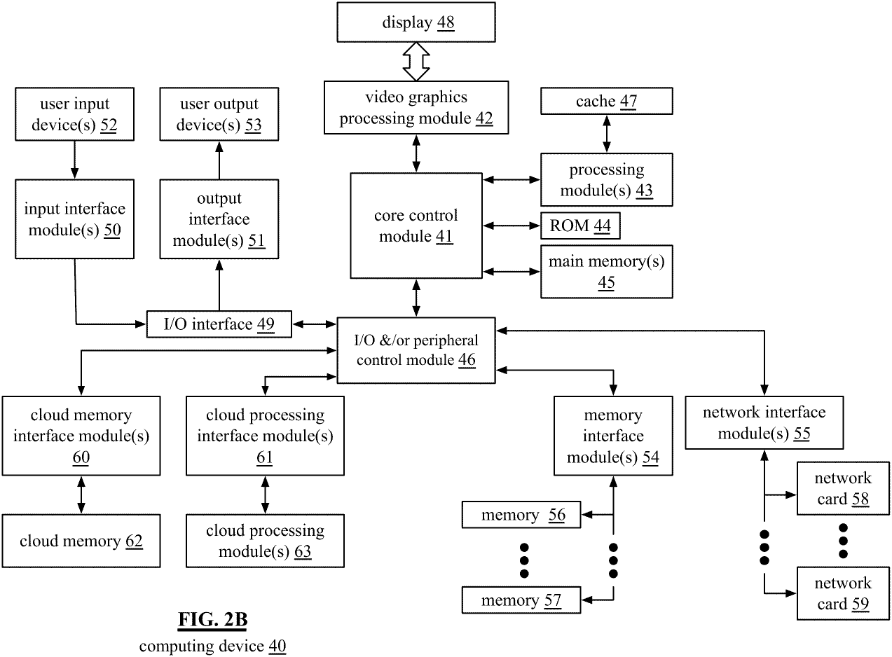

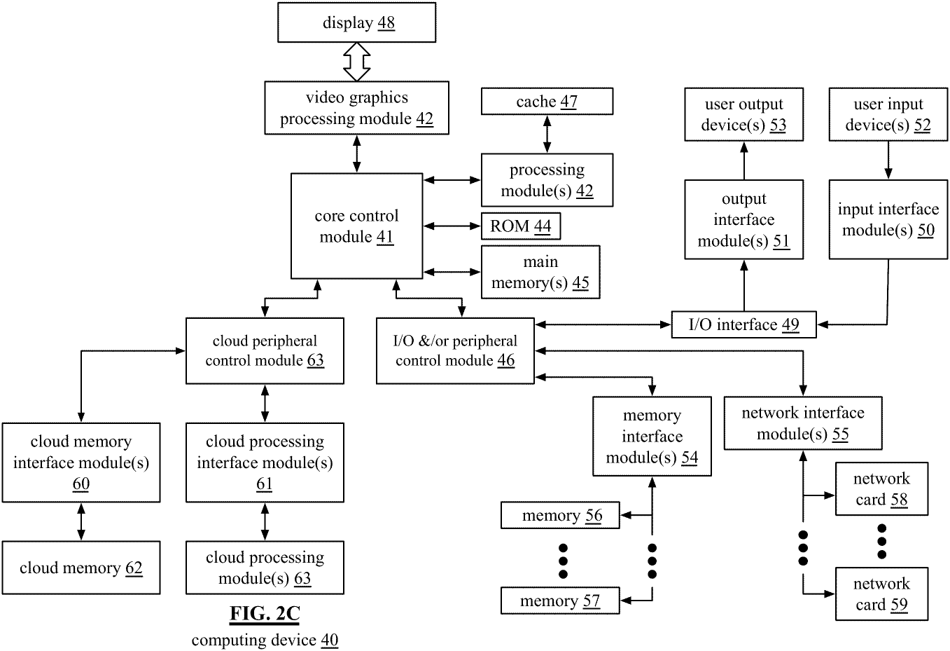

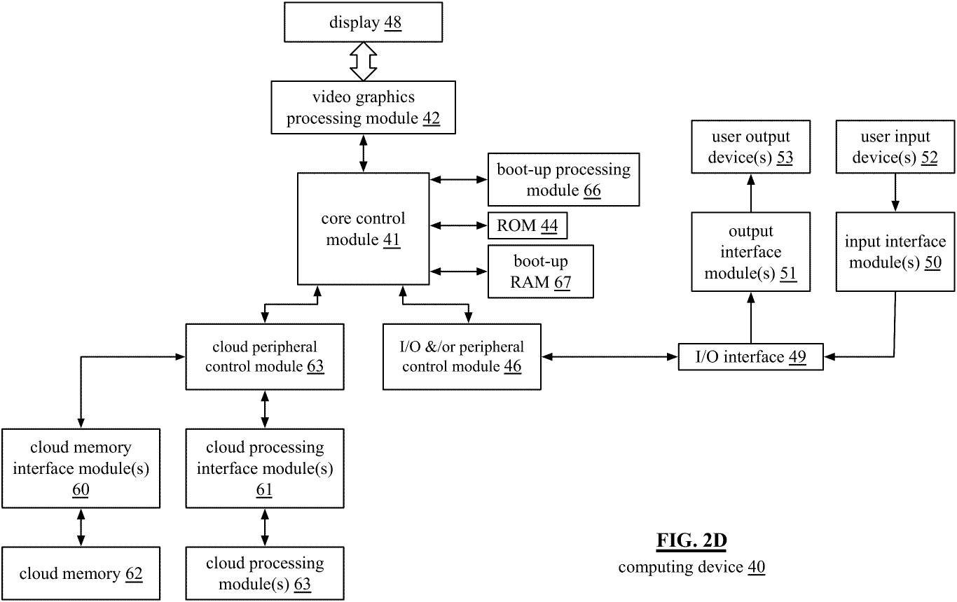

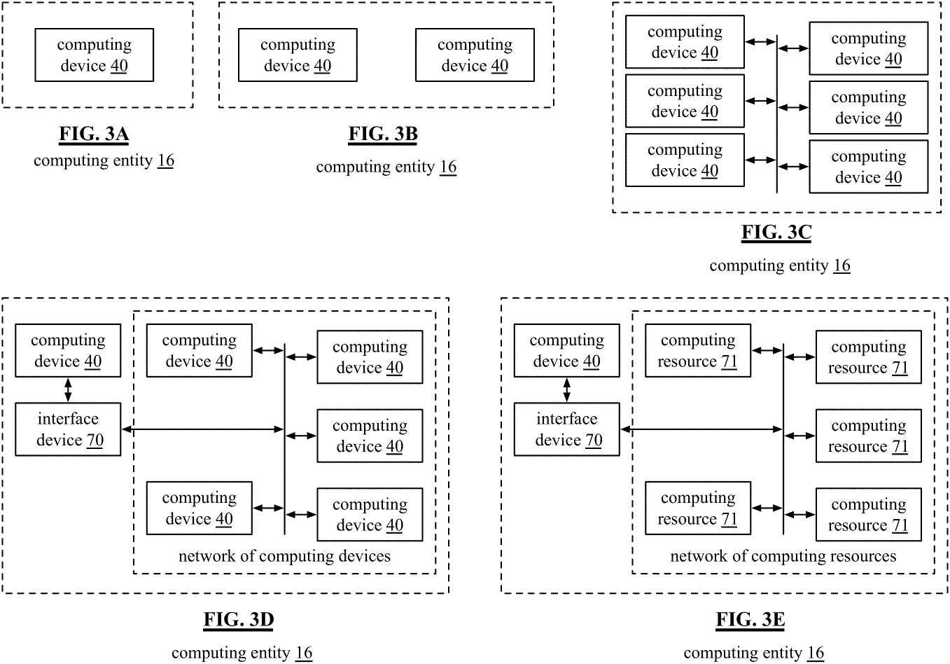

A computing device may be implemented in a variety of ways. A few examples are shown in FIGS. 2A - 2D. A computing entity may be implemented in a variety of ways. A few examples are shown in FIGS. 3A - 3E.

A storage system 19-21 may be implemented in a variety of ways. For example, each storage system is a standalone database. As another example, the storage systems are implemented in a common database. A database is a centralized database, a distributed database, an operational database, a cloud database, an object-oriented database, and/or a relational database. A storage system 19-21 is coupled to the analysis system 10 using a secure data pipeline to limit and control access to the storage systems. The secure data pipeline may be implemented in a variety of ways. For example, the secure data pipeline is implemented on a provided network of the analysis system and/or of a system under test. As another example, the secure data pipeline is implemented via the network 14 using access control, using network controls, implementing access and control policies, using encryption, using data loss prevention tools, and/or using auditing tools.

The one or more networks 14 includes one or more wide area networks (WAN), one or more local area networks (LAN), one or more wireless LANs (WLAN), one or more cellular networks, one or more satellite networks, one or more virtual private networks (VPN), one or more campus area networks (CAN), one or more metropolitan area networks (MAN), one or more storage area networks (SAN), one or more enterprise private networks (EPN), and/or one or more other type of networks.

In general, a system proficiency resource 22 is a source for data regarding best-in-class practices (for system requirements, for system design, for system implementation, and/or for system operation), governmental and/or regulatory requirements, security risk awareness and/or risk remediation information, security risk avoidance, performance optimization information, system development guidelines, software development guideline, hardware requirements, networking requirements, networking guidelines, and/or other system proficiency guidance. “Framework for Improving Critical Instructure Cybersecurity,” Version 1.1, Apr. 16, 2018 by the National Institute of Standards and Technology (NIST) is an example of a system proficiency in the form of a guideline for cybersecurity.

A business associated computing device 23 is one that is operated by a business associate of the system owner. Typically, the business associated computing device 23 has access to at least a limited portion of the system to which the general public does not have access. For example, the business associated computing device 23 is operated by a vendor of the organization operating the system and is granted limited access for order placement and/or fulfillment. As another example, the business associated computing device 23 is operated by a customer of the organization operating the system and is granted limited access for placing orders.

A non-business associated computing device 24 is a computing device operated by a person or entity that does not have a business relationship with the organization operating the system. Such non-business associated computing device 24 are not granted special access to the system. For example, a non-business associated computing device 24 is a publicly available server 27 to which a user computing device of the system may access. As another example, a non-business associated computing device 24 is a subscription-based server 28 to which a user computing device of the system may access if it is authorized by a system administrator of the system to have a subscription and has a valid subscription. As yet another example, the non-business associated computing device 24 is a computing device operated by a person or business that does not have an affiliation with the organization operating the system.

A bot (i.e., internet robot) computing device 25 is a computing device that runs, with little to no human interaction, to interact with a system and/or a computing device of a user via the internet or a network. There are a variety of types of bots. For example, there are social media bots, chatbots, bot crawlers, transaction bots, information bots, and entertainment bots (e.g., games, art, books, etc.).

A bad actor computing device 26 is a computing device operated by a person whose use of the computing device is for illegal and/or immoral purposes. The bad actor computing device 26 may employ a bot to execute an illegal and/or immoral purpose. In addition, or in the alternative, the person may instruct the bad actor computing device to perform the illegal and/or immoral purpose, such as hacking, planting a worm, planting a virus, stealing data, uploading false data, and so on.

The analysis system 10 is operable to evaluate a system 11-13, or portion thereof, in a variety of ways. For example, the analysis system 10 evaluates system A 11, or a portion thereof, by testing the organization’s understanding of its system, or portion thereof; by testing the organization’s implementation of its system, or portion thereof; and/or by testing the system’s, or portion thereof; operation. As a specific example, the analysis system 10 tests the organization’s understanding of its system requirements for the implementation and/or operation of its system, or portion thereof. As another specific example, the analysis system 10 tests the organization’s understanding of its software maintenance policies and/or procedures. As another specific example, the analysis system 10 tests the organization’s understanding of its cybersecurity policies and/or procedures.

There is an almost endless combination of ways in which the analysis system 10 can evaluate a system 11-13, which may be a computer system, a computer network, an enterprise system, and/or other type of system that includes computing devices operating software. For example, the analysis system 10 evaluates a system aspect (e.g., the system or a portion of it) based on an evaluation aspect (e.g., options for how the system, or portion thereof, can be evaluated) in view of evaluation rating metrics (e.g., how the system, or portion thereof, is evaluated) to produce an analysis system output (e.g., an evaluation rating, deficiency identification, and/or deficiency auto-correction).

The system aspect (e.g., the system or a portion thereof) includes a selection of one or more system elements of the system, a selection of one or more system criteria, and/or a selection of one or more system modes. A system element of the system is a physical asset of the system and/or a conceptual asset of the system. For example, a physical asset is a computing entity, a computing device, a user software application, a system software application (e.g., operating system, etc.), a software tool, a network software application, a security software application, a system monitoring software application, and the like. As another example, a conceptual asset is a hardware architectural layout, or portion thereof, and/or a software architectural layout, or portion thereof.

A system element may be identified in a variety of ways. For example, it is identifiable by its use and/or location within the organization. As a specific example, a system element is identified by an organizational identifier, a division of the organization identifier, a department of a division identifier, a group of a department identifier, and/or a sub-group of a group identifier. In this manner, if the entire system is to be evaluated, the organization identifier is used to select all of the system elements in the system. If a portion of the system is to be test based on business function, then a division, department, group, and/or sub-group identifier is used to select the desired portion of the system.

In addition, or in the alternative, a system element is identifiable based on a serial number, an IP (internet protocol) address, a vendor name, a type of system element (e.g., computing entity, a particular user software application, etc.), registered user of the system element, and/or other identifying metric. In this manner, an individual system element can be evaluated and/or a type of system element can be evaluated (e.g., a particular user software application).

A system criteria is regarding a level of the system, or portion thereof, being evaluated. For example, the system criteria includes guidelines, system requirements, system design, system build, and resulting system. As a further example, the guidelines (e.g., business objectives, security objectives, NIST cybersecurity guidelines, system objectives, governmental and/or regulatory requirements, third party requirements, etc.) are used to develop the system requirements, which are used to design the system, which is used to the build the resulting system. As such, the system, or potion thereof, can be evaluated from a guideline level, a system requirements level, a design level, a build level, and/or a resulting system level.

A system mode is regarding a different level of the system, or portion thereof, being evaluated. For example, the system mode includes assets, system functions, and security functions. As such, the system can be evaluated from an assets level, a system function level, and/or a security function level.

The evaluation aspect (e.g., options for how the system, or portion thereof, can be evaluated) includes a selection of one or more evaluation perspectives, a selection of one or more evaluation viewpoints, and/or a selection of one or more evaluation categories, which may further include sub-categories, and sub-categories of the sub-categories). An evaluation perspective is understanding of the system, or portion thereof; implementation (e.g., design and build) of the system, or portion thereof; operational performance of the system, or portion thereof; or self-analysis of the system, or portion thereof.

An evaluation viewpoint is disclosed information from the system, discovered information about the system by the analysis system, or desired information about the system obtained by the analysis system from system proficiency resources. The evaluation viewpoint complements the evaluation perspective to allow for more in-depth and/or detailed evaluations. For example, the analysis system 10 can evaluate how well the system is understood by comparing disclosed data with discovered data. As another example, the analysis system 10 can evaluate how well the system is actually implemented in comparison to a desired level of implementation.

The evaluation category includes an identify category, a protect category, a detect category, a respond category, and a recover category. Each evaluation category includes a plurality of sub-categories and, at least some of the sub-categories include their own sub-categories (e.g., a sub-sub category). For example, the identify category includes the sub-categories of asset management, business environment, governance, risk assessment, risk management, access control, awareness & training, and data security. As a further example, asset management includes the sub-categories of hardware inventory, software inventory, data flow maps, external system cataloged, resource prioritization, and security roles. The analysis system 10 can evaluate the system, or portion thereof, in light of one more evaluation categories, in light of an evaluation category and one or more sub-categories, or in light of an evaluation category, a sub-category, and one or more sub-sub-categories.

The evaluation rating metrics (e.g., how the system, or portion thereof, is evaluated) include a selection of process, policy, procedure, certification, documentation, and/or automation. This allows the analysis system to quantify its evaluation. For example, the analysis system 10 can evaluate the processes a system, or portion thereof, has to generate an evaluation rating, to identify deficiencies, and/or to auto-correct deficiencies. As another example, the analysis system 10 can evaluate how well the system, or portion thereof, uses the process it has to generate an evaluation rating, to identify deficiencies, and/or to auto-correct deficiencies.

In an example, the analysis computing entity 16 (which includes one or more computing entities) sends a data gathering request to the analysis system module 17. The data gathering request is specific to the evaluation to be performed by the analysis system 10. For example, if the analysis system 10 is evaluating the understanding of the policies, processes, documentation, and automation regarding the assets built for the engineering department, then the data gathering request would be specific to policies, processes, documentation, and automation regarding the assets built for the engineering department.

The analysis system module 17 is loaded on the system 11-13 and obtains the requested data from the system. The obtaining of the data can be done in a variety of ways. For example, the data is disclosed by one or more system administrators. The disclosed data corresponds to the information the system administrator(s) has regarding the system. In essence, the disclosed data is a reflection of the knowledge the system administrator(s) has regarding the system.

As another example, the analysis system module 17 communicates with physical assets of the system to discover the data. The communication may be direct with an asset. For example, the analysis system module 17 sends a request to a particular computing device. Alternatively, or in addition, the communication may be through one or more discovery tools of the system. For example, the analysis system module 17 communicates with one or more tools of the system to obtain data regarding data segregation & boundary, infrastructure management, exploit & malware protection, encryption, identity & access management, system monitoring, vulnerability management, and/or data protection.

A tool is a network monitoring tool, a network strategy and planning tool, a network managing tool, a Simple Network Management Protocol (SNMP) tool, a telephony monitoring tool, a firewall monitoring tool, a bandwidth monitoring tool, an IT asset inventory management tool, a network discovery tool, a network asset discovery tool, a software discovery tool, a security discovery tool, an infrastructure discovery tool, Security Information & Event Management (SIEM) tool, a data crawler tool, and/or other type of tool to assist in discovery of assets, functions, security issues, implementation of the system, and/or operation of the system. If the system does not have a particular tool, the analysis system module 17 engages one to discover a particular piece of data.

The analysis system module 17 provides the gathered data to the analysis computing entity 16, which stores the gathered data in a private storage 19-21 and processes it. The gathered data is processed alone, in combination with stored data (of the system being evaluated and/or another system’s data), in combination with desired data (e.g., system proficiencies), in combination with analysis modeling (e.g., risk modeling, data flow modeling, security modeling, etc.), and/or in combination with stored analytic data (e.g., results of other evaluations). As a result of the processing, the analysis computing entity 16 produces an evaluation rating, to identify deficiencies, and/or to auto-correct deficiencies. The evaluation results are stored in a private storage and/or in another database.

The analysis system 10 is operable to evaluate a system and/or its eco-system at any level of granularity from the entire system to an individual asset over a wide spectrum of evaluation options. As an example, the evaluation is to test understanding of the system, to test the implementation of the system, and/or to test the operation of the system. As another example, the evaluation is to test the system’s self-evaluation capabilities with respect to understanding, implementation, and/or operation. As yet another example, the evaluation is to test policies regarding software tools; to test which software tools are prescribed by policy; to test which software tools are prohibited by policy; to test the use of the software tools in accordance with policy, to test maintenance of software tools in accordance with policy; to test the sufficiency of the policies, to test the effectiveness of the policies; and/or to test compliancy with the policies.

The analysis system 10 takes an outside perspective to analyze the system. From within the system, it is often difficult to test the entire system, to test different combinations of system elements, to identify areas of vulnerabilities (assets and human operators), to identify areas of strength (assets and human operators), and to be proactive. Further, such evaluations are additional tasks the system has to perform, which means it consumes resources (human, physicals assets, and financial). Further, since system analysis is not the primary function of a system (supporting the organization is the system’s primary purpose), the system analysis is not as thoroughly developed, implemented, and/or executed as is possible when it’s implemented in a stand-alone analysis system, like system 10.

The primary purpose of the analysis system is to analyze other systems to determine an evaluation rating, to identify deficiencies in the system, and, where it can, auto-correct the deficiencies. The evaluation rating can be regarding how well the system, or portion thereof, is understood, how well it is implemented, and/or how well it operates. The evaluation rating can be regarding how effective the system, or portion thereof, is believed (disclosed data) to support a business function; actually (discovered data) supports a business function; and/or should (desired data) support the business function.

The evaluation rating can be regarding how effective the system, or portion thereof, is believed (disclosed data) to mitigate security risks; actually (discovered data) supports mitigating security risks; and/or should (desired data) support mitigating security risks. The evaluation rating can be regarding how effective the system, or portion thereof, is believed (disclosed data) to respond to security risks; actually (discovered data) supports responding to security risks; and/or should (desired data) support responding security risks.

The evaluation rating can be regarding how effective the system, or portion thereof, is believed (disclosed data) to be used by people; is actually (discovered data) used by people; and/or should (desired data) be used by people. The evaluation rating can be regarding how effective the system, or portion thereof, is believed (disclosed data) to identify assets of the system; actually (discovered data) identifies assets of the system; and/or should (desired data) identify assets of the system.

There are a significant number of combinations in which the analysis system 10 can evaluate a system 11-13. A primary purpose the analysis system 10 is help the system 11-13 become more self-healing, more self-updating, more self-protecting, more self-recovering, more self-evaluating, more self-aware, more secure, more efficient, more adaptive, and/or more self-responding. By discovering the strengths, weaknesses, vulnerabilities, and other system limitations in a way that the system itself cannot do effectively, the analysis system 10 significantly improves the usefulness, security, and efficiency of systems 11-13.

FIG. 2A is a schematic block diagram of an embodiment of a computing device 40 that includes a plurality of computing resources. The computing resource include a core control module 41, one or more processing modules 43, one or more main memories 45, a read only memory (ROM) 44 for a boot up sequence, cache memory 47, a video graphics processing module 42, a display 48 (optional), an Input-Output (I/O) peripheral control module 46, an I/O interface module 49 (which could be omitted), one or more input interface modules 50, one or more output interface modules 51, one or more network interface modules 55, and one or more memory interface modules 54. A processing module 43 is described in greater detail at the end of the detailed description of the invention section and, in an alternative embodiment, has a direction connection to the main memory 45. In an alternate embodiment, the core control module 41 and the I/O and/or peripheral control module 46 are one module, such as a chipset, a quick path interconnect (QPI), and/or an ultra-path interconnect (UPI).

Each of the main memories 45 includes one or more Random Access Memory (RAM) integrated circuits, or chips. For example, a main memory 45 includes four DDR4 (4^{th} generation of double data rate) RAM chips, each running at a rate of 2,400 MHz. In general, the main memory 45 stores data and operational instructions most relevant for the processing module 43. For example, the core control module 41 coordinates the transfer of data and/or operational instructions between the main memory 45 and the memory 56 - 57. The data and/or operational instructions retrieve from memory 56 - 57 are the data and/or operational instructions requested by the processing module or will most likely be needed by the processing module. When the processing module is done with the data and/or operational instructions in main memory, the core control module 41 coordinates sending updated data to the memory 56 - 57 for storage.

The memory 56 - 57 includes one or more hard drives, one or more solid state memory chips, and/or one or more other large capacity storage devices that, in comparison to cache memory and main memory devices, is/are relatively inexpensive with respect to cost per amount of data stored. The memory 56 - 57 is coupled to the core control module 41 via the I/O and/or peripheral control module 46 and via one or more memory interface modules 54. In an embodiment, the I/O and/or peripheral control module 46 includes one or more Peripheral Component Interface (PCI) buses to which peripheral components connect to the core control module 41. A memory interface module 54 includes a software driver and a hardware connector for coupling a memory device to the I/O and/or peripheral control module 46. For example, a memory interface 54 is in accordance with a Serial Advanced Technology Attachment (SATA) port.

The core control module 41 coordinates data communications between the processing module(s) 43 and the network(s) 14 via the I/O and/or peripheral control module 46, the network interface module(s) 55, and a network card 58 or 59. A network card 58 or 59 includes a wireless communication unit or a wired communication unit. A wireless communication unit includes a wireless local area network (WLAN) communication device, a cellular communication device, a Bluetooth device, and/or a ZigBee communication device. A wired communication unit includes a Gigabit LAN connection, a Firewire connection, and/or a proprietary computer wired connection. A network interface module 55 includes a software driver and a hardware connector for coupling the network card to the I/O and/or peripheral control module 46. For example, the network interface module 55 is in accordance with one or more versions of IEEE 802.11, cellular telephone protocols, 10/100/1000 Gigabit LAN protocols, etc.

The core control module 41 coordinates data communications between the processing module(s) 43 and input device(s) 52 via the input interface module(s) 50, the I/O interface 49, and the I/O and/or peripheral control module 46. An input device 52 includes a keypad, a keyboard, control switches, a touchpad, a microphone, a camera, etc. An input interface module 50 includes a software driver and a hardware connector for coupling an input device to the I/O and/or peripheral control module 46. In an embodiment, an input interface module 50 is in accordance with one or more Universal Serial Bus (USB) protocols.

The core control module 41 coordinates data communications between the processing module(s) 43 and output device(s) 53 via the output interface module(s) 51 and the I/O and/or peripheral control module 46. An output device 53 includes a speaker, auxiliary memory, headphones, etc. An output interface module 51 includes a software driver and a hardware connector for coupling an output device to the I/O and/or peripheral control module 46. In an embodiment, an output interface module 46 is in accordance with one or more audio codec protocols.

The processing module 43 communicates directly with a video graphics processing module 42 to display data on the display 48. The display 48 includes an LED (light emitting diode) display, an LCD (liquid crystal display), and/or other type of display technology. The display has a resolution, an aspect ratio, and other features that affect the quality of the display. The video graphics processing module 42 receives data from the processing module 43, processes the data to produce rendered data in accordance with the characteristics of the display, and provides the rendered data to the display 48.

FIG. 2B is a schematic block diagram of an embodiment of a computing device 40 that includes a plurality of computing resources similar to the computing resources of FIG. 2A with the addition of one or more cloud memory interface modules 60, one or more cloud processing interface modules 61, cloud memory 62, and one or more cloud processing modules 63. The cloud memory 62 includes one or more tiers of memory (e.g., ROM, volatile (RAM, main, etc.), non-volatile (hard drive, solid-state, etc.) and/or backup (hard drive, tape, etc.)) that is remoted from the core control module and is accessed via a network (WAN and/or LAN). The cloud processing module 63 is similar to processing module 43 but is remoted from the core control module and is accessed via a network.

FIG. 2C is a schematic block diagram of an embodiment of a computing device 40 that includes a plurality of computing resources similar to the computing resources of FIG. 2B with a change in how the cloud memory interface module(s) 60 and the cloud processing interface module(s) 61 are coupled to the core control module 41. In this embodiment, the interface modules 60 and 61 are coupled to a cloud peripheral control module 63 that directly couples to the core control module 41.

FIG. 2D is a schematic block diagram of an embodiment of a computing device 40 that includes a plurality of computing resources, which includes include a core control module 41, a boot up processing module 66, boot up RAM 67, a read only memory (ROM) 45, a video graphics processing module 42, a display 48 (optional), an Input-Output (I/O) peripheral control module 46, one or more input interface modules 50, one or more output interface modules 51, one or more cloud memory interface modules 60, one or more cloud processing interface modules 61, cloud memory 62, and cloud processing module(s) 63.

In this embodiment, the computing device 40 includes enough processing resources (e.g., module 66, ROM 44, and RAM 67) to boot up. Once booted up, the cloud memory 62 and the cloud processing module(s) 63 function as the computing device’s memory (e.g., main and hard drive) and processing module.

FIG. 3A is schematic block diagram of an embodiment of a computing entity 16 that includes a computing device 40 (e.g., one of the embodiments of FIGS. 2A - 2D). A computing device may function as a user computing device, a server, a system computing device, a data storage device, a data security device, a networking device, a user access device, a cell phone, a tablet, a laptop, a printer, a game console, a satellite control box, a cable box, etc.

FIG. 3B is schematic block diagram of an embodiment of a computing entity 16 that includes two or more computing devices 40 (e.g., two or more from any combination of the embodiments of FIGS. 2A - 2D). The computing devices 40 perform the functions of a computing entity in a peer processing manner (e.g., coordinate together to perform the functions), in a master-slave manner (e.g., one computing device coordinates and the other support it), and/or in another manner.

FIG. 3C is schematic block diagram of an embodiment of a computing entity 16 that includes a network of computing devices 40 (e.g., two or more from any combination of the embodiments of FIGS. 2A - 2D). The computing devices are coupled together via one or more network connections (e.g., WAN, LAN, cellular data, WLAN, etc.) and preform the functions of the computing entity.

FIG. 3D is schematic block diagram of an embodiment of a computing entity 16 that includes a primary computing device (e.g., any one of the computing devices of FIGS. 2A - 2D), an interface device (e.g., a network connection), and a network of computing devices 40 (e.g., one or more from any combination of the embodiments of FIGS. 2A - 2D). The primary computing device utilizes the other computing devices as co-processors to execute one or more the functions of the computing entity, as storage for data, for other data processing functions, and/or storage purposes.

FIG. 3E is schematic block diagram of an embodiment of a computing entity 16 that includes a primary computing device (e.g., any one of the computing devices of FIGS. 2A - 2D), an interface device (e.g., a network connection) 70, and a network of computing resources 71 (e.g., two or more resources from any combination of the embodiments of FIGS. 2A - 2D). The primary computing device utilizes the computing resources as co-processors to execute one or more the functions of the computing entity, as storage for data, for other data processing functions, and/or storage purposes.

FIG. 4 is a schematic block diagram of another embodiment of a networked environment that includes a system 11 (or system 12 or system 13), the analysis system 10, one or more networks, one or more system proficiency resources 22, one or more business associated computing devices 23, one or more non-business associated computing devices 24 (e.g., publicly available servers 27 and subscription based servers 28), one or more BOT computing devices 25, and one or more bad actor computing devices 26. This diagram is similar to FIG. 1 with the inclusion of detail within the system proficiency resource(s) 22, with inclusion of detail within the system 11, and with the inclusion of detail within the analysis system module 17.

In addition to the discussion with respect FIG. 1, a system proficiency resource 22 is a computing device that provides information regarding best-in-class assets, best-in-class practices, known protocols, leading edge information, and/or established guidelines regarding risk assessment, devices, software, networking, data security, cybersecurity, and/or data communication. A system proficiency resource 22 is a computing device that may also provide information regarding standards, information regarding compliance requirements, information regarding legal requirements, and/or information regarding regulatory requirements.

The system 11 is shown to include three inter-dependent modes: system functions 82, security functions 83, and system assets 84. System functions 82 correspond to the functions the system executes to support the organization’s business requirements. Security functions 83 correspond to the functions the system executes to support the organization’s security requirements. The system assets 84 are the hardware and/or software platforms that support system functions 82 and/or the security functions 84.

The analysis system module 17 includes one or more data extraction modules 80 and one or more system user interface modules 81. A data extraction module 80, which will be described in greater detail with reference to one or more subsequent figures, gathers data from the system for analysis by the analysis system 10. A system user interface module 81 provides a user interface between the system 11 and the analysis system 10 and functions to provide user information to the analysis system 10 and to receive output data from the analysis system. The system user interface module 81 will be described in greater detail with reference to one or more subsequent figures.

FIG. 5 is a schematic block diagram of another embodiment of a networked environment that includes a system 11 (or system 12 or system 13), the analysis system 10, one or more networks, one or more system proficiency resources 22, one or more business associated computing devices 23, one or more non-business associated computing devices 24 (e.g., publicly available servers 27 and subscription based servers 28), one or more BOT computing devices 25, and one or more bad actor computing devices 26. This diagram is similar to FIG. 4 with the inclusion of additional detail within the system 11.

In this embodiment, the system 11 includes a plurality of sets of system assets to support the system functions 82 and/or the security functions 83. For example, a set of system assets supports the system functions 82 and/or security functions 83 for a particular business segment (e.g., a department within the organization). As another example, a second set of system assets supports the security functions 83 for a different business segment and a third set of system assets supports the system functions 82 for the different business segment.

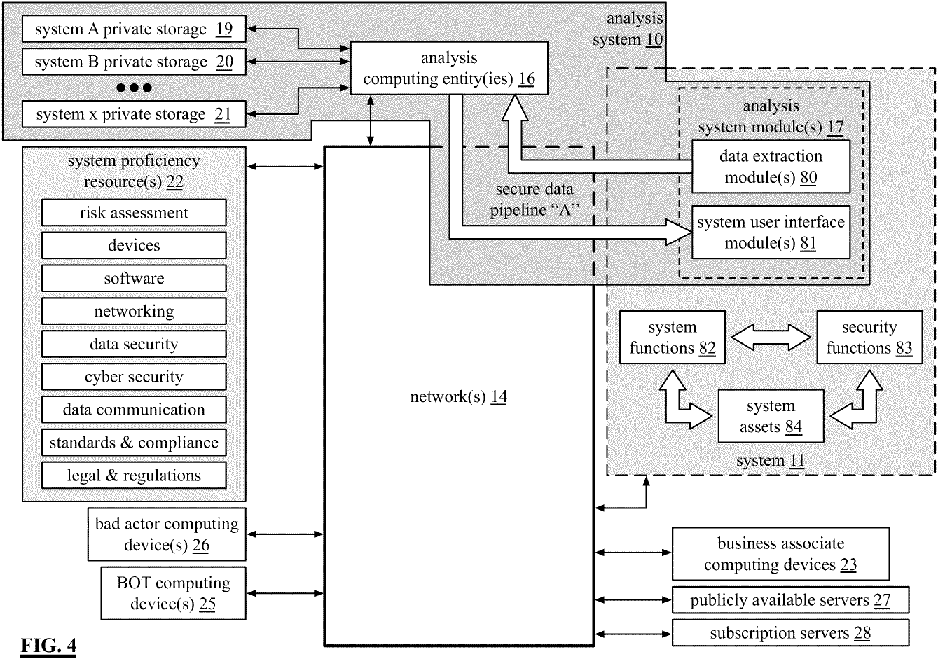

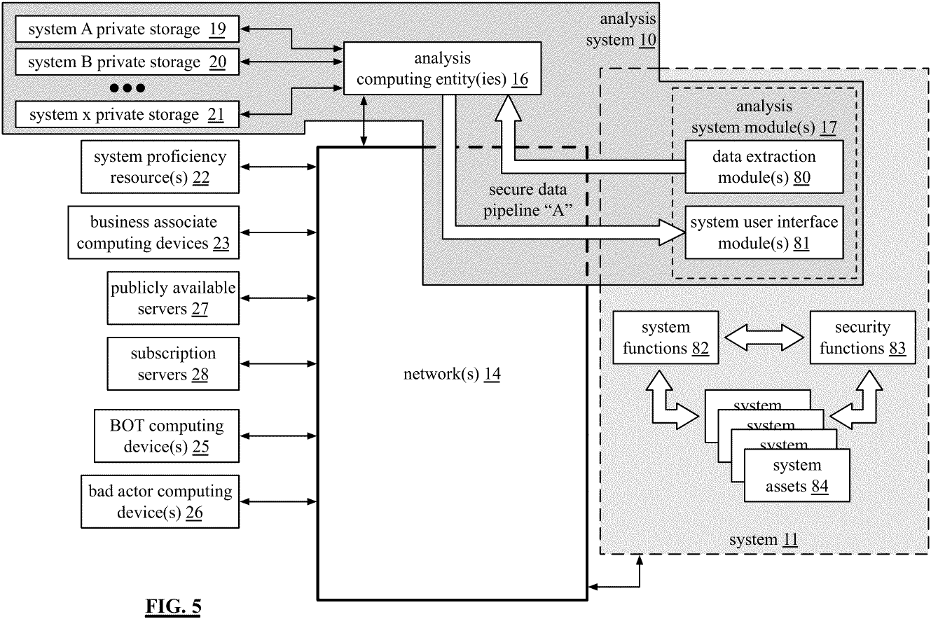

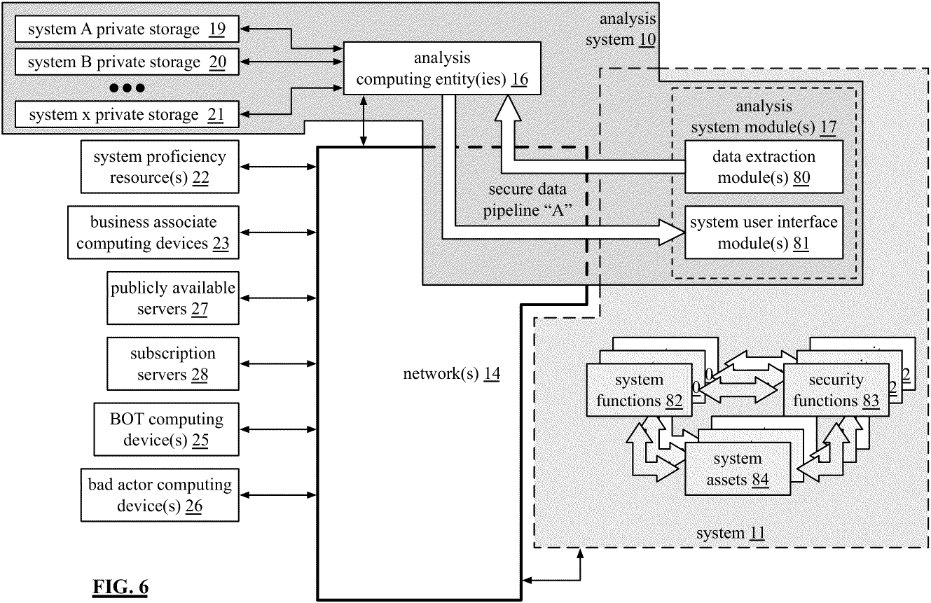

FIG. 6 is a schematic block diagram of another embodiment of a networked environment that includes a system 11 (or system 12 or system 13), the analysis system 10, one or more networks, one or more system proficiency resources 22, one or more business associated computing devices 23, one or more non-business associated computing devices 24 (e.g., publicly available servers 27 and subscription based servers 28), one or more BOT computing devices 25, and one or more bad actor computing devices 26. This diagram is similar to FIG. 5 with the inclusion of additional detail within the system 11.

In this embodiment, the system 11 includes a plurality of sets of system assets 84, system functions 82, and security functions 84. For example, a set of system assets 84, system functions 82, and security functions 84 supports one department in an organization and a second set of system assets 84, system functions 82, and security functions 84 supports another department in the organization.

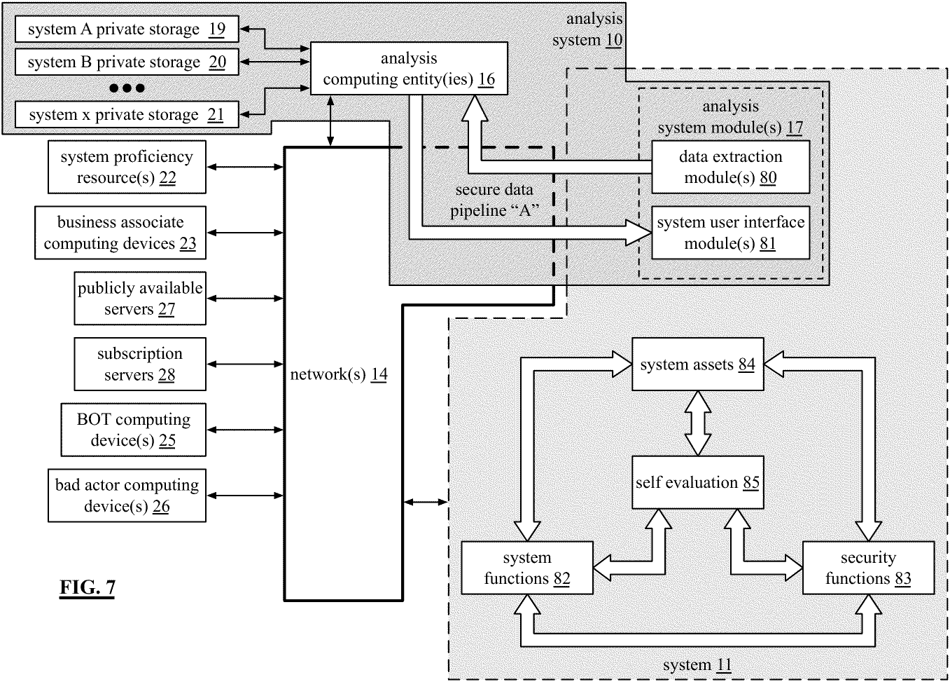

FIG. 7 is a schematic block diagram of another embodiment of a networked environment that includes a system 11 (or system 12 or system 13), the analysis system 10, one or more networks, one or more system proficiency resources 22, one or more business associated computing devices 23, one or more non-business associated computing devices 24 (e.g., publicly available servers 27 and subscription based servers 28), one or more BOT computing devices 25, and one or more bad actor computing devices 26. This diagram is similar to FIG. 4 with the inclusion of additional detail within the system 11.

In this embodiment, the system 11 includes system assets 84, system functions 82, security functions 83, and self-evaluation functions 85. The self-evaluation functions 85 are supported by the system assets 84 and are used by the system to evaluate its assets, is system functions, and its security functions. In general, self-evaluation looks at system’s ability to analyze itself for self-determining it’s understanding (self-aware) of the system; self-determining the implementation of the system, and/or self-determining operation of the system. In addition, the self-evaluation may further consider the system’s ability to self-heal, self-update, self-protect, self-recover, self-evaluate, and/or self-respond. The analysis system 10 can evaluate the understanding, implementation, and/or operation of the self-evaluation functions.

FIG. 8 is a schematic block diagram of another embodiment of a networked environment having a system 11 (or system 12 or system 13), the analysis system 10, one or more networks represented by networking infrastructure, one or more system proficiency resources 22, one or more business associated computing devices 23, one or more publicly available servers 27, one or more subscription-based servers 28, one or more BOT computing devices 25, and one or more bad actor computing devices 26.

In this embodiment, the system 11 is shown to include a plurality of physical assets dispersed throughout a geographic region (e.g., a building, a town, a county, a state, a country). Each of the physical assets includes hardware and software to perform its respective functions within the system. A physical asset is a computing entity (CE), a public or provide networking device (ND), a user access device (UAD), or a business associate access device (BAAD).

A computing entity may be a user device, a system admin device, a server, a printer, a data storage device, etc. A network device may be a local area network device, a network card, a wide area network device, etc. A user access device is a portal that allows authorizes users of the system to remotely access the system. A business associated access device is a portal that allows authorized business associates of the system access the system.

Some of the computing entities are grouped via a common connection to a network device, which provides the group of computing entities access to other parts of the system and/or the internet. For example, the highlighted computing entity may access a publicly available server 25 via network devices coupled to the network infrastructure. The analysis system 10 can evaluate whether this is an appropriate access, the understanding of this access, the implementation to enable this access, and/or the operation of the system to support this access.

FIG. 9 is a schematic block diagram of an example of a system section of a system selected for evaluation similar to FIG. 8. In this example, only a portion of the system is being tested, i.e., system section under test 91. As such, the analysis system 10 only evaluates assets, system functions, and/or security functions related to assets within the system section under test 91.

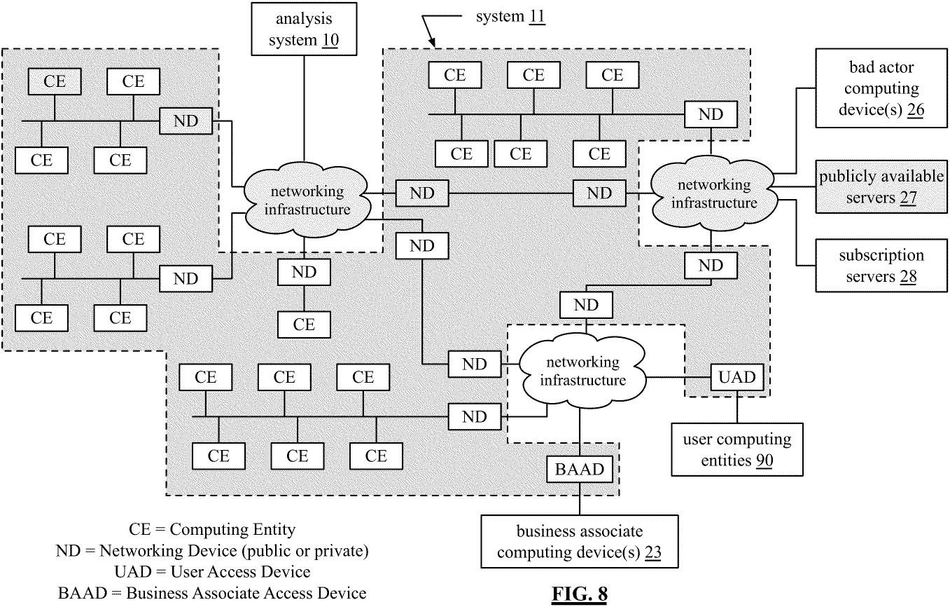

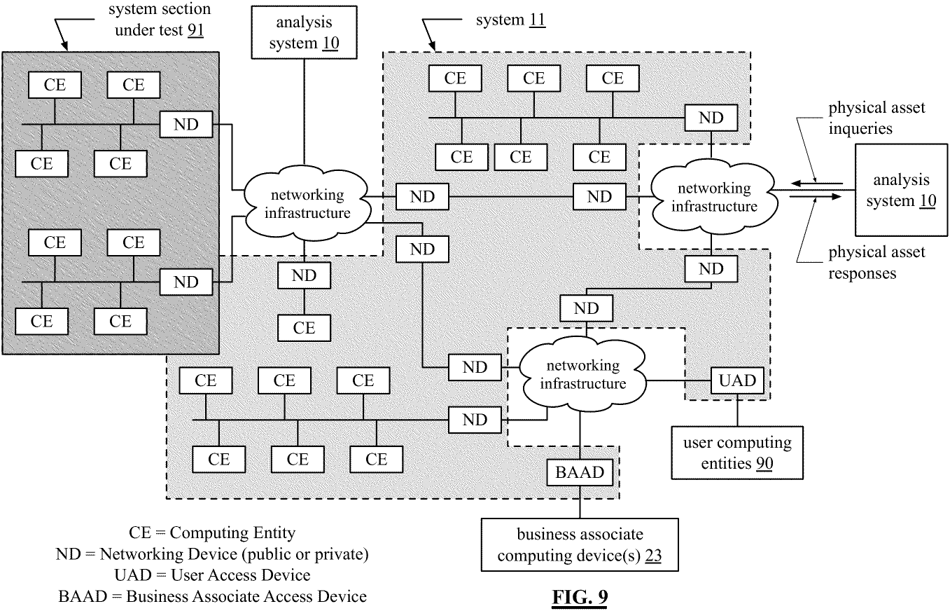

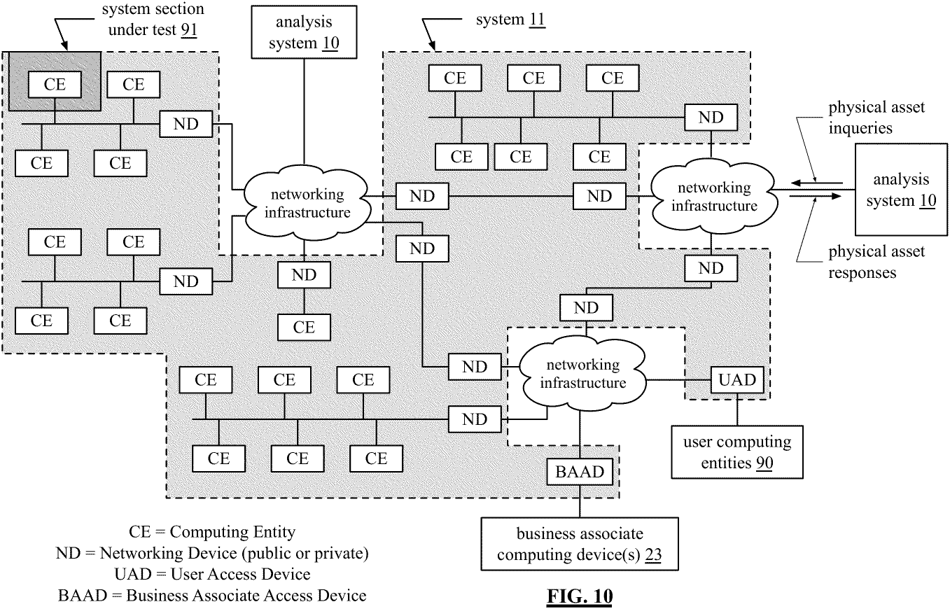

FIG. 10 is a schematic block diagram of another example of a system section of a system selected for evaluation similar to FIG. 9. In this example, a single computing entity (CE) is being tested, i.e., system section under test 91. As such, the analysis system 10 only evaluates assets, system functions, and/or security functions related to the selected computing entity.

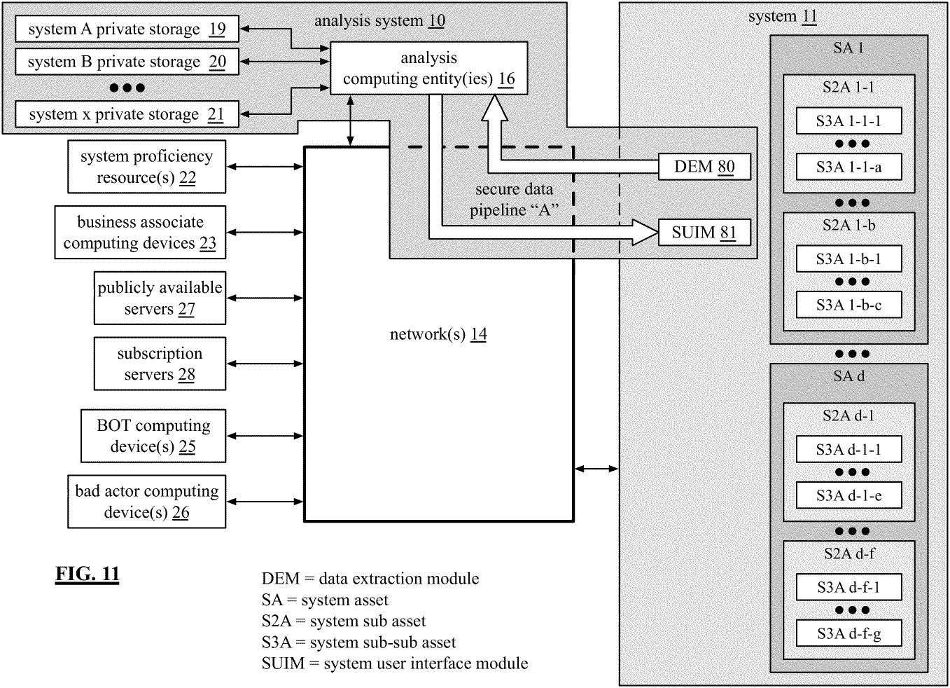

FIG. 11 is a schematic block diagram of an embodiment of a networked environment having a system 11 (or system 12 or system 13), the analysis system 10, one or more networks 14, one or more system proficiency resources 22, one or more business associated computing devices 23, one or more publicly available servers 27, one or more subscription based servers 28, one or more BOT computing devices 25, and one or more bad actor computing devices 26.

In this embodiment, the system 11 is shown to include a plurality of system assets (SA). A system asset (SA) may include one or more system sub assets (S2A) and a system sub asset (S2A) may include one or more system sub-sub assets (S3A). While being a part of the analysis system 10, at least one data extraction module (DEM) 80 and at least one system user interface module (SUIM) 81 are installed on the system 11.

A system element includes one or more system assets. A system asset (SA) may be a physical asset or a conceptual asset as previously described. As an example, a system element includes a system asset of a computing device. The computing device, which is the SA, includes user applications and an operating system; each of which are sub assets of the computing device (S2A). In addition, the computing device includes a network card, memory devices, etc., which are sub assets of the computing device (S2A). Documents created from a word processing user application are sub assets of the word processing user application (S3A) and sub-sub assets of the computing device.

As another example, the system asset (SA) includes a plurality of computing devices, printers, servers, etc. of a department of the organization operating the system 11. In this example, a computing device is a sub asset of the system asset and the software and hardware of the computing devices are sub-sub assets.

The analysis system 10 may evaluate understanding, implementation, and/or operation of one or more system assets, one or more system sub assets, and/or one or more system sub-sub assets, as an asset, as it supports system functions 82, and/or as it supports security functions. The evaluation may be to produce an evaluation rating, to identify deficiencies, and/or to auto-correct deficiencies.

FIG. 12 is a schematic block diagram of an embodiment of a system 11 that includes a plurality of physical assets 100 coupled to an analysis system 100. The physical assets 100 include an analysis interface device 101, one or more networking devices 102, one or more security devices 103, one or more system admin devices 104, one or more user devices 105, one or more storage devices 106, and/or one or more servers 107. Each device may be a computing entity that includes hardware (HW) components and software (SW) applications (user, device, drivers, and/or system). A device may further include a data extraction module (DEM). In an alternative embodiment, the devices 102-107 do not include a data extraction module (DEM).

The analysis interface device 101 includes a data extraction module (DEM) 80 and the system user interface module 81 to provide connectivity to the analysis system 10. With the connectivity, the analysis system 10 is able to evaluate understanding, implementation, and/or operation of each device, or portion thereof, as an asset, as it supports system functions 82, and/or as it supports security functions. For example, the analysis system 10 evaluates the understanding of networking devices 102 as an asset. As a more specific example, the analysis system 10 evaluates how well the networking devices 102, its hardware, and its software are understood within the system and/or by the system administrators. The evaluation includes how well are the networking devices 102, its hardware, and its software documented; how well are they implemented based on system requirements; how well do they operate based on design and/or system requirements; how well are they maintained per system policies and/or procedures; how well are their deficiencies identified; and/or how well are their deficiencies auto-corrected.

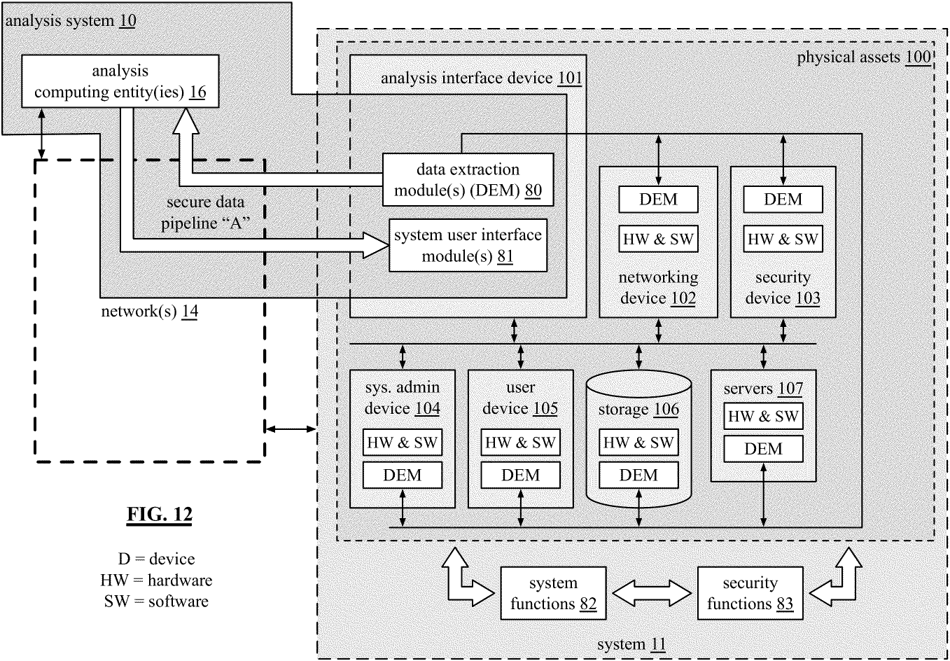

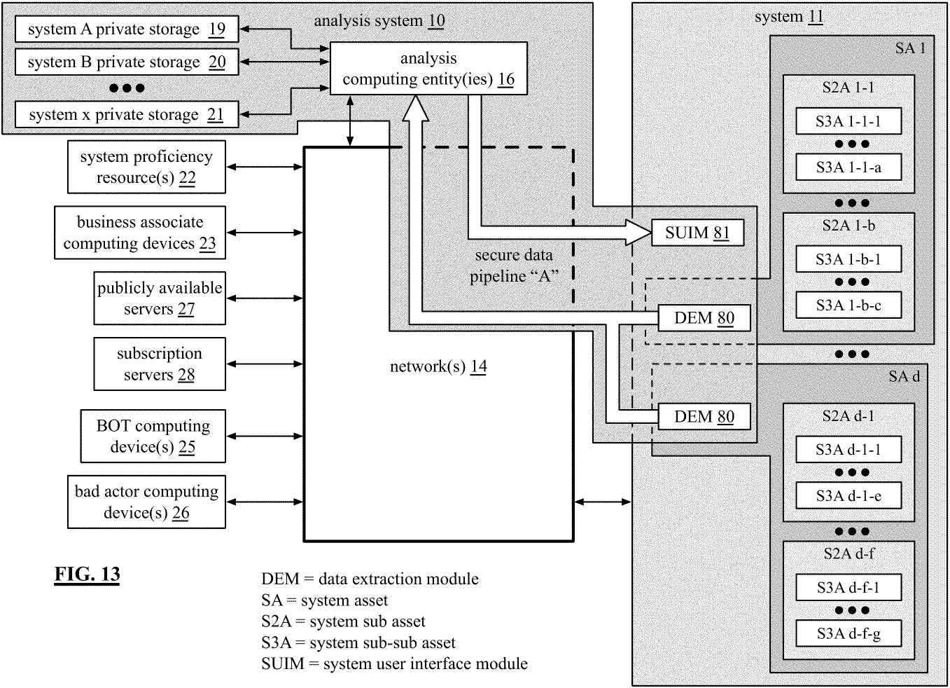

FIG. 13 is a schematic block diagram of another embodiment of a networked environment having a system 11 that includes a plurality of system assets coupled to an analysis system 10. This embodiment is similar to the embodiment of FIG. 11 with the addition of additional data extraction modules (DEM) 80. In this embodiment, each system asset (SA) is affiliated with its own DEM 80. This allows the analysis system 10 to extract data more efficiently than via a single DEM. A further extension of this embodiment is that each system sub asset (S2A) could have its own DEM 80. As yet a further extension, each system sub-sub asset (S3A) could have its own DEM 80.

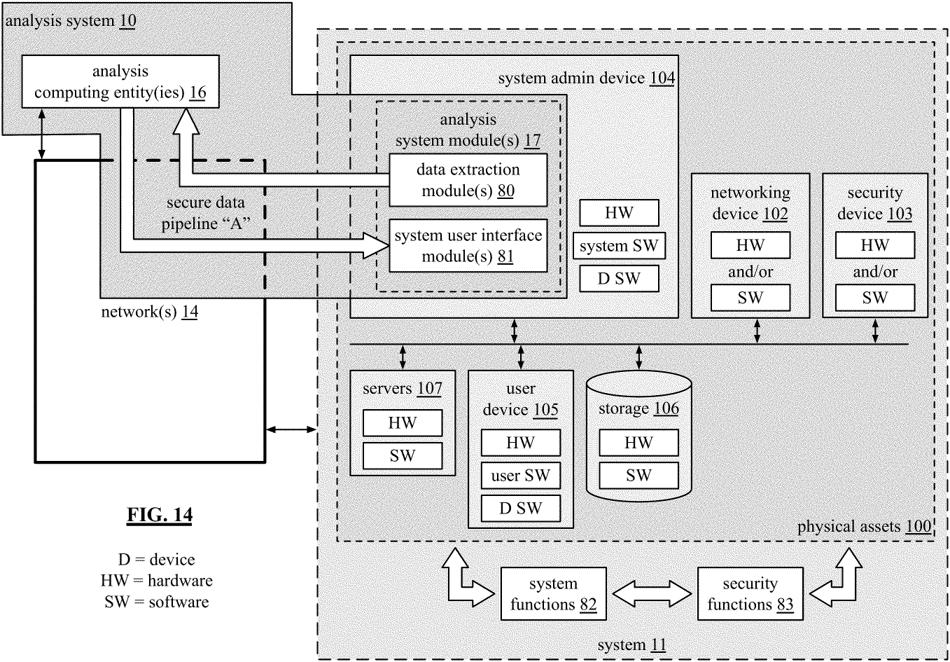

FIG. 14 is a schematic block diagram of another embodiment of a system 11 physical assets 100 coupled to an analysis system 100. The physical assets 100 include one or more networking devices 102, one or more security devices 103, one or more system admin devices 104, one or more user devices 105, one or more storage devices 106, and/or one or more servers 107. Each device may be a computing entity that includes hardware (HW) components and software (SW) applications (user, system, and/or device).

The system admin device 104 includes one or more analysis system modules 17, which includes a data extraction module (DEM) 80 and the system user interface module 81 to provide connectivity to the analysis system 10. With the connectivity, the analysis system 10 is able to evaluate understanding, implementation, and/or operation of each device, or portion thereof, as an asset, as it supports system functions 82, and/or as it supports security functions. For example, the analysis system 10 evaluates the implementation of networking devices 102 to support system functions. As a more specific example, the analysis system 10 evaluates how well the networking devices 102, its hardware, and its software are implemented within the system to support one or more system functions (e.g., managing network traffic, controlling network access per business guidelines, policies, and/or processes, etc.). The evaluation includes how well is the implementation of the networking devices 102, its hardware, and its software documented to support the one or more system functions; how well does their implementation support the one or more system functions; how well have their implementation to support the one or more system functions been verified in accordance with policies, processes, etc.; how well are they updated per system policies and/or procedures; how well are their deficiencies in support of the one or more system functions identified; and/or how well are their deficiencies in support of the one or more system functions auto-corrected.

FIG. 15 is a schematic block diagram of another embodiment of a system 11 that includes a plurality of physical assets 100 coupled to an analysis system 100. The physical assets 100 include an analysis interface device 101, one or more networking devices 102, one or more security devices 103, one or more system admin devices 104, one or more user devices 105, one or more storage devices 106, and/or one or more servers 107. Each device may be a computing entity that includes hardware (HW) components and software (SW) applications (user, device, drivers, and/or system). This embodiment is similar to the embodiment of FIG. 12 with a difference being that the devices 102-107 do not include a data extraction module (DEM) as is shown in FIG. 12.

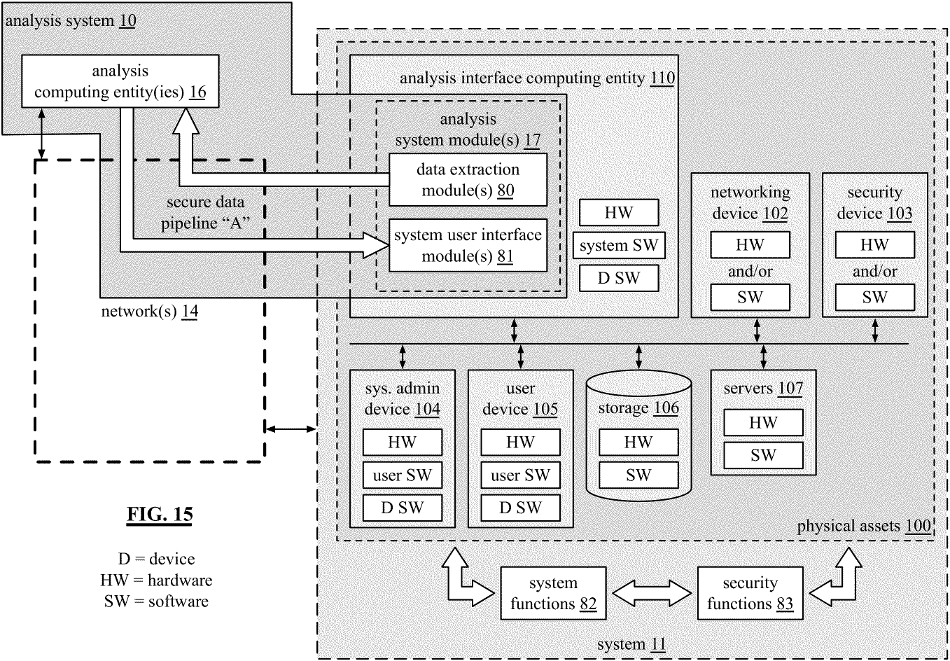

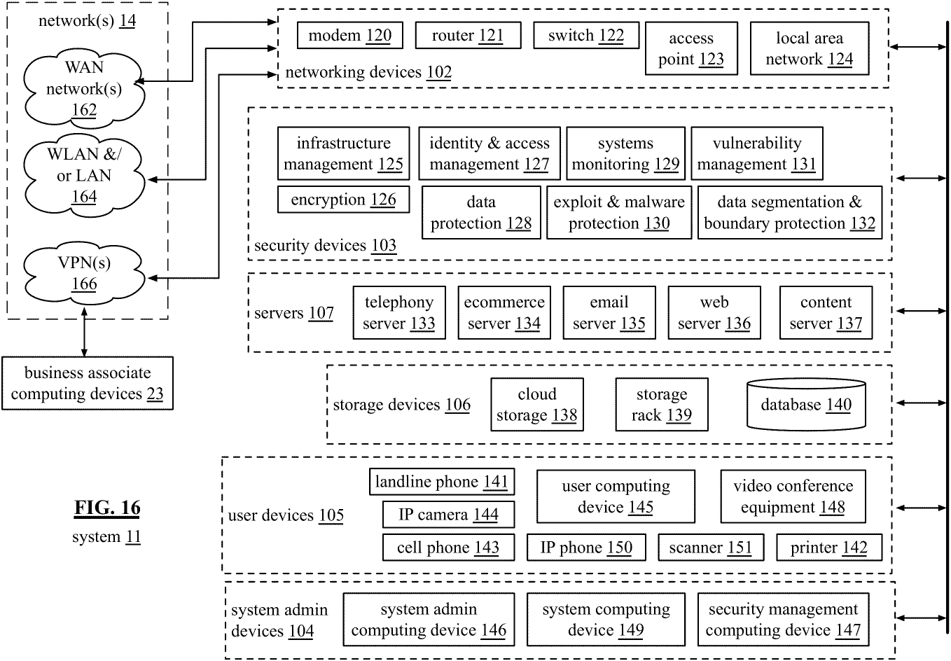

FIG. 16 is a schematic block diagram of another embodiment of a system 11 that includes networking devices 102, security devices 103, servers 107, storage devices 106, and user devices 105. The system 11 is coupled to the network 14, which provides connectivity to the busines associate computing device 23. The network 14 is shown to include one or more wide area networks (WAN) 162, one or more wireless LAN (WLAN) and/or LANs 164, one or more virtual private networks 166.

The networking devices 102 includes one or more modems 120, one or more routers 121, one or more switches 122, one or more access points 124, and/or one or more local area network cards 124. The analysis system 10 can evaluate the network devices 102 collectively as assets, as they support system functions, and/or as they support security functions. The analysis system 10 may also evaluate each network device individually as an asset, as it supports system functions, and/or as it supports security functions. The analysis system may further evaluate one or more network devices as part of the physical assets of a system aspect (e.g., the system or a portion thereof being evaluated with respect to one or more system criteria and one or more system modes).

The security devices 103 includes one or more infrastructure management tools 125, one or more encryption software programs 126, one or more identity and access management tools 127, one or more data protection software programs 128, one or more system monitoring tools 129, one or more exploit and malware protection tools 130, one or more vulnerability management tools 131, and/or one or more data segmentation and boundary tools 132. Note that a tool is a program that functions to develop, repair, and/or enhance other programs and/or hardware.

The analysis system 10 can evaluate the security devices 103 collectively as assets, as they support system functions, and/or as they support security functions. The analysis system 10 may also evaluate each security device individually as an asset, as it supports system functions, and/or as it supports security functions. The analysis system may further evaluate one or more security devices as part of the physical assets of a system aspect (e.g., the system or a portion thereof being evaluated with respect to one or more system criteria and one or more system modes).

The servers 107 include one or more telephony servers 133, one or more ecommerce servers 134, one or more email servers 135, one or more web servers 136, and/or one or more content servers 137. The analysis system 10 can evaluate the servers 103 collectively as assets, as they support system functions, and/or as they support security functions. The analysis system 10 may also evaluate each server individually as an asset, as it supports system functions, and/or as it supports security functions. The analysis system may further evaluate one or more servers as part of the physical assets of a system aspect (e.g., the system or a portion thereof being evaluated with respect to one or more system criteria and one or more system modes).

The storage devices include one or more cloud storage devices 138, one or more storage racks 139 (e.g., a plurality of storage devices mounted in a rack), and/or one or more databases 140. The analysis system 10 can evaluate the storage devices 103 collectively as assets, as they support system functions, and/or as they support security functions. The analysis system 10 may also evaluate each storage device individually as an asset, as it supports system functions, and/or as it supports security functions. The analysis system may further evaluate one or more storage devices as part of the physical assets of a system aspect (e.g., the system or a portion thereof being evaluated with respect to one or more system criteria and one or more system modes).

The user devices 105 include one or more landline phones 141, one or more IP cameras 144, one or more cell phones 143, one or more user computing devices 145, one or more IP phones 150, one or more video conferencing equipment 148, one or more scanners 151, and/or one or more printers 142. The analysis system 10 can evaluate the use devices 103 collectively as assets, as they support system functions, and/or as they support security functions. The analysis system 10 may also evaluate each user device individually as an asset, as it supports system functions, and/or as it supports security functions. The analysis system may further evaluate one or more user devices as part of the physical assets of a system aspect (e.g., the system or a portion thereof being evaluated with respect to one or more system criteria and one or more system modes).

The system admin devices 104 includes one or more system admin computing devices 146, one or more system computing devices 194 (e.g., data management, access control, privileges, etc.), and/or one or more security management computing devices 147. The analysis system 10 can evaluate the system admin devices 103 collectively as assets, as they support system functions, and/or as they support security functions. The analysis system 10 may also evaluate each system admin device individually as an asset, as it supports system functions, and/or as it supports security functions. The analysis system may further evaluate one or more system admin devices as part of the physical assets of a system aspect (e.g., the system or a portion thereof being evaluated with respect to one or more system criteria and one or more system modes).

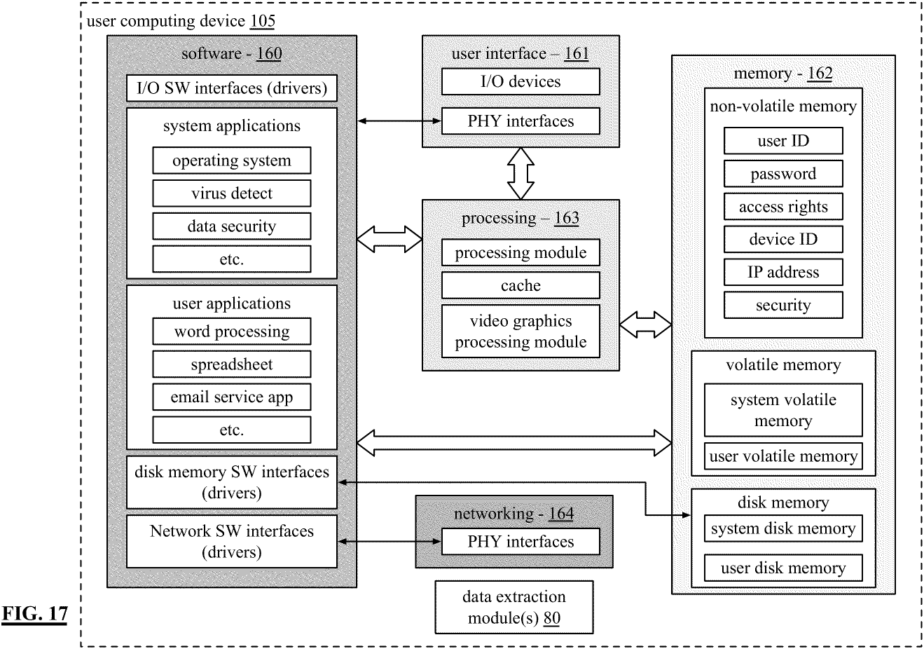

FIG. 17 is a schematic block diagram of an embodiment of a user computing device 105 that includes software 160, a user interface 161, processing resources 163, memory 162 and one or more networking device 164. The processing resources 163 include one or more processing modules, cache memory, and a video graphics processing module.

The memory 162 includes non-volatile memory, volatile memory and/or disk memory. The non-volatile memory stores hardware IDs, user credentials, security data, user IDs, passwords, access rights data, device IDs, one or more IP addresses and security software. The volatile memory includes system volatile memory and user volatile memory. The disk memory includes system disk memory and user disk memory. User memory (volatile and/or disk) stores user data and user applications. System memory (volatile and/or disk) stores system applications and system data.

The user interface 104 includes one or more I/O (input/output) devices such as video displays, keyboards, mice, eye scanners, microphones, speakers, and other devices that interface with one or more users. The user interface 161 further includes one or more physical (PHY) interface with supporting software such that the user computing device can interface with peripheral devices.

The software 160 includes one or more I/O software interfaces (e.g., drivers) that enable the processing module to interface with other components. The software 160 also includes system applications, user applications, disk memory software interfaces (drivers) and network software interfaces (drivers).

The networking device 164 may be a network card or network interface that intercouples the user computing device 105 to devices external to the computing device 105 and includes one or more PHY interfaces. For example, the network card is a WLAN card. As another example, he network card is a cellular data network card. As yet another example, the network card is an ethernet card.

The user computing device may further include a data extraction module 80. This would allow the analysis system 10 to obtain data directly from the user computing device. Regardless of how the analysis system 10 obtains data regarding the user computing device, the analysis system 10 can evaluate the user computing device as an asset, as it supports one or more system functions, and/or as it supports one or more security functions. The analysis system 10 may also evaluate each element of the user computing device (e.g., each software application, each drive, each piece of hardware, etc.) individually as an asset, as it supports one or more system functions, and/or as it supports one or more security functions.

FIG. 18 is a schematic block diagram of an embodiment of a server 107 that includes software 170, processing resources 171, memory 172 and one or more networking resources 173. The processing resources 171 include one or more processing modules, cache memory, and a video graphics processing module. The memory 172 includes non-volatile memory, volatile memory, and/or disk memory. The non-volatile memory stores hardware IDs, user credentials, security data, user IDs, passwords, access rights data, device IDs, one or more IP addresses and security software. The volatile memory includes system volatile memory and shared volatile memory. The disk memory include server disk memory and shared disk memory.

The software 170 includes one or more I/O software interfaces (e.g., drivers) that enable the software 170 to interface with other components. The software 170 includes system applications, server applications, disk memory software interfaces (drivers), and network software interfaces (drivers). The networking resources 173 may be one or more network cards that provides a physical interface for the server to a network.

The server 107 may further include a data extraction module 80. This would allow the analysis system 10 to obtain data directly from the server. Regardless of how the analysis system 10 obtains data regarding the server, the analysis system 10 can evaluate the server as an asset, as it supports one or more system functions, and/or as it supports one or more security functions. The analysis system 10 may also evaluate each element of the server (e.g., each software application, each drive, each piece of hardware, etc.) individually as an asset, as it supports one or more system functions, and/or as it supports one or more security functions.

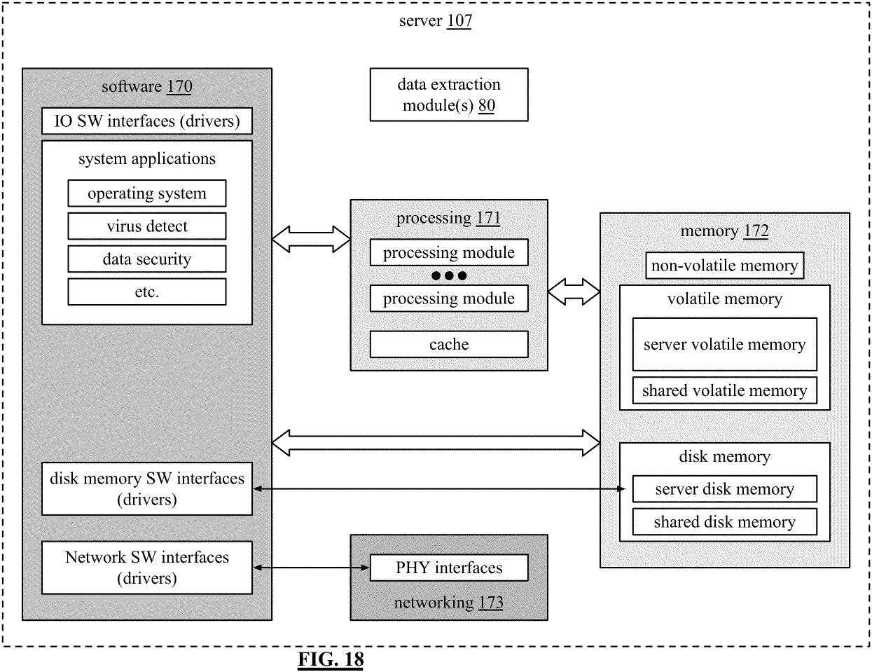

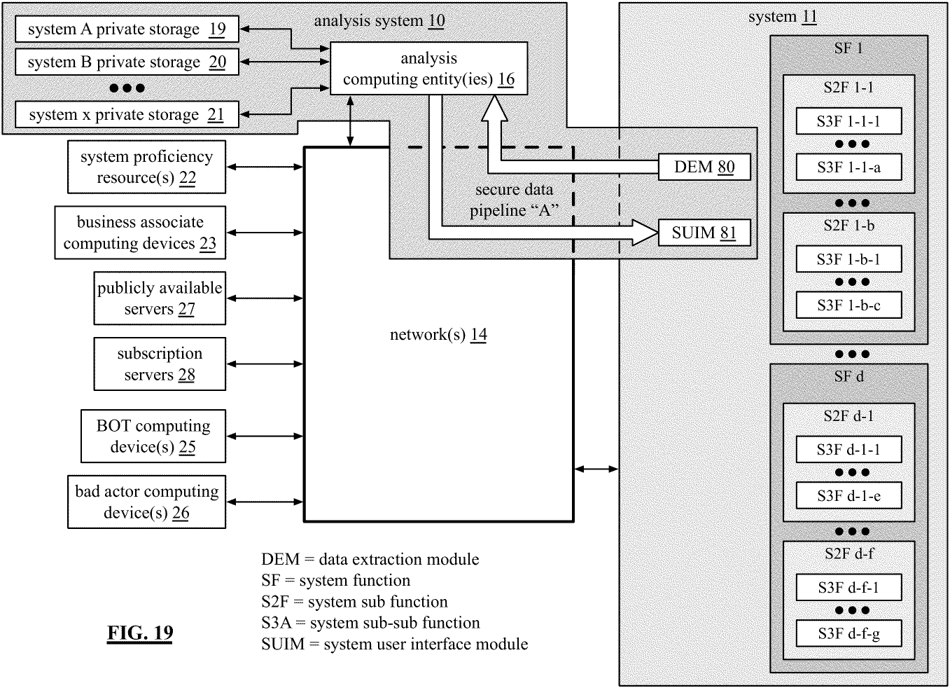

FIG. 19 is a schematic block diagram of another embodiment of a networked environment having a system 11 (or system 12 or system 13), the analysis system 10, one or more networks 14, one or more system proficiency resources 22, one or more business associated computing devices 23, one or more publicly available servers 27, one or more subscription based servers 28, one or more BOT computing devices 25, and one or more bad actor computing devices 26.

In this embodiment, the system 11 is shown to include a plurality of system functions (SF). A system function (SF) may include one or more system sub functions (S2F) and a system sub function (S2F) may include one or more system sub-sub functions (S3F). While being a part of the analysis system 10, at least one data extraction module (DEM) 80 and at least one system user interface module (SUIM) 81 are installed on the system 11.

A system function (SF) includes one or more business operations, one or more compliance requirements, one or more data flow objectives, one or more data access control objectives, one or more data integrity objectives, one or more data storage objectives, one or more data use objectives, and/or one or more data dissemination objectives. Business operation system functions are the primary purpose for the system 11. The system 11 is designed and built to support the operations of the business, which vary from business to business.

In general, business operations include operations regarding critical business functions, support functions for core business, product and/or service functions, risk management objectives, business ecosystem objectives, and/or business contingency plans. The business operations may be divided into executive management operations, information technology operations, marketing operations, engineering operations, manufacturing operations, sales operations, accounting operations, human resource operations, legal operations, intellectual property operations, and/or finance operations. Each type of business operation includes sub-business operations, which, in turn may include its own sub-operations.

For example, engineering operations includes a system function of designing new products and/or product features. The design of a new product or feature involves sub-functions of creating design specifications, creating a design based on the design specification, and testing the design through simulation and/or prototyping. Each of these steps includes sub-steps. For example, for the design of a software program, the design process includes the sub-sub system functions of creating a high level design from the design specifications; creating a low level design from the high level design; and the creating code from the low level design.

A compliance requirement may be a regulatory compliance requirement, a standard compliance requirement, a statutory compliance requirement, and/or an organization compliance requirement. For example, there are a regulatory compliance requirements when the organization has governmental agencies as clients. An example of a standard compliance requirement, encryption protocols are often standardized. Data Encryption Standard (DES), Advanced Encryption Standard (AES), RSA (Rivest-Shamir-Adleman) encryption, and public-key infrastructure (PKI) are examples of encryption type standards. HIPAA (health Insurance Portability and Accountability Act) is an example of a statutory compliance requirement. Examples of organization compliance requirements include use of specific vendor hardware, use of specific vendor software, use of encryption, etc.

A data flow objective is regarding where data can flow, at what rate data can and should flow, the manner in which the data flow, and/or the means over which the data flows. As an example of a data flow objective, data for remote storage is to flow via a secure data pipeline using a particular encryption protocol. As another example of a data flow objective, ingesting of data should have the capacity to handle a data rate of 100 giga-bits per second.

A data access control objective established which type of personnel and/or type of assets can access specific types of data. For example, certain members of the corporate department and human resources department have access to employee personnel files, while all other members of the organization do not.

A data integrity objective establishes a reliability that, when data is retrieved, it is the data that was stored, i.e., it was not lost, damaged, or corrupted. An example of a data integrity protocol is Cyclic Redundancy Check (CRC). Another example of a data integrity protocol is a hash function.

A data storage objective establishes the manner in which data is to be stored. For example, a data storage objective is to store data in a RAID system; in particular, a RAID 6 system. As another example, a data storage objective is regarding archiving of data and the type of storage to use for archived data.

A data use objective establishes the manner in which data can be used. For example, if the data is for sale, then the data use objective would establish what type of data is for sale, at what price, and what is the target customer. As another example, a data use objective establishes read only privileges, editing privileges, creation privileges, and/or deleting privileges.

A data dissemination objective establishes how the data can be shared. For example, a data dissemination objective is regarding confidential information and indicates how the confidential information should be marked, who in can be shared with internally, and how it can be shared externally, if at all.

The analysis system 10 may evaluate understanding, implementation, and/or operation of one or more system functions, one or more system sub functions, and/or one or more system sub-sub functions. The evaluation may be to produce an evaluation rating, to identify deficiencies, and/or to auto-correct deficiencies. For example, the analysis system 10 evaluates the understanding of the software development policies and/or processes. As another example, the analysis system 10 evaluates the use of software development policies and/or processes to implement a software program. As yet another example, analysis system 10 evaluates the operation of the software program with respect to the business operation, the design specifications, and/or the design.

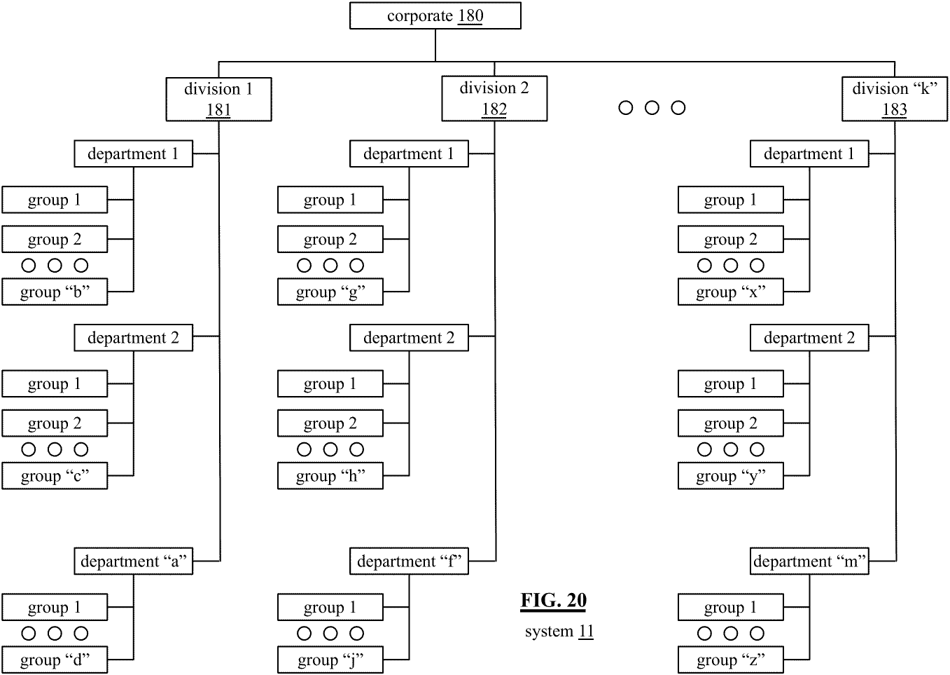

FIG. 20 is a schematic block diagram of another embodiment of a system 11 that includes, from a business operations perspective, divisions 181 – 183, departments, and groups. The business structure of the system 11, as in most businesses, is governed by a corporate department 180. The corporate department may have its own sub-system with structures and software tailored to the corporate function of the system. Organized under the corporate department 180 are divisions, division 1 181, division 2 182, through division k 183. These divisions may be different business divisions of a multi-national conglomerate, may be different functional divisions of a business, e.g., finance, marketing, sales, legal, engineering, research and development, etc. Under each division 1081 – 183 include a plurality of departments. Under each department are a number of groups.

The business structure is generic and can be used to represent the structure of most conventional businesses and/or organizations. The analysis system 10 is able to use this generic structure to create and categorize the business structure of the system 11. The creation and categorization of the business structure is done in a number of ways. Firstly, the analysis system 10 accesses corporate organization documents for the business and receive feedback from one or more persons in the business and use these documents and data to initially determine at least partially the business structure. Secondly, the analysis system 10 determines the network structure of the other system, investigate identities of components of the network structure, and construct a sub-division of the other system. Then, based upon software used within the sub-division, data character, and usage character, the analysis system 10 identifies more specifically the function of the divisions, departments and groups. In doing so, the analysis system 10 uses information known of third-party systems to assist in the analysis.

With the abstraction of the business structure, differing portions of the business structure may have different levels of abstraction from a component/sub-component/sub-sub-component/system/sub-system/sub-sub-system level based upon characters of differing segments of the business. For example. a more detailed level of abstraction for elements of the corporate and security departments of the business may be taken than for other departments of the business.

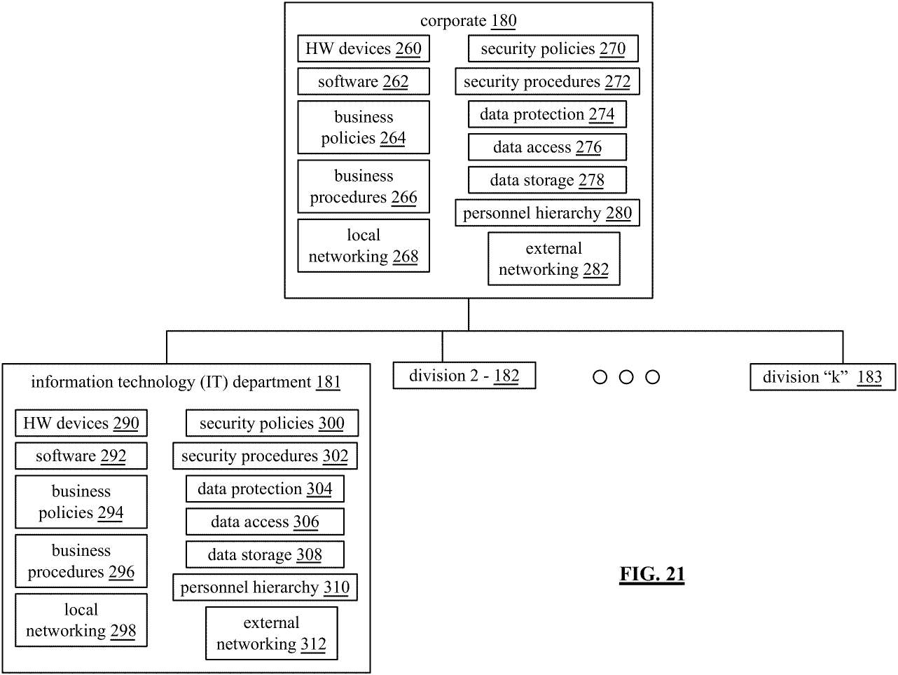

FIG. 21 is a schematic block diagram of another embodiment of a business structure of the system 11. Shown are a corporate department 180, an IT department 181, division 2 182 through division “k” 183, where k is an integer equal to or greater than 3. The corporate department 180 includes a plurality of hardware devices 260, a plurality of software applications 262, a plurality of business policies 264, a plurality of business procedures 266, local networking 268, a plurality of security policies 270, a plurality of security procedures 272, data protection resources 272, data access resources 276, data storage devices 278, a personnel hierarchy 280, and external networking 282. Based upon an assessment of these assets of the corporate department 180, analysis system 10 may evaluate the understanding, implementation, and/or operation of the assets, system functions, and/or security functions of the corporate department from a number of different perspectives, as will be described further with reference to one or more the subsequent figures.

Likewise, the IT department 181 includes a plurality of hardware devices 290, a plurality of software applications 292, a plurality of business policies 294, a plurality of business procedures 296, local networking 298, a plurality of security policies 300, a plurality of security procedures 302, data protection resources 304, data access resources 306, data storage devices 308, a personnel hierarchy 310, and external networking 312. Based upon an assessment of these assets of the IT department 181, the analysis system 10 may evaluate the understanding, implementation, and/or operation of the assets, system functions, and/or security functions of the IT department from a number of different perspectives, as will be described further with reference to one or more of the subsequent figures.

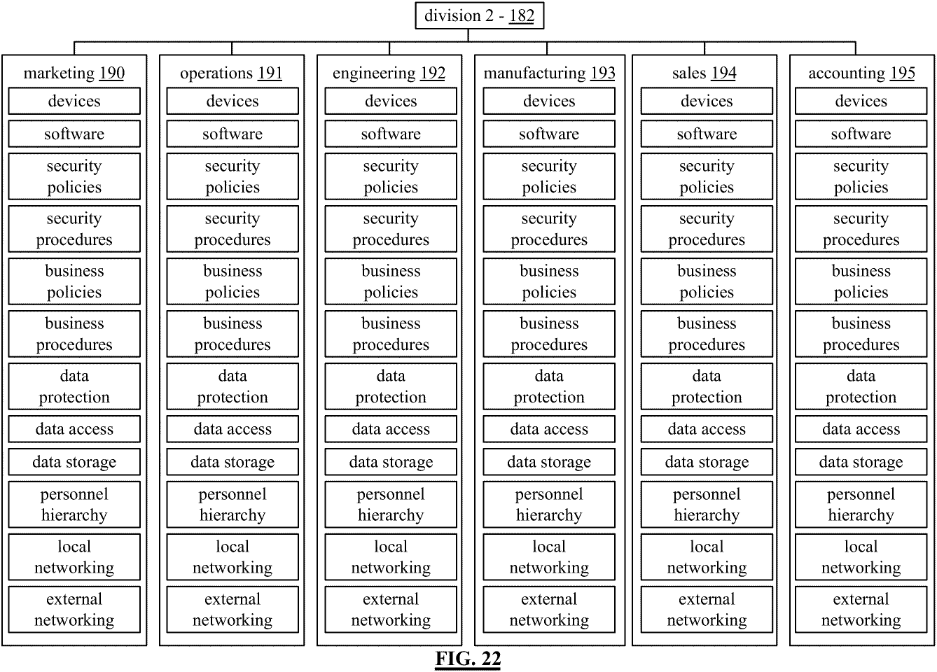

FIG. 22 is a schematic block diagram of another embodiment of a division 182 of a system that includes multiple departments. The departments include a marketing department 190, an operations department 191, an engineering department 192, a manufacturing department 193, a sales department 194, and an accounting department 195. Each of the departments includes a plurality of components relevant to support the corresponding business functions and/or security functions of the division and of the department. In particular, the marketing department 190 includes a plurality of devices, software, security policies, security procedures, business policies, business procedures, data protection resources, data access resources, data storage resources, a personnel hierarchy, local network resources, and external network resources.

Likewise, each of the operations department 191, the engineering department 192, the manufacturing department 193, the sales department 194, and the accounting department 195 includes a plurality of devices, software, security policies, security procedures, business policies, business procedures, data protection resources, data access resources, data storage resources, a personnel hierarchy, local network resources, and external network resources.

Further, within the business structure, a service mesh may be established to more effectively protect important portions of the business from other portions of the business. The service mesh may have more restrictive safety and security mechanisms for one part of the business than another portion of the business, e.g., manufacturing department service mesh is more restrictive than the sales department service mesh.

The analysis system 10 may evaluate the understanding, implementation, and/or operation of the assets, system functions, and/or security functions of the division 182, of each department, of each type of system elements, and/or each system element. For example, the analysis system 10 evaluates the data access policies and procedures of each department. As another example, the analysis system 10 evaluates the data storage policies, procedures, design, implementation, and/or operation of data storage within the engineering department 192.

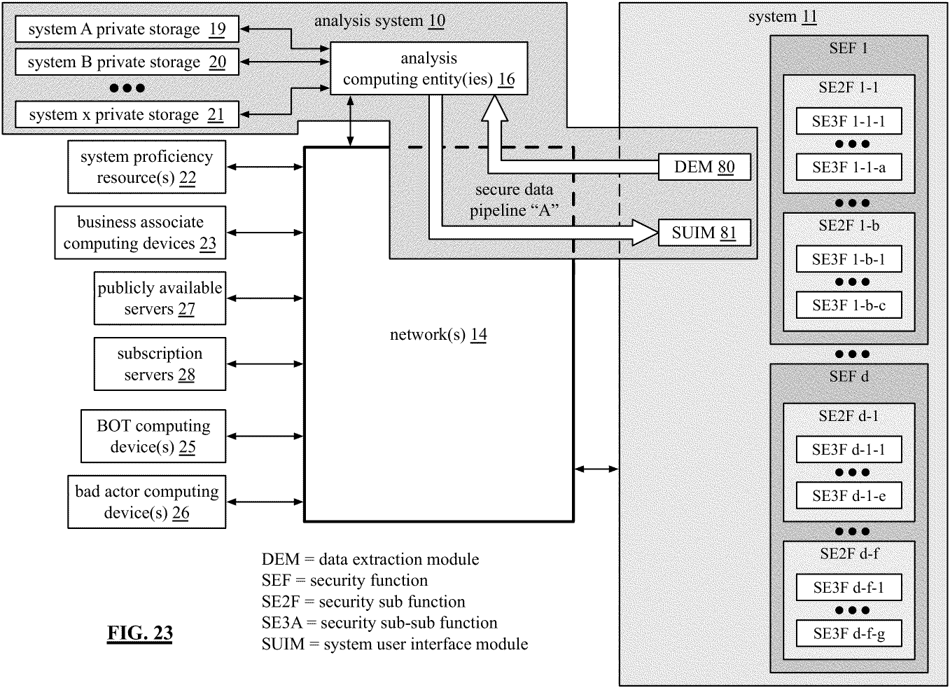

FIG. 23 is a schematic block diagram of another embodiment of a networked environment having a system 11 (or system 12 or system 13), the analysis system 10, one or more networks 14, one or more system proficiency resources 22, one or more business associated computing devices 23, one or more publicly available servers 27, one or more subscription based servers 28, one or more BOT computing devices 25, and one or more bad actor computing devices 26.

In this embodiment, the system 11 is shown to include a plurality of security functions (SEF). A security function (SEF) may include one or more system sub security functions (SE2F) and a security sub function (SE2F) may include one or more security sub-sub functions (SE3F). While being a part of the analysis system 10, at least one data extraction module (DEM) 80 and at least one system user interface module (SUIM) 81 are installed on the system 11. As used herein, a security function includes a security operation, a security requirement, a security policy, and/or a security objective with respect to data, system access, system design, system operation, and/or system modifications (e.g., updates, expansion, part replacement, maintenance, etc.).

A security function (SF) includes one or more threat detection functions, one or more threat avoidance functions, one or more threat resolution functions, one or more threat recovery functions, one or more threat assessment functions, one or more threat impact functions, one or more threat tolerance functions, one or more business security functions, one or more governance security functions, one or more data at rest protection functions, one or more data in transit protection functions, and/or one or more data loss prevention functions.

A threat detection function includes detecting unauthorized system access; detecting unauthorized data access; detecting unauthorized data changes; detecting uploading of worms, viruses, and the like; and/or detecting bad actor attacks. A threat avoidance function includes avoiding unauthorized system access; avoiding unauthorized data access; avoiding unauthorized data changes; avoiding uploading of worms, viruses, and the like; and/or avoiding bad actor attacks.

A threat resolution function includes resolving unauthorized system access; resolving unauthorized data access; resolving unauthorized data changes; resolving uploading of worms, viruses, and the like; and/or resolving bad actor attacks. A threat recovery function includes recovering from an unauthorized system access; recovering from an unauthorized data access; recovering from an unauthorized data changes; recovering from an uploading of worms, viruses, and the like; and/or recovering from a bad actor attack.

A threat assessment function includes accessing the likelihood of and/or mechanisms for unauthorized system access; accessing the likelihood of and/or mechanisms for unauthorized data access; accessing the likelihood of and/or mechanisms for unauthorized data changes; accessing the likelihood of and/or mechanisms for uploading of worms, viruses, and the like; and/or accessing the likelihood of and/or mechanisms for bad actor attacks.

A threat impact function includes determining an impact on business operations from an unauthorized system access; resolving unauthorized data access; determining an impact on business operations from an unauthorized data changes; determining an impact on business operations from an uploading of worms, viruses, and the like; and/or determining an impact on business operations from a bad actor attacks.

A threat tolerance function includes determining a level of tolerance for an unauthorized system access; determining a level of tolerance for an unauthorized data access; determining a level of tolerance for an unauthorized data changes; determining a level of tolerance for an uploading of worms, viruses, and the like; and/or determining a level of tolerance for a bad actor attacks.

A business security function includes data encryption, handling of third party data, releasing data to the public, and so on. A governance security function includes HIPAA compliance; data creation, data use, data storage, and/or data dissemination for specific types of customers (e.g., governmental agency); and/or the like.

A data at rest protection function includes a data access protocol (e.g., user ID, password, etc.) to store data in and/or retrieve data from system data storage; data storage requirements, which include type of storage, location of storage, and storage capacity; and/or other data storage security functions.

A data in transit protection function includes using a specific data transportation protocol (e.g., TCP/IP); using an encryption function prior to data transmission; using an error encoding function for data transmission; using a specified data communication path for data transmission; and/or other means to protect data in transit. A data loss prevention function includes a storage encoding technique (e.g., single parity encoding, double parity encoding, erasure encoding, etc.); a storage backup technique (e.g., one or two backup copies, erasure encoding, etc.); hardware maintenance and replacement policies and processes; and/or other means to prevent loss of data.

The analysis system 10 may evaluate understanding, implementation, and/or operation of one or more security functions, one or more security sub functions, and/or one or more security sub-sub functions. The evaluation may be to produce an evaluation rating, to identify deficiencies, and/or to auto-correct deficiencies. For example, the analysis system 10 evaluates the understanding of the threat detection policies and/or processes. As another example, the analysis system 10 evaluates the use of threat detection policies and/or processes to implement a security assets. As yet another example, analysis system 10 evaluates the operation of the security assets with respect to the threat detection operation, the threat detection design specifications, and/or the threat detection design.

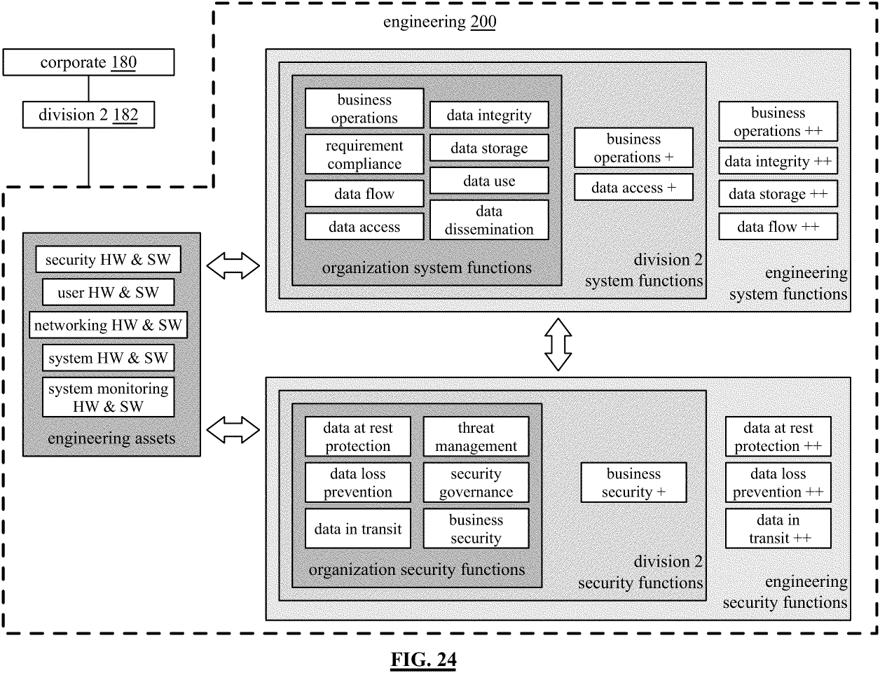

FIG. 24 is a schematic block diagram of an embodiment of an engineering department 200 of a division 182 that reports to a corporate department 180 of a system 11. The engineering department 200 includes engineering assets, engineering system functions, and engineering security functions. The engineering assets include security HW & SW, user device HW & SW, networking HW & SW, system HW & SW, system monitoring HW & SW, and/or other devices that includes HW and/or SW.

In this example, the organization’s system functions includes business operations, compliance requirements, data flow objectives, data access objectives, data integrity objectives, data storage objectives, data use objectives, and/or data dissemination objectives. These system functions apply throughout the system including throughout division 2 and for the engineering department 200 of division 2.

The division 182, however, can issues more restrictive, more secure, and/or more detailed system functions. In this example, the division has issued more restrictive, secure, and/or detailed business operations (business operations +) and more restrictive, secure, and/or detailed data access functions (data access +). Similarly, the engineering department 200 may issue more restrictive, more secure, and/or more detailed system functions than the organization and/or the division. In this example, the engineering department has issued more restrictive, secure, and/or detailed business operations (business operations ++) than the division; has issued more restrictive, secure, and/or detailed data flow functions (data flow ++) than the organization; has issued more restrictive, secure, and/or detailed data integrity functions (data integrity ++) than the organization; and has issued more restrictive, secure, and/or detailed data storage functions (data storage ++) than the organization.

For example, an organization level business operation regarding the design of new products and/or of new product features specifies high-level design and verify guidelines. The division issued more detailed design and verify guidelines. The engineering department issued even more detailed design and verify guidelines.

The analysis system 10 can evaluate the compliance with the system functions for the various levels. In addition, the analysis system 10 can evaluate that the division issued system functions are compliant with the organization issued system functions and/or are more restrictive, more secure, and/or more detailed. Similarly, the analysis system 10 can evaluate that the engineering department issued system functions are compliant with the organization and the division issued system functions and/or are more restrictive, more secure, and/or more detailed.

As is further shown in this example, the organization security functions includes data at rest protection, data loss prevention, data in transit protection, threat management, security governance, and business security. The division has issued more restrictive, more secure, and/or more detailed busines security functions (business security +). The engineering department has issued more restrictive, more secure, and/or more detailed data at rest protection (data at rest protection ++), data loss prevention (data loss prevention ++), and data in transit protection (data in transit ++).

The analysis system 10 can evaluate the compliance with the security functions for the various levels. In addition, the analysis system 10 can evaluate that the division issued security functions are compliant with the organization issued security functions and/or are more restrictive, more secure, and/or more detailed. Similarly, the analysis system 10 can evaluate that the engineering department issued security functions are compliant with the organization and the division issued security functions and/or are more restrictive, more secure, and/or more detailed.

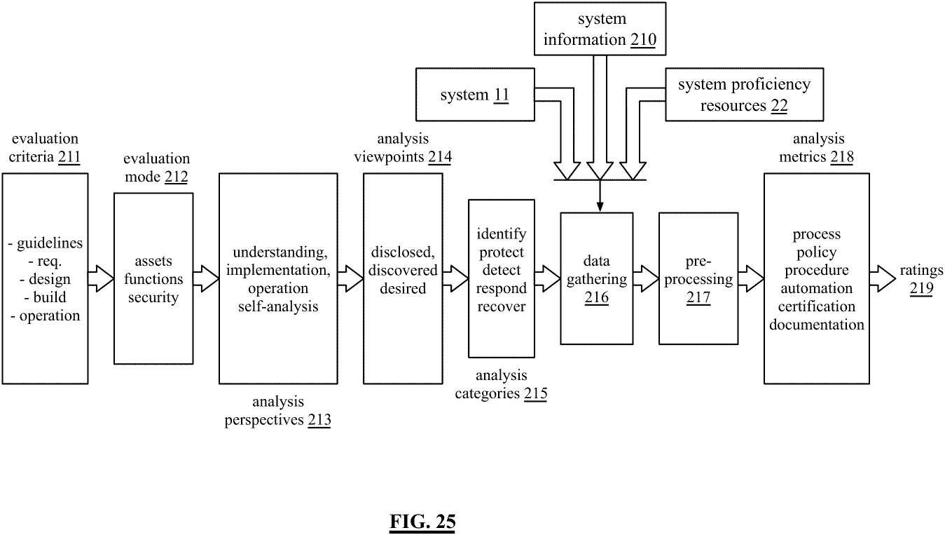

FIG. 25 is a schematic block diagram of an example of the functioning of an analysis system 10 evaluating a system element under test. Functionally, the analysis system 10 includes evaluation criteria 211, evaluation mode 212, analysis perspective 213, analysis viewpoint 214, analysis categories 215, data gathering 216, pre-processing 217, and analysis metrics 218 to produce one or more ratings 219. The evaluation criteria 211 includes guidelines, system requirements, system design, system build, and system operation. The evaluation mode 212 includes assets, system functions, and security functions. The evaluation criteria 211 and the evaluation mode 212 are part of the system aspect, which corresponds to the system, or portion thereof, being evaluated.

The analysis perspective 213 includes understanding, implementation, operation, and self-analysis. The analysis viewpoint includes disclosed, discovered, and desired. The analysis categories 215 include identify, protect, detect, respond, and recover. The analysis perspective 213, the analysis viewpoint 214, and the analysis categories correspond to how the system, or portion thereof, will be evaluated. For example, the system, or portion thereof, is being evaluated regarding the understanding of the system’s ability to identify assets, system functions, and/or security functions from discovered data.

The analysis metrics 218 includes process, policy, procedure, automation, certification, and documentation. The analysis metric 218 and the pre-processing 217 corresponds to manner of evaluation. For example, the policies regarding system’s ability to identify assets, system functions, and/or security functions from discovered data of the system, or portion thereof, are evaluated to produce an understanding evaluation rating.

In an example of operation, the analysis system 10 determines what portion of the system is evaluated (i.e., a system aspect). As such, the analysis system 10 determines one or more system elements (e.g., physical assets and/or conceptual assets), one or more system criteria (e.g., guidelines, system requirements, system design, system build, and/or system operation), and one or more system modes (e.g., assets, system functions, and security functions). The analysis system 10 may determine the system aspect in a variety of ways. For example, the analysis system 10 receives an input identifying the system aspect from an authorized operator of the system (e.g., IT personnel, executive personnel, etc.). As another example, the analysis system determines the system aspect in a systematic manner to evaluate various combinations of system aspects as part of an overall system evaluation. The overall system evaluation may be done one time, periodically, or continuously. As yet another example, the analysis system determines the system aspect as part of a systematic analysis of a section of the system, which may be done one time, periodically, or continuously.

The analysis system then determines how the system aspect is to be evaluated by selecting one or more analysis perspectives (understanding, implementation, operation, and self-analysis), one or more analysis viewpoints (disclosed, discovered, and desired), and one or more analysis categories (identify, protect, detect, respond, and recover). The analysis system 10 may determine how the system aspect is to be evaluated in a variety of ways. For example, the analysis system 10 receives an input identifying how the system aspect is to be evaluated from an authorized operator of the system (e.g., IT personnel, executive personnel, etc.). As another example, the analysis system determines how the system aspect is to be evaluated in a systematic manner to evaluate the system aspect in various combinations of analysis perspectives, analysis viewpoints, and analysis categories as part of an overall system evaluation. The overall system evaluation may be done one time, periodically, or continuously. As yet another example, the analysis system determines how the system aspect is to be evaluated as part of a systematic analysis of a section of the system, which may be done one time, periodically, or continuously.

The analysis system 10 also determines one or more analysis metrics (e.g., process, policy, procedure, automation, certification, and documentation) regarding the manner for evaluating the system aspect in accordance with how it’s to be evaluated. A policy sets out a strategic direction and includes high-level rules or contracts regarding issues and/or matters. For example, all software shall be a most recent version of the software. A process is a set of actions for generating outputs from inputs and includes one or more directives for generating outputs from inputs. For example, a process regarding the software policy is that software updates are to be performed by the IT department and all software shall be updated within one month of the release of the new version of software.

A procedure is the working instructions to complete an action as may be outlined by a process. For example, the IT department handling software updates includes a procedure that describes the steps for updating the software, verifying that the updated software works, and recording the updating and verification in a software update log. Automation is in regard to the level of automation the system includes for handling actions, issues, and/or matters of policies, processes, and/or procedures. Documentation is in regard to the level of documentation the system has regard guidelines, system requirements, system design, system build, system operation, system assets, system functions, security functions, system understanding, system implementation, operation of the system, policies, processes, procedures, etc. Certification is in regard to certifications of the system, such as maintenance certification, regulatory certifications, etc.

In an example, the analysis system 10 receives an input identifying a manner in which to evaluate the system aspect from an authorized operator of the system (e.g., IT personnel, executive personnel, etc.). As another example, the analysis system determines the manner in which to evaluate the system aspect in a systematic manner to evaluate the system aspect in various combinations of analysis metrics as part of an overall system evaluation. The overall system evaluation may be done one time, periodically, or continuously. As yet another example, the analysis system determines the manner in which to evaluate the system aspect as part of a systematic analysis of a section of the system, which may be done one time, periodically, or continuously.

Once the analysis system has determined the system aspect, how it is to be evaluated, and the manner for evaluation, the data gathering function 216 gathers data relevant to the system aspect, how it’s to be evaluated, and the manner of evaluation from the system 11, from resources that store system information 210 (e.g., from the system, from a private storage of the analysis system, etc.), and/or from one or more system proficiency resources 22. For example, a current evaluation is regarding an understanding (analysis perspective) of policies (analysis metric) to identify (analysis category) assets (evaluation mode) of an engineering department (system elements) regarding operations (evaluation criteria) that the assets perform based on discovered data (analysis viewpoint). As such, the data gathering function 216 gathers data regarding policies to identify assets of the engineering department and the operations they perform using one or more data discovery tools.

The pre-processing function 217 processes the gathered data by parsing the data, tagging the data, normalizing the data, and/or de-duplicating the data. The analysis system evaluates the processed data in accordance with the selected analysis metric to produce one or more ratings 219. For example, the analysis system would produce a rating regarding the understanding of policies to identify assets of an engineering department regarding operations that the assets perform based on discovered data. The rating 219 is on a scale from low to high. In this example, a low rating indicates issues with the understanding and a high rating indicates no issues with the understanding.

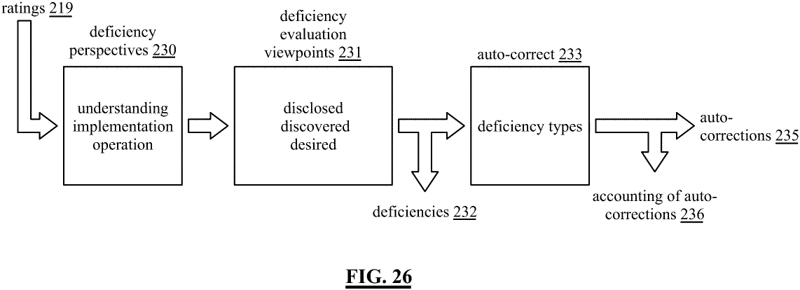

FIG. 26 is a schematic block diagram of another example of the functioning of an analysis system 10 evaluating a system element under test 91. The functioning of the analysis system includes a deficiency perspective function 230, a deficiency evaluation viewpoint function 31, and an auto-correction function 233.

The deficiency perspective function 230 receives one or more ratings 219 and may also receive the data used to generate the ratings 219. From these inputs, the deficiency perspective function 230 determines whether there is an understanding issue, an implementation issue, and/or an operation issue. For example, an understanding (analysis perspective) issue relates to a low understanding evaluation rating for a specific evaluation regarding policies (analysis metric) to identify (analysis category) assets (evaluation mode) of an engineering department (system elements) regarding operations (evaluation criteria) that the assets perform based on discovered data (analysis viewpoint).

As another example, an implementation (analysis perspective) issue relates to a low implementation evaluation rating for a specific evaluation regarding implementation and/or use of policies (analysis metric) to identify (analysis category) assets (evaluation mode) of an engineering department (system elements) regarding operations (evaluation criteria) that the assets perform based on discovered data (analysis viewpoint). As yet another example, an operation (analysis perspective) issue relates to a low operation evaluation rating for a specific evaluation regarding consistent, reliable, and/or accurate mechanism(s) to identify (analysis category) assets (evaluation mode) of an engineering department (system elements) regarding operations (evaluation criteria) that the assets perform based on discovered data (analysis viewpoint) and on policies (analysis metric).

When an understanding, implementation, and/or operation issue is identified, the deficiency evaluation viewpoint function 231 determines whether the issue(s) is based on disclosed data, discovered data, and/or desired data. For example, an understanding issue may be based on a difference between disclosed data and discovered data. As a specific example, the disclosed data includes a policy outline how to identify (analysis category) assets (evaluation mode) of an engineering department (system elements) regarding operations (evaluation criteria) that the assets perform, which is listed as version 1.12 and a last revision date of Oct. 2, 2020. In this specific example, the discovered data includes the same policy, but is has been updated to version 1.14 and the last revision date as Nov. 13, 2020. As such, the deficiency evaluation viewpoint function identifies a deficiency 232 in the disclosed data as being an outdated policy.

As another specific example, the disclosed data includes a policy outline how to identify (analysis category) assets (evaluation mode) of an engineering department (system elements) regarding operations (evaluation criteria) that the assets perform. The disclosed data also shows an inconsistent use and/or application of the policy resulting one or more assets not being properly identified. In this instance, the deficiency evaluation viewpoint function identifies a deficiency 232 in the disclosed data as being inconsistent use and/or application of the policy.

The auto-correct function 233 receives a deficiency 232 and interprets it to determine a deficiency type, i.e., a nature of the understanding issue, the implementation issue, and/or the operation issues. Continuing with the outdated policy example, the nature of the understanding issue is that there is a newer version of the policy. Since there is a newer version available, the auto-correct function 233 can update the policy to the newer version for the system (e.g., an auto-correction). In addition to making the auto-correction 235, the analysis system creates an accounting 236 of the auto-correction (e.g., creates a record). The record includes an identity of the deficiency, date information, what auto-correction was done, how it was done, verification that it was done, and/or more or less data as may be desired for recording auto-corrections.

As another specific example, a deficiency 232 is discovered that an asset exists in the engineering department that was not included in the disclosed data. This deficiency may include one or more related deficiencies. For example, a deficiency of design, a deficiency of build, a deficiency is oversight of asset installation, etc. The deficiencies of design, build, and/or installation oversight can be auto-corrected; the deficiency of an extra asset cannot. With regard to the deficiency of the extra asset, the analysis system generates a report regarding the extra asset and the related deficiencies.

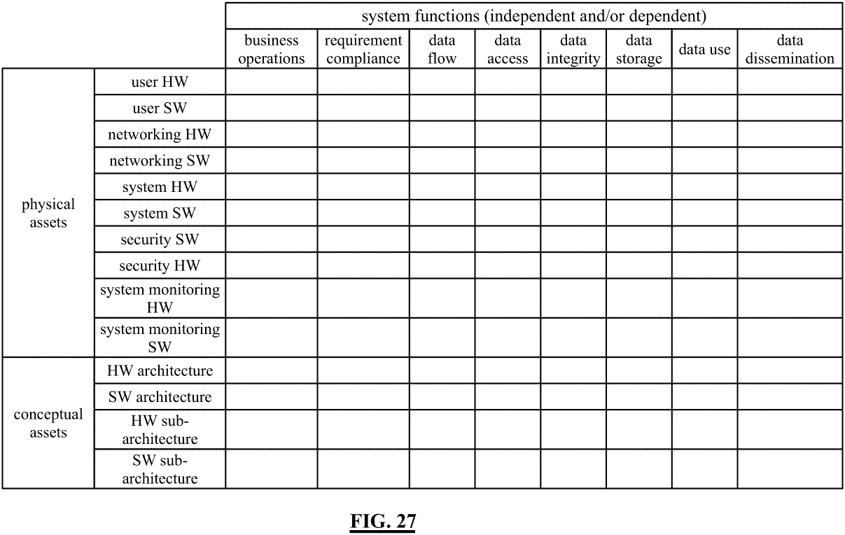

FIG. 27 is a diagram of another example of evaluation options of an analysis system 10 for evaluating a system element under test 91 (e.g., system aspect). The evaluation options are shown in the form of a table. The rows are assets (physical and conceptual) and the columns are system functions. The analysis system 10 can evaluate the system element under test 91 (e.g., system aspect) in one or more combinations of a row selection and a column selection.

For example, the analysis system 10 can evaluate user HW with respect to business operations. As another example, the analysis system 10 can evaluate physical assets with respect to data flow. As another example, the analysis system 10 can evaluate user SW with respect to all system functions.

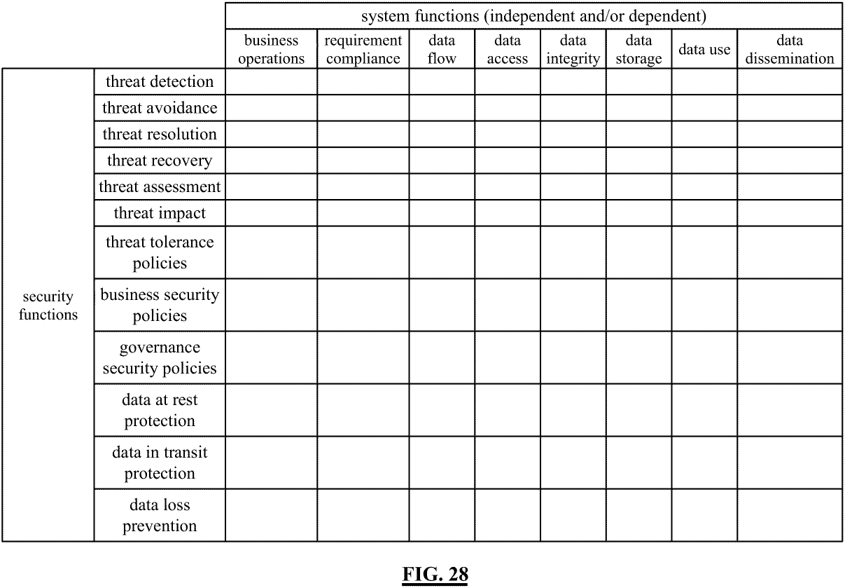

FIG. 28 is a diagram of another example of evaluation options of an analysis system 10 for evaluating a system element under test 91 (e.g., system aspect). The evaluation options are shown in the form of a table. The rows are security functions and the columns are system functions. The analysis system 10 can evaluate the system element under test 91 (e.g., system aspect) in one or more combinations of a row selection and a column selection.

For example, the analysis system 10 can evaluate threat detection with respect to business operations. As another example, the analysis system 10 can evaluate all security functions with respect to data flow. As another example, the analysis system 10 can evaluate threat avoidance with respect to all system functions.

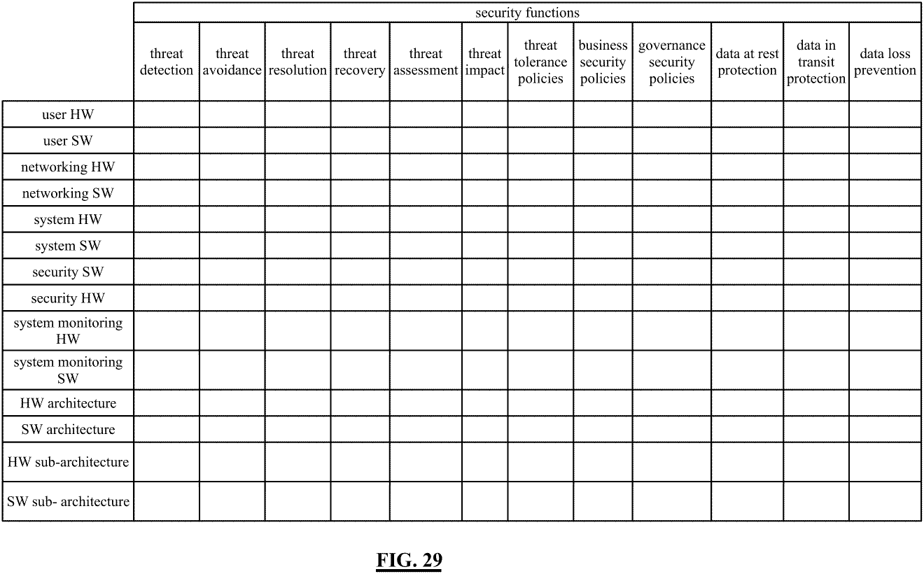

FIG. 29 is a diagram of another example of evaluation options of an analysis system 10 for evaluating a system element under test 91 (e.g., system aspect). The evaluation options are shown in the form of a table. The rows are assets (physical and conceptual) and the columns are security functions. The analysis system 10 can evaluate the system element under test 91 (e.g., system aspect) in one or more combinations of a row selection and a column selection.

For example, the analysis system 10 can evaluate user HW with respect to threat recovery. As another example, the analysis system 10 can evaluate physical assets with respect to threat resolution. As another example, the analysis system 10 can evaluate user SW with respect to all security functions.

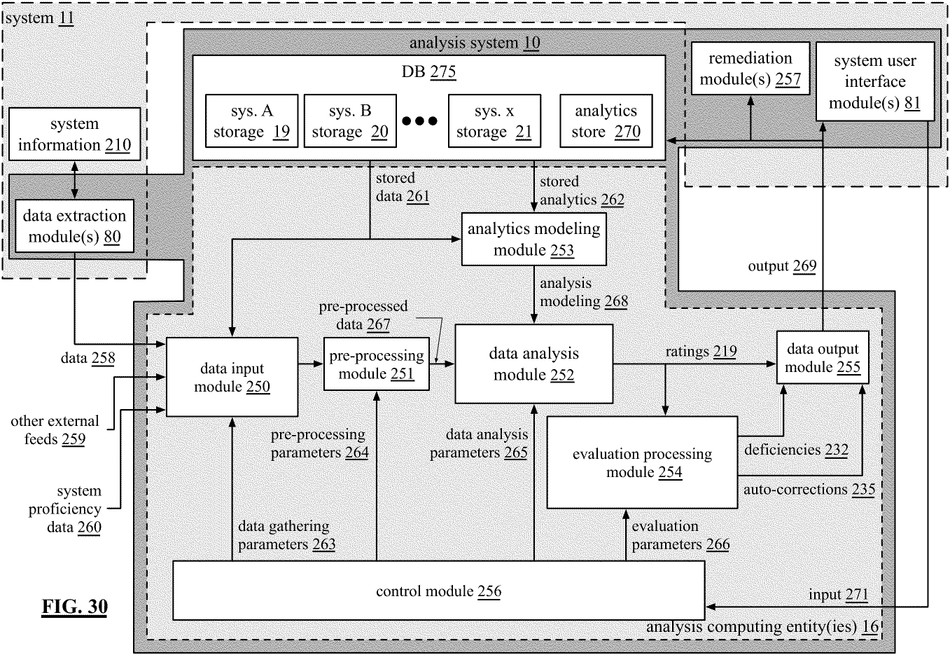

FIG. 30 is a schematic block diagram of an embodiment of an analysis system 10 that includes one or more computing entities 16, one or more databases 275, one or more data extraction modules 80, one or more system user interface modules 81, and one or more remediation modules 257. The computing entity(ies) 16 is configured to include a data input module 250, a pre-processing module 251, a data analysis module 252, an analytics modeling module 253, an evaluation processing module 254, a data output module 255, and a control module 256. The database 275, which includes one or more databases, stores the private data for a plurality of systems (e.g., systems A - x) and stores analytical data 270 of the analysis system 10.

In an example, the system 11 provides input 271 to the analysis system 10 via the system user interface module 80. The system user interface module 80 provides a user interface for an administrator of the system 11 and provides a secure end-point of a secure data pipeline between the system 11 and the analysis system 10. While the system user interface module 81 is part of the analysis system, it is loaded on and is executed on the system 11.

Via the system user interface module 81, the administrator makes selections as to how the system is to be evaluated and the desired output from the evaluation. For example, the administrator selects evaluate system, which instructs the analysis system 10 to evaluate the system from most every, if not every, combination of system aspect (e.g., system element, system criteria, and system mode), evaluation aspect (e.g., evaluation perspective, evaluation viewpoint, and evaluation category), evaluation metric (e.g., process, policy, procedure, automation, documentation, and certification), and analysis output (e.g., an evaluation rating, deficiencies identified, and auto-correction of deficiencies). As another example, the administrator selects one or more system aspects, one or more evaluation aspects, one or more evaluation metrics, and/or one or more analysis outputs.

The analysis system 10 receives the evaluation selections as part of the input 271. A control module 256 interprets the input 271 to determine what part of the system is to be evaluated (e.g., system aspects), how the system is to be evaluated (e.g., evaluation aspects), the manner in which the system is to be evaluated (e.g., evaluation metrics), and/or the resulting evaluation output (e.g., an evaluation rating, a deficiency report, and/or auto-correction). From the interpretation of the input, the control module 256 generates data gathering parameters 263, pre-processing parameters 264, data analysis parameters 265, and evaluation parameters 266.

The control module 256 provides the data gathering parameters 263 to the data input module 250. The data input module 250 interprets the data gathering parameters 263 to determine data to gather. For example, the data gathering parameters 263 are specific to the evaluation to be performed by the analysis system 10. As a more specific example, if the analysis system 10 is evaluating the understanding of the policies, processes, documentation, and automation regarding the assets built for an engineering department, then the data gathering parameters 263 would prescribe gathering data related to policies, processes, documentation, and automation regarding the assets built for the engineering department.

The data input module 250 may gather (e.g., retrieve, request, etc.) from a variety of sources. For example, the data input module 250 gathers data 258 from the data extraction module 80. In this example, the data input module 250 provides instructions to the data extraction module 80 regarding the data being requested. The data extraction module 80 pulls the requested data from system information 210, which may be centralized data of the system, system administration data, and/or data from assets of the system.

As another example, the data input module 250 gathers data from one or more external data feeds 259. A source of an external data feed includes one or more business associate computing devices 23, one or more publicly available servers 27, and/or one or more subscriber servers 28. Other sources of external data feeds 259 includes bot computing devices 25, and/or bad actor computing devices 26. Typically, the data input module 250 does not seek data inputs from bot computing devices 25 and/or bad actor computing devices 26 except under certain circumstances involving specific types of cybersecurity risks.

As another example, the data input module 250 gathers system proficiency data 260 from one or more system proficiency resources 22. As a specific example, for a data request that includes desired data, the data input module 250 addresses one or more system proficiencies resources 22 to obtain the desired system proficiency data 260. For example, system proficiency data 260 includes information regarding best-in-class practices (for system requirements, for system design, for system implementation, and/or for system operation), governmental and/or regulatory requirements, security risk awareness and/or risk remediation information, security risk avoidance, performance optimization information, system development guidelines, software development guideline, hardware requirements, networking requirements, networking guidelines, and/or other system proficiency guidance.

As another example, the data input module 250 gathers stored data 261 from the database 275. The stored data 261 is previously stored data that is unique to the system 11, is data from other systems, is previously processed data, is previously stored system proficiency data, and/or is previously stored data that assists in the current evaluation of the system.

The data input module 250 provides the gathered data to the pre-processing module 251. Based on the pre-processing parameters 264 (e.g., parse, tag, normalize, de-duplication, sort, filter, etc.), the pre-processing module 251 processes the gathered data to produce pre-processed data 267. The pre-processed data 267 may be stored in the database 275 and later retrieved as stored data 261. In another embodiment, the analysis system 10 does not include the pre-processing module 251 such that all the data collected by the data input module 250 is provided directly to the data analysis module 252.

The analysis modeling module 253 retrieves stored data 261 and/or stored analytics 262 from the database 275. The analysis modeling module 253 operates to increase the artificial intelligence of the analysis system 10. For example, the analysis modeling module 253 evaluates stored data from one or more systems in a variety of ways to test the evaluation processes of the analysis system. As a more specific example, the analysis modeling module 253 models the evaluation of understanding of the policies, processes, documentation, and automation regarding the assets built for an engineering department across multiple systems to identify commonalities and/or deviations. The analysis modeling module 253 interprets the commonalities and/or deviations to adjust parameters of the evaluation of understanding and models how the adjustments affect the evaluation of understanding. If the adjustments have a positive effect, the analysis modeling module 253 stores them as analytics 262 and/or analysis modeling 268 in the database 275.

The data analysis module 252 receives the pre-processed data 267, the data analysis parameters 265 and may further receive optional analysis modeling data 268. The data analysis parameters 265 includes identity of selected evaluation categories (e.g., identify, protect, detect, respond, and recover), identity of selected evaluation sub-categories, identity of selected evaluation sub-sub categories, identity of selected analysis metrics (e.g., process, policy, procedure, automation, certification, and documentation), grading parameters for the selected analysis metrics (e.g., a scoring scale for each type of analysis metric), identity of selected analysis perspective (e.g., understanding, implementation, operation, and self-analysis), and/or identity of selected analysis viewpoint (e.g., disclosed, discovered, and desired).

The data analysis module 252 generates one or more ratings 219 for the pre-processed data 267 based on the data analysis parameters 265. The data analysis module 252 may adjust the generation of the one or more rating 219 based on the analysis modeling data 268. For example, the data analysis module 252 evaluates the understanding of the policies, processes, documentation, and automation regarding the assets built for an engineering department based on the pre-processed data 267 to produce at least one evaluation rating 219.

Continuing with this example, the analysis modeling 268 is regarding the evaluation of understanding of the policies, processes, documentation, and automation regarding the assets built for an engineering department of a plurality of different organizations operating on a plurality of different systems. The modeling indicates that if processes are well understood, the understanding of the policies is less significant in the overall understanding. In this instance, the data analysis module 252 may adjusts its evaluation rating of the understanding to a more favorably rating if the pre-processed data 267 correlates with the modeling (e.g., good understanding of processes).

The data analysis module 252 provides the rating(s) 219 to the data output module 255 and to the evaluation processing module 254. The data output module 255 provides the rating(s) 219 as an output 269 to the system user interface module 81. The system user interface module 81 provides a graphical rendering of the rating(s) 219.

The evaluation processing module 254 processes the rating(s) 219 based on the evaluation parameters 266 to identify deficiencies 232 and/or to determine auto-corrections 235. The evaluation parameters 266 provide guidance on how to evaluate the rating(s) 219 and whether to obtain data (e.g., pre-processed data, stored data, etc.) to assist in the evaluation. The evaluation guidance includes how deficiencies are to be identified. For example, identify the deficiencies based on the disclosed data, based on the discovered data, based on differences between the disclosed and discovered data, based on differences between the disclosed and desired data, and/or based on differences between the discovered and desired data. The evaluation guidance further includes whether auto-correction is enabled. The evaluation parameters 266 may further include deficiency parameters, which provide a level of tolerance between the disclosed, discovered, and/or desired data when determining deficiencies.

The evaluation processing module 254 provides deficiencies 232 and/or the auto-corrections 235 to the data output module 255. The data output module 255 provides the deficiencies 232 and/or the auto-corrections 235 as an output 269 to the system user interface module 81 and to the remediation module 257. The system user interface module 81 provides a graphical rendering of the deficiencies 232 and/or the auto-corrections 235. In another embodiment, the analysis system does not include the evaluation processing module 254 and provides ratings 219 to the data output module 255.

The remediation module 257 interprets the deficiencies 232 and the auto-corrections 235 to identify auto-corrections to be performed within the system. For example, if a deficiency is a computing device having an outdated user software application, the remediation module 257 coordinates obtaining a current copy of the user software application, uploading it on the computing device, and updating maintenance logs. In another embodiment, the analysis system 10 does not include the remediation module 257 or the evaluation processing module 254 and provides ratings 219 to the data output module 255.

FIG. 31 is a schematic block diagram of an embodiment of a data analysis module 252 of an analysis system 10. The data analysis module 252 includes a data module 321 and an analysis & score module 336. The data module 321 includes a data parse module 320, one or more data storage modules 322-334, and a source data matrix 335. A data storage module 322-334 may be implemented in a variety of ways. For example, a data storage module is a buffer. As another example, a data storage module is a section of memory (45, 56, 57, and/or 62 of the FIG. 2 series) of a computing device (e.g., an allocated, or ad hoc, addressable section of memory). As another example, a data storage module is a storage unit (e.g., a computing device used primarily for storage). As yet another example, a data storage module is a section of a database (e.g., an allocated, or ad hoc, addressable section of a database).

The data module 321 operates to provide the analyze & score module 336 with source data 337 selected from incoming data based on one or more data analysis parameters 265. The data analysis parameter(s) 265 indicate(s) how the incoming data is to be parsed (if at all) and how it is to be stored within the data storage modules 322-334. A data analysis parameter 265 includes system aspect storage parameters 345, evaluation aspect storage parameters 346, and evaluation metric storage parameters 347. A system aspect storage parameter 345 may be null or includes information to identify one or more system aspects (e.g., system element, system criteria, and system mode), how the data relating to system aspects is to be parsed, and how the system aspect parsed data is to be stored.

An evaluation aspect storage parameter 346 may be null or includes information to identify one or more evaluation aspects (e.g., evaluation perspective, evaluation viewpoint, and evaluation category), how the data relating to evaluation aspects is to be parsed, and how the evaluation aspect parsed data is to be stored. An evaluation metric storage parameter 347 may be null or includes information to identify one or more evaluation metrics (e.g., process, policy, procedure, certification, documentation, and automation), how the data relating to evaluation metrics is to be parsed, and how the evaluation metric parsed data is to be stored. Note that the data module 321 interprets the data analysis parameters 265 collectively such that parsing and storage are consistent with the parameters.

The data parsing module 320 parses incoming data in accordance with the system aspect storage parameters 345, evaluation aspect storage parameters 346, and evaluation metric storage parameters 347, which generally correspond to what part of the system is being evaluated, how the system is being evaluated, the manner of evaluation, and/or a desired analysis output. As such, incoming data may be parsed in a variety of ways. The data storage modules 322 - 334 are assigned to store parsed data in accordance with the storage parameters 345-347. For example, the incoming data, which includes pre-processed data 267, other external feed data 259, data 258 received via a data extraction module, stored data 261, and/or system proficiency data 260, is parsed based on system criteria (of the system aspect) and evaluation viewpoint (of the evaluation aspect). As a more specific example, the incoming data is parsed into, and stored, as follows:
disclosed guideline data that is stored in a disclosed guideline data storage module 322;
discovered guideline data that is stored in a discovered guideline data storage module 323;
desired guideline data that is stored in a desired guideline data storage module 324;
disclosed system requirement (sys. req.) data that is stored in a disclosed system requirement data storage module 325;
discovered system requirement (sys. req.) data that is stored in a discovered system requirement data storage module 326;
desired system requirement (sys. req.) data that is stored in a desired system requirement data storage module 327;
disclosed design and/or build data that is stored in a disclosed design and/or build data storage module 328;
discovered design and/or build data that is stored in a discovered design and/or build data storage module 329;
desired design and/or build data that is stored in a desired design and/or build data storage module 330;
disclosed system operation data that is stored in a disclosed system operation data storage module 331;
discovered system operation data that is stored in a discovered system operation data storage module 332;
desired system operation data that is stored in a desired system operation data storage module 333; and/or
other data that is stored in another data storage module 334.

As another example of parsing, the incoming data is parsed based on a combination of one or more system aspects (e.g., system elements, system criteria, and system mode) or sub-system aspects thereof, one or more evaluation aspects (e.g., evaluation perspective, evaluation viewpoint, and evaluation category) or sub-evaluation aspects thereof, and/or one or more evaluation rating metrics (e.g., process, policy, procedure, certification, documentation, and automation) or sub-evaluation rating metrics thereof. As a specific example, the incoming data is parsed based on the evaluation rating metrics, creating processed parsed data, policy parsed data, procedure parsed data, certification parsed data, documentation parsed data, and automation parsed data. As another specific example, the incoming data is parsed based on the evaluation category of identify and its sub-categories of asset management, business environment, governance, risk assessment, risk management, access control, awareness &, training, and/or data security.

As another example of parsing, the incoming data is not parsed, or is minimally parsed. As a specific example, the data is parsed based on timestamps: data from one time period (e.g., a day) is parsed from data of another time period (e.g., a different day).

The source data matrix 335, which may be a configured processing module, retrieves source data 337 from the data storage modules 322-334. The selection corresponds to the analysis being performed by the analyze & score module 336. For example, if the analyze & score module 336 is evaluating the understanding of the policies, processes, documentation, and automation regarding the assets built for the engineering department, then the source data 337 would be data specific to policies, processes, documentation, and automation regarding the assets built for the engineering department.

The analyze & score module 336 generates one or more ratings 219 for the source data 337 in accordance with the data analysis parameters 265 and analysis modeling 268. The data analysis parameters 265 includes system aspect analysis parameters 342, evaluation aspect analysis parameters 343, and evaluation metric analysis parameters 344. The analyze & score module 336 is discussed in greater detail with reference to FIG. 11.

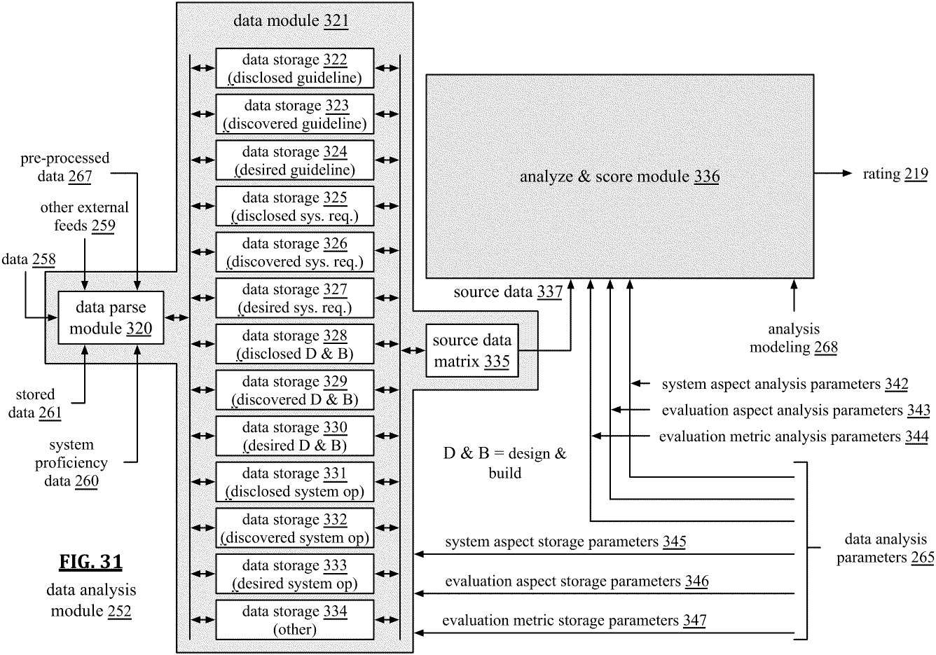

FIG. 32 is a schematic block diagram of an embodiment of an analyze and score module 336 includes a matrix module 341 and a scoring module 348. The matrix module 341 processes an evaluation mode matrix, an evaluation perspective matrix, an evaluation viewpoint matrix, and an evaluation categories matrix to produce a scoring input. The scoring module 348 includes an evaluation metric matrix to process the scoring input data in accordance with the analysis modeling 268 to produce the rating(s) 219.

For example, the matrix module 341 configures the matrixes based on the system aspect analysis parameters 342 and the evaluation aspect analysis parameters 343 to process the source data 337 to produce the scoring input data. As a specific example, the system aspect analysis parameters 342 and the evaluation aspect analysis parameters 343 indicate assets as the evaluation mode, understanding as the evaluation perspective, discovered as the evaluation viewpoint, and the identify as the evaluation category.

Accordingly, the matrix module 341 communicates with the source data matrix module 335 of the data module 321 to obtain source data 337 relevant to assets, understanding, discovered, and identify. The matrix module 341 may organize the source data 337 using an organization scheme (e.g., by asset type, by evaluation metric type, by evaluation sub-categories, etc.) or keep the source data 337 as a collection of data. The matrix module 341 provides the scoring input data 344 as a collection of data or as organized data to the scoring module 348.

Continuing with the example, the scoring module 248 receives the scoring input data 348 and evaluates in accordance with the evaluation metric analysis parameters 344 and the analysis modeling 268 to produce the rating(s) 219. As a specific example, the evaluation metric analysis parameters 344 indicate analyzing the scoring input data with respect to processes. In this instance, the analysis modeling 268 provides a scoring mechanism for evaluating the scoring input data with respect to processes to the scoring module 248. For instance, the analysis modeling 268 includes six levels regarding processes and a corresponding numerical rating: none (e.g., 0), inconsistent (e.g., 10), repeatable (e.g., 20), standardized (e.g., 30), measured (e.g., 40), and optimized (e.g., 50).

In addition, the analysis modeling 268 includes analysis protocols for interpreting the scoring input data to determine its level and corresponding rating. For example, if there are no processes regarding identifying assess of the discovered data, then an understanding level of processes would be none (e.g., 0), since there are no processes. As another example, if there are some processes regarding identifying assess of the discovered data, but there are gaps in the processes (e.g., identifies some assets, but not all, do not produce consistent results), then an understanding level of processes would be inconsistent (e.g., 10). To determine if there are gaps in the processes, the score module 248 executes the processes of the discovered data to identify assets. The scoring module 248 also executes one or more asset discovery tools to identify assets and then compares the two results. If there are inconsistencies in the identified assets, then there are gaps in the processes.

As a further example, the processes regarding identifying assess of the discovered data are repeatable (e.g., produces consistent results, but there are variations in the processes from process to process, and/or the processes are not all regulated) but not standardized (e.g., produces consistent results, but there are no appreciable variations in the processes from process to process, and/or the processes are regulated). If the processes are repeatable but not standardized, the scoring module establishes an understanding level of the processes as repeatable (e.g., 20).

If the processes are standardized, the scoring module then determines whether the processes are measured (e.g., precise, exact, and/or calculated to the task of identifying assets). If not, the scoring module establishes an understanding level of the processes as standardized (e.g., 30).

If the processes are measured, the scoring module then determines whether the processes are optimized (e.g., up-to-date and improvement assessed on a regular basis as part of system protocols). If not, the scoring module establishes an understanding level of the processes as measured (e.g., 40). If so, the scoring module establishes an understanding level of the processes as optimized (e.g., 50).

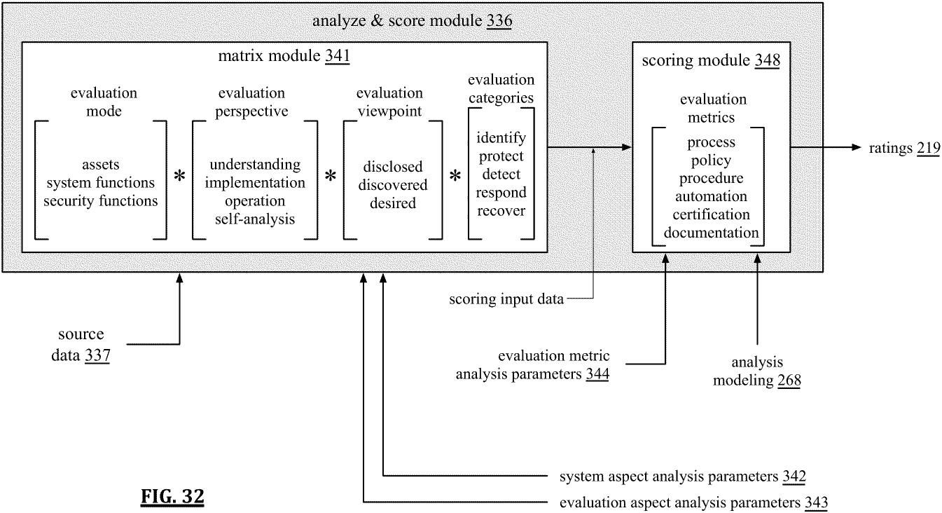

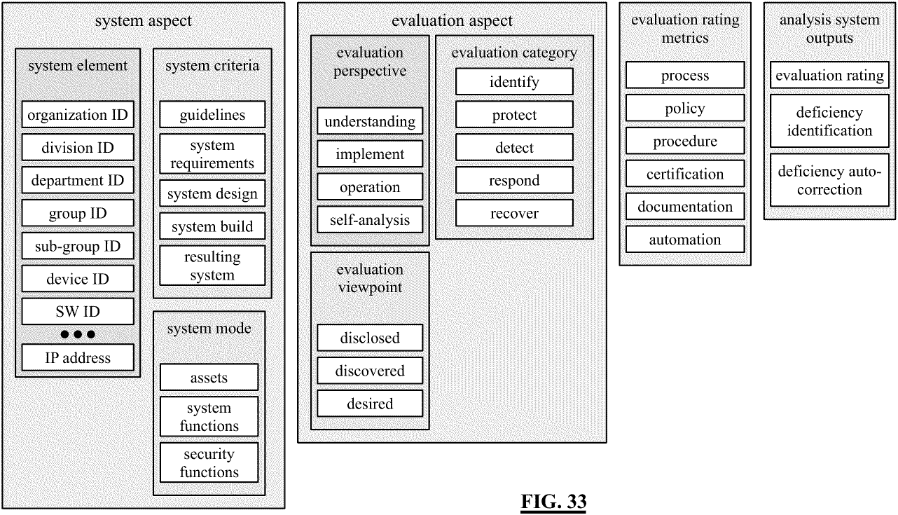

FIG. 33 is a diagram of an example of system aspect, evaluation aspect, evaluation rating metric, and analysis system output options of an analysis system 10 for analyzing a system 11, or portion thereof. The system aspect corresponds to what part of the system is to be evaluated by the analysis system. The evaluation aspect indicates how the system aspect is to be evaluated. The evaluation rating metric indicates the manner of evaluation of the system aspect in accordance with the evaluation aspect. The analysis system output indicates the type of output to be produced by the analysis system based on the evaluation of the system aspect in accordance with the evaluation aspect as per the evaluation rating metric.

The system aspect includes system elements, system criteria, and system modes. A system element is a physical asset and/or a conceptual asset. For example, a physical asset is a computing entity, a computing device, a user software application, a system software application (e.g., operating system, etc.), a software tool, a network software application, a security software application, a system monitoring software application, and the like. As another example, a conception asset is a hardware architecture (e.g., identification of a system’s physical components, their capabilities, and their relationship to each other) and/or sub-architectures thereof and a software architecture (e.g., fundamental structures for the system’s software, their requirements, and inter-relational operations) and sub-architectures thereof.

A system element is identifiable in a variety of ways. For example, it can be identified by an organization identifier (ID), which would be associated with most, if not all, system elements of a system. As another example, a system element can be identified by a division ID, where the division is one of a plurality of divisions in the organization. As another example, a system element can be identified by a department ID, where the department is one of a plurality of departments in a division. As yet another example, a system element can be identified by a department ID, where the department is one of a plurality of departments in a division. As a further example, a system element can be identified by a group ID, where the department is one of a plurality of groups in a department. As a still further example, a system element can be identified by a sub-group ID, where the department is one of a plurality of sub-groups in a group. With this type of identifier, a collection of system elements can be selected for evaluation by using an organization ID, a division ID, a department ID, a group ID, or a sub-group ID.

A system element may also be identified based on a user ID, a serial number, vendor data, an IP address, etc. For example, a computing device has a serial number and vendor data. As such, the computing device can be identified for evaluation by its serial number and/or the vendor data. As another example, a software application has a serial number and vendor data. As such, the software application can be identified for evaluation by its serial number and/or the vendor data.

In addition, an identifier of one system element may link to one or more other system elements. For example, computing device has a device ID, a user ID, and/or a serial number to identify it. The computing device also includes a plurality of software applications, each with its own serial number. In this example, the software identifiers are linked to the computing device identifier since the software is loaded on the computing device. This type of an identifier allows a single system element to be identified for evaluation.

The system criteria include information regarding the development, operation, and/or maintenance of the system 11. For example, a system criterion is a guideline, a system requirement, a system design component, a system build component, the system, and system operation.

A guideline includes one or more of business objectives, security objectives, NIST cybersecurity guidelines, system objectives, governmental and/or regulatory requirements, third party requirements, etc. and are used to help create the system requirements. System requirements outline the hardware requirements for the system, the software requirements for the system, the networking requirements for the system, the security requirements for the system, the logical data flow for the system, the hardware architecture for the system, the software architecture for the system, the logical inputs and outputs of the system, the system input requirements, the system output requirements, the system’s storage requirements, the processing requirements for the system, system controls, system backup, data access parameters, and/or specification for other system features.

The system requirements are used to help create the system design. The system design includes a high-level design (HDL), a low level design (LLD), a detailed level design (DLD), and/or other design levels. High level design is a general design of the system. It includes a description of system architecture; a database design; an outline of platforms, services, and processes the system will require; a description of relationships between the assets, system functions, and security functions; diagrams regarding data flow; flowcharts; data structures; and/or other documentation to enable more detailed design of the system.

Low level design is a component level design that is based on the HLD. It provides the details and definitions for every system component (e.g., HW and SW). In particular, LLD specifies the features of the system components and component specifications. Detailed level design describes the interaction of every component of the system.

The system is built based on the design to produce a resulting system (i.e., the implemented assets). The assets of system operate to perform the system functions and/or security functions.

The system mode indicates the assets of the system, the system functions of the system, and/or the security functions of the system are to be evaluated. Assets, system functions, and security functions have been previously discussed with reference to FIGS. 5-6.

The evaluation aspect, which indicates how the system aspect is to be evaluated, includes evaluation perspective, evaluation viewpoint, and evaluation category. The evaluation perspective includes understanding (e.g., how well the system is known, should be known, etc.); implementation, which includes design and/or build, (e.g., how well is the system designed, how well should it be designed); system performance, and/or system operation (e.g., how well does the system perform and/or operate, how well should it perform and/or operate); and self-analysis (e.g., how self-aware is the system, how self-healing is the system, how self-updating is the system).

The evaluation viewpoint includes disclosed data, discovered data, and desired data. Disclosed data is the known data of the system at the outset of an analysis, which is typically supplied by a system administrator and/or is obtained from data files of the system. Discovered data is the data discovered about the system from the by the analysis system during the analysis. Desired data is the data obtained by the analysis system from system proficiency resources regarding desired guidelines, system requirements, system design, system build, and/or system operation. Differences in disclosed, discovered, and desired data are evaluated to support generating an evaluation rating, to identify deficiencies, and/or to determine and provide auto-corrections.

The evaluation category includes an identify category, a protect category, a detect category, a respond category, and a recover category. In general, the identify category is regarding identifying assets, system functions, and/or security functions of the system; the protect category is regarding protecting assets, system functions, and/or security functions of the system from issues that may adversely affect; the detect category is regarding detecting issues that may, or have, adversely affect assets, system functions, and/or security functions of the system; the respond category is regarding responding to issues that may, or have, adversely affect assets, system functions, and/or security functions of the system; and the recover category is regarding recovering from issues that have adversely affect assets, system functions, and/or security functions of the system. Each category includes one or more sub-categories and each sub-category may include one or more sub-sub categories as discussed with reference to FIG. XX.

The evaluation rating metric includes process, policy, procedure, certification, documentation, and automation. The evaluation rating metric may include more or less topics. The analysis system output options include evaluation rating, deficiency identification, and deficiency auto-correction.

With such a significant number of options with the system aspect, the evaluation aspect, the evaluation rating metrics, and analysis system output options, the analysis system can analyze a system in thousands, or more, combinations. For example, the analysis system 10 could provide an evaluation rating for the entire system with respect to its vulnerability to cyber-attacks. The analysis system 10 could also identify deficiencies in the system’s cybersecurity processes, policies, documentation, implementation, operation, assets, and/or security functions based on the evaluation rating. The analysis system 10 could further auto-correct at least some of the deficiencies in the system’s cybersecurity processes, policies, documentation, implementation, operation, assets, and/or security functions.

As another example, the analysis system 10 could evaluates the system’s requirements for proper use of software (e.g., authorized to use, valid copy, current version) by analyzing every computing device in the system as to the system’s software use requirements. From this analysis, the analysis system generates an evaluation rating. The analysis system 10 could also identify deficiencies in the compliance with the system’s software use requirements (e.g., unauthorized use, invalid copy, outdated copy). The analysis system 10 could further auto-correct at least some of the deficiencies in compliance with the system’s software use requirements (e.g., remove invalid copies, update outdated copies).

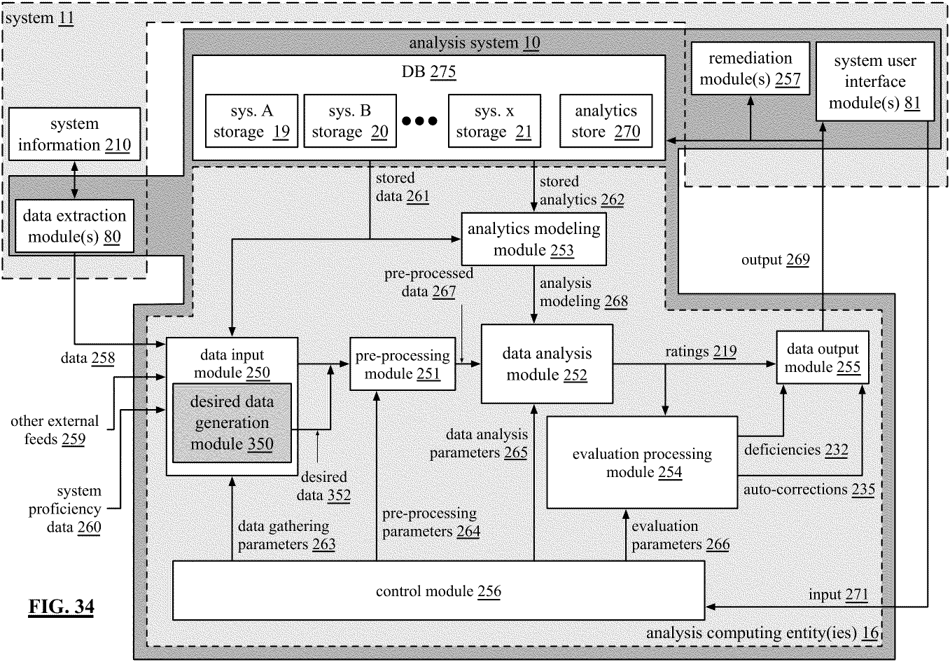

FIG. 34 is a schematic block diagram of an embodiment of an analysis system 10 that includes one or more computing entities 16, one or more databases 275, one or more data extraction modules 80, one or more system user interface modules 81, and one or more remediation modules 257. The computing entity(ies) 16 is configured to include a data input module 250, a pre-processing module 251, a data analysis module 252, an analytics modeling module 253, an evaluation processing module 254, a data output module 255, and a control module 256. The database 275, which includes one or more databases, stores the private data for a plurality of systems (e.g., systems A - x) and stores analytical data 270 of the analysis system 10. The diagram of FIG. 34 is similar to the diagram of FIG. 30 except that the data input module 250 is shown in more detail. In particular, the data input module 250 includes a desired data generation module 350.

In an example, the system 11 provides input 271 to the analysis system 10 via the system user interface module 80. The system user interface module 80 provides a user interface for an administrator of the system 11 and provides a secure end-point of a secure data pipeline between the system 11 and the analysis system 10. While the system user interface module 81 is part of the analysis system, it is loaded on and is executed on the system 11.

Via the system user interface module 81, the administrator makes selections as to how the system is to be evaluated and the desired output from the evaluation. For example, the administrator selects evaluate system, which instructs the analysis system 10 to evaluate the system from most every, if not every, combination of system aspect (e.g., system element, system criteria, and system mode), evaluation aspect (e.g., evaluation perspective, evaluation viewpoint, and evaluation category), evaluation metric (e.g., process, policy, procedure, automation, documentation, and certification), and analysis output (e.g., an evaluation rating, deficiencies identified, and auto-correction of deficiencies). As another example, the administrator selects one or more system aspects, one or more evaluation aspects, one or more evaluation metrics, and/or one or more analysis outputs.

The analysis system 10 receives the evaluation selections as part of the input 271. A control module 256 interprets the input 271 to determine what part of the system is to be evaluated (e.g., system aspects), how the system is to be evaluated (e.g., evaluation aspects), the manner in which the system is to be evaluated (e.g., evaluation metrics), and/or the resulting evaluation output (e.g., an evaluation rating, a deficiency report, and/or auto-correction). From the interpretation of the input, the control module 256 generates data gathering parameters 263, pre-processing parameters 264, data analysis parameters 265, and evaluation parameters 266.

The control module 256 provides the data gathering parameters 263 to the data input module 250. The data input module 250 interprets the data gathering parameters 263 to determine data to gather. For example, the data gathering parameters 263 are specific to the evaluation to be performed by the analysis system 10. When the data gathering parameters 263 indicate that the evaluation involves desired data (e.g., the evaluation viewpoint of the evaluation aspect is a desired evaluation viewpoint), the desired data generation module 350 of the data input module 250 is triggered to generate the desired data 352. In another example, the desired data generation module 350 generates desired data 352 for various potential data gathering parameters and stores the desired data 352 for future use. In that example, when the data gathering parameters 263 indicate that the evaluation involves desired data 352, a lookup table for the correct desired data 352 can be used. The desired data generation module 350 may update the stored desired data 352 based on a time frame (e.g., every month), a triggering event (e.g., a system change), and/or a default setting (e.g., upon launching the analysis system). In another example, a combination of the above examples is used to generate the desired data 352 (e.g., some desired data is continually generated while some is generated upon a particular evaluation request).

The data input module 250 may gather (e.g., retrieve, request, etc.) data from a variety of sources. For example, when the data gathering parameters 263 indicate that the evaluation involves desired data, the data input module 250 generates system proficiency data gathering parameters based on the evaluation and gathers system proficiency data 260 from one or more corresponding system proficiency resources 22 accordingly.

System proficiency data 260 includes information regarding best-in-class practices (for system requirements, for system design, for system implementation, and/or for system operation), governmental and/or regulatory requirements, security risk awareness and/or risk remediation information, security risk avoidance, performance optimization information, system development guidelines, software development guideline, hardware requirements, networking requirements, networking guidelines, and/or other system proficiency guidance.

The system proficiency data gathering parameters may also indicate data sources outside of the system proficiency resources 22. For example, the system proficiency data gathering parameters indicate that data from the database 275 and/or external data feeds is required. The desired data generation module 350 analyzes the gathered proficiency data 260 to generate the desired data 352. For example, the gathered proficiency data 260 includes a collection of relevant proficiency data and the desired data generation module 350 analyzes the gathered proficiency data 260 to identify desired features and/or characteristics (e.g., functions, cost, performance, reviews, experiences, evaluations, etc.) of the gathered proficiency data 260 as the desired data. Generating the desired data from the gathered proficiency data 260 will be discussed in more detail with respect to one or more of the following Figures.

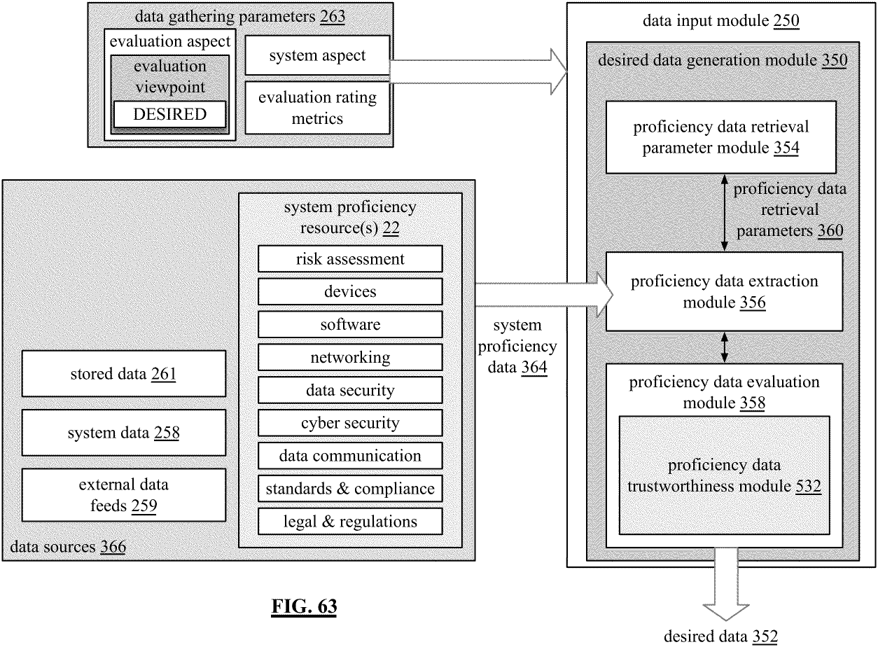

The desired data generation module 350 also evaluates the trustworthiness of the gathered proficiency data 260 to determine whether the system proficiency data retreival parameters need to be adjusted prior to generating the desired data. Evaluating the trustworthiness of the gathered proficiency data 260 will be discussed in more detail with reference to FIGS. 63-67.

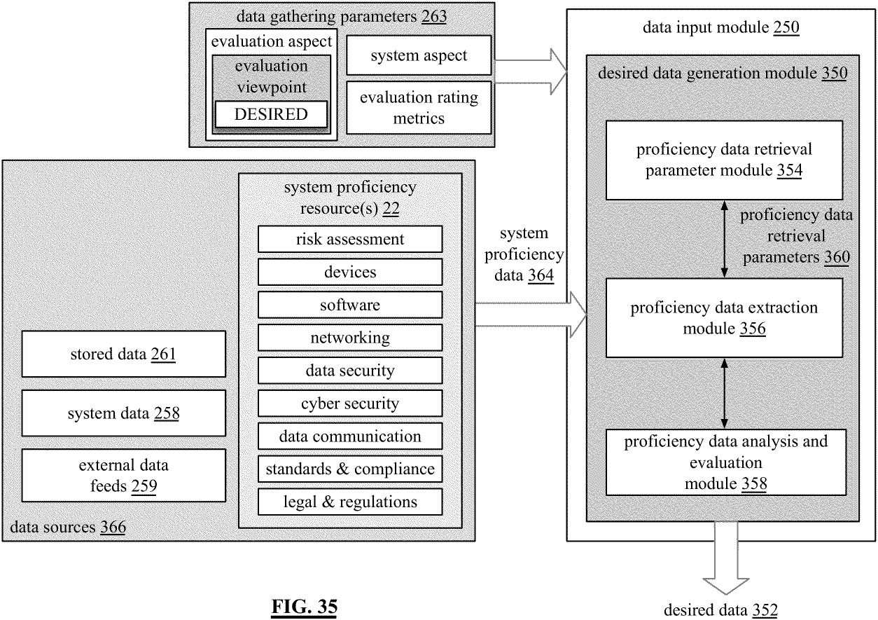

FIG. 35 is a schematic block diagram of an embodiment of a data input module 250 of an analysis system that includes a desired data generation module 350. The desired data generation module 350 includes a proficiency data retrieval parameter module 354, a proficiency data extraction module 356, and a proficiency data analysis and evaluation module 358.

The data input module 250 receives the data gathering parameters 263 as discussed with reference to FIG. 34. In this example, the data gathering parameters 263 include a system aspect, an evaluation aspect, and one or more evaluation metrics. When the evaluation aspect includes an evaluation viewpoint of desired (e.g., the desired evaluation viewpoint), the desired data generation module 350 is triggered to obtain system proficiency data 364 from one or more data sources 366 and analyze the system proficiency data 364 to generate the desired data 352 required for the evaluation. The one or more data sources 366 includes the system data 258, the stored data 261, the external data feeds 259, and the system proficiency resource(s) 22. A system proficiency resource 22 is a computing device and/or computing entity that provides information regarding best-in-class assets, best-in-class practices, known protocols, leading edge information, and/or established guidelines regarding risk assessment, devices, software, networking, data security, cybersecurity, and/or data communication. For example, a proficiency resource 22 is an industry publication.

A system proficiency resource 22 is a computing device and or computing entity that may also provide information regarding standards, information regarding compliance requirements, information regarding legal requirements, and/or information regarding regulatory requirements. For example, the system proficiency resource 22 is a government website. When triggered, the proficiency data retrieval parameter module 354 obtains the data gathering parameters 263 to generate the proficiency data retrieval parameters 360.

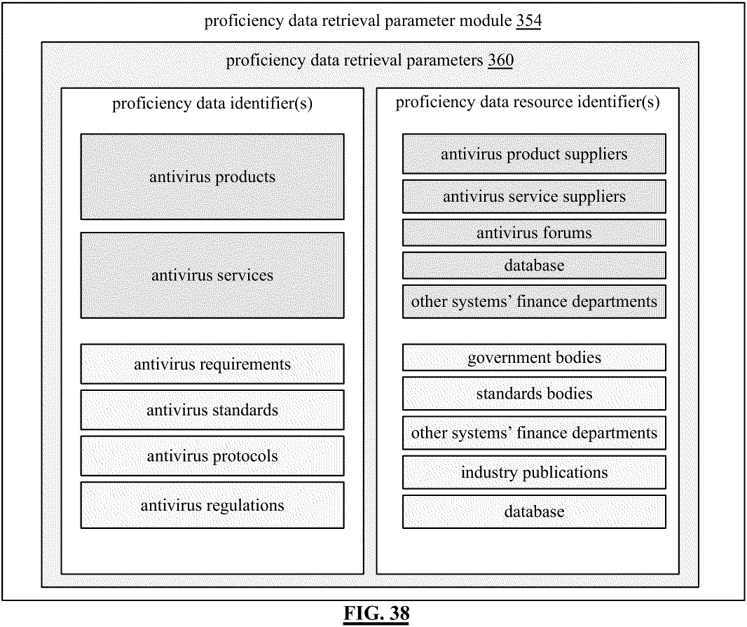

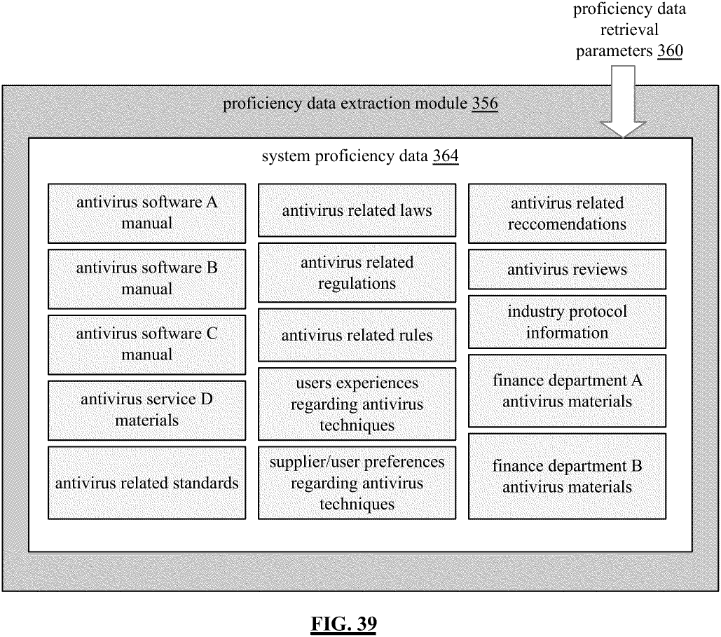

The proficiency data extraction module 356 gathers the proficiency data 364 from the system proficiency data (e.g., already obtained and/or stored system proficiency data) and/or directly from one or more of the data sources based on the proficiency data retrieval parameters 360. Gathering the proficiency data 364 based on the proficiency data retrieval parameters 360 will be discussed in further detail with reference to FIGS. 38-39.

The proficiency data evaluation module 358 analyzes the gathered proficiency data 260 to identify relevant data points (e.g., features, functions, cost, performance, reviews, experiences, evaluations, etc.) of the gathered proficiency data 260 as the desired data. The proficiency data evaluation module 358 also determines the trustworthiness of the gathered proficiency data 364. For example, the proficiency data evaluation module 358 analyzes the gathered data to determine whether the data sources and the resulting data can be trusted based on an analysis level of the data source and the data. When the gathered proficiency data 364 is considered trustworthy, the desired data 352 is generated from the proficiency data 364. The proficiency data evaluation module 358 and its functions will be discussed in further detail with reference to one or more of the following Figures.

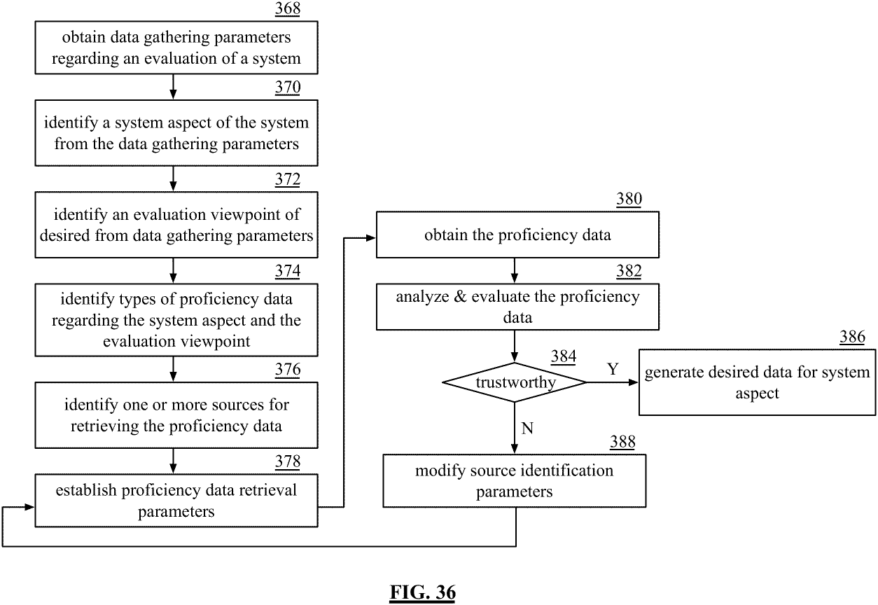

FIG. 36 is a logic diagram of an example of a method of generating desired data for an evaluation of at least a portion of a system. The method begins with step 368 where a data input module of an analysis system obtains data gathering parameters regarding an evaluation of a system. In another embodiment, the desired data generation module periodically generates desired data for various system aspects of a system. In that example, step 368 is skipped, and the method continues with step 370 which occurs on the periodic basis and based on default and/or predetermined data gathering parameters.

The method continues with step 370 where the data input module identifies a system aspect of the system from the data gathering parameters. The system aspect includes at least one system element of the system for the evaluation, at least one system criteria of the system for the evaluation, and at least one system mode of the system for the evaluation.

A system element of the at least one system element includes an enterprise identifier, an organization identifier, a division identifier, a department identifier, a group identifier, a sub-group identifier, a device identifier, a software identifier, or an internet protocol address identifier. System criteria of the at least one system criteria include system guidelines, system requirements, system design, system build, or resulting system. A system mode of the at least one system mode includes assets, system functions, or system security functions.

As an example, the data gathering parameters indicate a system aspect that includes a system mode of system security functions (specifically antivirus techniques), a system element of a finance department, and system criteria of a resulting system. As such, the data gathered should be relevant to antivirus techniques of a financial department with respect to how the resulting financial department is operating.

The method continues with step 372 where the data input module identifies an evaluation viewpoint of desired of a set of evaluation viewpoints for the system aspect from the data gathering parameters. The set of evaluation viewpoints include a disclosed viewpoint, a discovered viewpoint, and the desired viewpoint. When the data gathering parameters include the desired viewpoint, the desired data generation module of the data input module is triggered to determine, collect, and generate desired data for the evaluation. Using the example above, the data gathered should be relevant to desired, best-in-class antivirus techniques of a resulting financial department.

The method continues with step 374 where the desired data generation module identifies one or more types of proficiency data regarding the system aspect and the desired evaluation viewpoint. The one or more types of proficiency data include products, services, requirements, standards, regulations, and/or protocols related to the system aspect. For example, the products or services are information related to antivirus technique products or services such as antivirus software products. The requirements, standards, regulations, and/or protocols may be laws set by a government, rules provided by a standards body, and/or industry-based protocols (e.g., what is commonly done in a particular industry) related to antivirus techniques of a resulting financial department.

The method continues with step 376 where the desired data generation module identifies one or more sources for retrieving the proficiency data to produce source identification parameters. For example, to gather the products, services, requirements, standards, regulations, and/or protocols, the desired data generation module identifies source identifiers for sources such as product/service providers, forums, manuals, other systems, government sources, legal materials (e.g., written laws), standards body materials, industry publications, etc.

The method continues with step 378 where the desired data generation module establishes proficiency data retrieval parameters based on the one or more types of proficiency data and the source identification parameters. The proficiency data retrieval parameters instruct the desired data generation module to the relevant identified sources to gather the relevant identified information.

The method continues with step 380 where the desired data generation module obtains the proficiency data from the identified one or more sources based on the proficiency data retrieval parameters. The method continues with step 382 where the desired data generation module analyzes and evaluates the proficiency data. The desired data generation module analyzes the gathered proficiency data to identify relevant characteristics (e.g., features, functions, cost, performance, reviews, experiences, evaluations, etc.) of the gathered proficiency data as the desired data. The method continues at step 384 where the desired data generation module evaluates the gathered proficiency data to determine the trustworthiness of the gathered proficiency data. For example, the desired data generation module analyzes the gathered data to determine whether the data sources and the resulting data can be trusted based on an analysis level of the data source and the data. When the gathered proficiency data is considered trustworthy, the method continues to step 386 where the desired data is generated from the proficiency data. When the gathered proficiency data is not considered trustworthy, the method continues to step 388 where the desired data generation module modifies the source identification parameters to produce updated proficiency data retrieval parameters. The method branches back to step 378 where the desired data generation module establishes proficiency data retrieval parameters based on the updated proficiency data retrieval parameters.

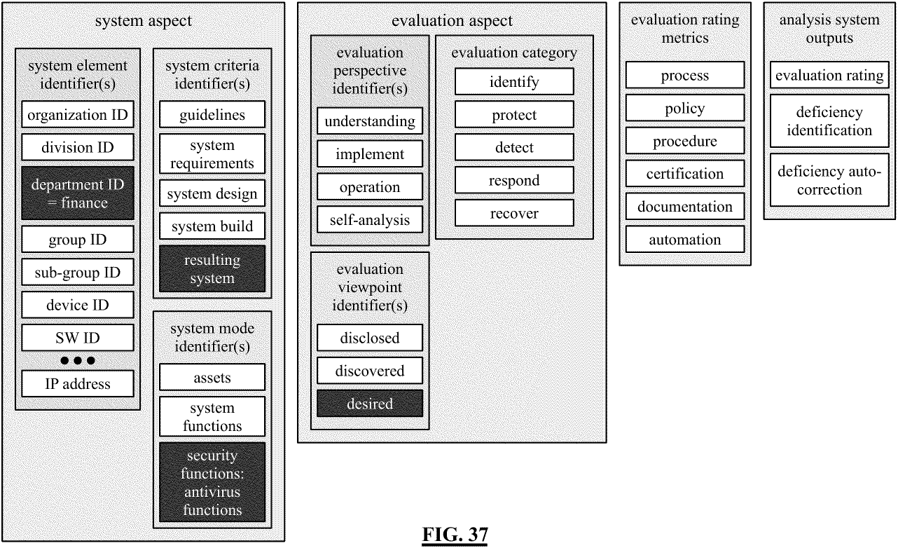

FIG. 37 is a diagram of an example of system aspect, evaluation aspect, evaluation rating metric, and analysis system output options of an analysis system for analyzing a system, or portion thereof. The diagram of FIG. 37 is similar to the diagram of FIG. 33 and depicts a specific example of data gathering parameters for an evaluation.

The system aspect corresponds to what part of the system is to be evaluated by the analysis system. The evaluation aspect indicates how the system aspect is to be evaluated. The evaluation rating metric indicates the manner of evaluation of the system aspect in accordance with the evaluation aspect. The analysis system output indicates the type of output to be produced by the analysis system based on the evaluation of the system aspect in accordance with the evaluation aspect as per the evaluation rating metric.

The system aspect includes system elements, system criteria, and system modes. A system element is one or more physical assets and/or a conceptual assets. For example, a physical asset is a computing entity, a computing device, a user software application, a system software application (e.g., operating system, etc.), a software tool, a network software application, a security software application, a system monitoring software application, and the like. As another example, a conceptual asset is a hardware architecture (e.g., identification of a system’s physical components, their capabilities, and their relationship to each other) and/or sub-architectures thereof and a software architecture (e.g., fundamental structures for the system’s software, their requirements, and inter-relational operations) and sub-architectures thereof.

A system element is identifiable in a variety of ways. For example, it can be identified by an organization identifier (ID), which would be associated with most, if not all, system elements of a system. As another example, a system element can be identified by a division ID, where the division is one of a plurality of divisions in the organization. As another example, a system element can be identified by a department ID, where the department is one of a plurality of departments in a division. As yet another example, a system element can be identified by a department ID, where the department is one of a plurality of departments in a division. As a further example, a system element can be identified by a group ID, where the department is one of a plurality of groups in a department. As a still further example, a system element can be identified by a sub-group ID, where the department is one of a plurality of subgroups in a group. With this type of identifier, a collection of system elements can be selected for evaluation by using an organization ID, a division ID, a department ID, a group ID, or a sub-group ID.

A system element may also be identified based on a user ID, a serial number, vendor data, an IP address, etc. For example, a computing device has a serial number and vendor data. As such, the computing device can be identified for evaluation by its serial number and/or the vendor data. As another example, a software application has a serial number and vendor data. As such, the software application can be identified for evaluation by its serial number and/or the vendor data.

In addition, an identifier of one system element may link to one or more other system elements. For example, computing device has a device ID, a user ID, and/or a serial number to identify it. The computing device also includes a plurality of software applications, each with its own serial number. In this example, the software identifiers are linked to the computing device identifier since the software is loaded on the computing device. This type of an identifier allows a single system element to be identified for evaluation.

In this example, the system element of the system aspect indicated in the data gathering parameters includes all the physical and conceptual assets of the finance department and is identifiable by a department identifier (ID) indicating the finance department.

The system criteria includes information regarding the development, operation, and/or maintenance of the system 11. For example, a system criterion is a guideline, a system requirement, a system design component, a system build component, the system, and system operation (e.g., the resulting system).

A guideline includes one or more of business objectives, security objectives, NIST cybersecurity guidelines, system objectives, governmental and/or regulatory requirements, third party requirements, etc. and are used to help create the system requirements. System requirements outline the hardware requirements for the system, the software requirements for the system, the networking requirements for the system, the security requirements for the system, the logical data flow for the system, the hardware architecture for the system, the software architecture for the system, the logical inputs and outputs of the system, the system input requirements, the system output requirements, the system’s storage requirements, the processing requirements for the system, system controls, system backup, data access parameters, and/or specification for other system features.

The system is built based on the design to produce a resulting system (i.e., the implemented assets). The assets of system operate to perform the system functions and/or security functions. In this example, the system criterion indicated in the data gathering parameters is the resulting system.

The system mode indicates the assets of the system, the system functions of the system, and/or the security functions of the system to be evaluated. In this example, the system mode is security functions. In particular, the system mode indicated in the data gathering parameters is the specific security function of antivirus functions and/or techniques.

The evaluation aspect, which indicates how the system aspect is to be evaluated, includes evaluation perspective, evaluation viewpoint, and evaluation category. The evaluation perspective includes understanding (e.g., how well the system is known, should be known, etc.); implementation, which includes design and/or build, (e.g., how well is the system designed, how well should it be designed); system performance, and/or system operation (e.g., how well does the system perform and/or operate, how well should it perform and/or operate); and self-analysis (e.g., how self-aware is the system, how self-healing is the system, how self-updating is the system). In this example, the evaluation perspective is not indicated in the data gathering parameters.

The evaluation viewpoint includes disclosed data, discovered data, and desired data. Disclosed data is the known data of the system at the outset of an analysis, which is typically supplied by a system administrator and/or is obtained from data files of the system. In this example, the evaluation viewpoint indicated in the data gathering parameters is desired data. Continuing the examples above, the desired data is the data obtained by the analysis system from data sources regarding a resulting financial department’s antivirus techniques. Differences in disclosed, discovered, and desired data are evaluated to support generating an evaluation rating, to identify deficiencies, and/or to determine and provide auto-corrections.

The evaluation category includes an identify category, a protect category, a detect category, a respond category, and a recover category. In general, the identify category is regarding identifying assets, system functions, and/or security functions of the system; the protect category is regarding protecting assets, system functions, and/or security functions of the system from issues that may adversely affect; the detect category is regarding detecting issues that may, or have, adversely affect assets, system functions, and/or security functions of the system; the respond category is regarding responding to issues that may, or have, adversely affect assets, system functions, and/or security functions of the system; and the recover category is regarding recovering from issues that have adversely affect assets, system functions, and/or security functions of the system. Each category includes one or more sub-categories and each sub-category may include one or more sub-sub categories. In this example, the evaluation categories are not indicated in the data gathering parameters.

The evaluation rating metric includes process, policy, procedure, certification, documentation, and automation. The evaluation rating metric may include more or less topics. The analysis system output options include evaluation rating, deficiency identification, and deficiency auto-correction. In this example, the evaluation rating metrics and the analysis output are not indicated in the data gathering parameters. While for simplicity, only the system aspect, and evaluation viewpoint are indicated in the data gathering parameters, any combination of the identifiers, categories, metrics, and outputs shown could be indicated in the data gathering parameters for a particular evaluation.

FIG. 38 is a diagram of an example of generating proficiency data retrieval parameters 360. As discussed with reference to FIGS. 34-36, a data input module of an analysis system receives data gathering parameters regarding an evaluation. When the data gathering parameters indicate that desired data is needed for the evaluation, a proficiency data retrieval parameter module 354 of a desired data generation module of the data input module generates the proficiency data retrieval parameters 360 based on the data gathering parameters.

Based on the system aspect identified in the data gathering parameters, the proficiency data retrieval parameter module 354 identifies a list of relevant proficiency data regarding the system aspect and determines source identifiers for the sources that would likely have the data.

Using the example of FIG. 37 where the system aspect includes a system element of a financial department, a system mode of antivirus security functions/techniques, and a system criterion of a resulting system, the proficiency data retrieval parameter module 354 identifies a list of relevant proficiency data (proficiency data identifiers) such as antivirus products, antivirus services, antivirus requirements, antivirus standards, antivirus regulations, and antivirus protocols. Based on the identified types of proficiency data, the proficiency data retrieval parameter module 354 generates a list of proficiency data resource identifiers to gather the data from. For example, based on the proficiency data identifiers of antivirus services and products, the list of proficiency data resource identifiers includes antivirus product suppliers, antivirus service suppliers, antivirus related forums, the analysis system database (e.g., for stored tests and experiences), and other systems’ finance departments. Based on the proficiency data identifiers of antivirus requirements, antivirus standards, antivirus regulations, and antivirus protocols, the list of proficiency data resource identifiers includes government bodies (e.g., to find applicable statutes, rules, etc.), standards bodies, other systems’ finance departments, industry publications, and the analysis system database (e.g., for stored materials).

FIG. 39 is a diagram of an example of extracting system proficiency data 356. Continuing the example of FIG. 38, after the proficiency data retrieval parameters 360 are generated by the proficiency data retrieval parameter module 354, the proficiency data extraction module 356 uses the proficiency data retrieval parameters 360 to gather system proficiency data 364 from identified data sources. FIG. 39 depicts example proficiency data 364 extracted from the identified data sources.

For example, from the identified antivirus product and service supplier sources (e.g., supplier websites, supplier resources, stored data, etc.) the proficiency data extraction module 356 extracts antivirus software A-D manuals. From the antivirus related forums, the proficiency data extraction module 356 extracts antivirus related reviews, recommendations, and supplier/user preferences regarding antivirus techniques.

From the government bodies and standards bodies (e.g., government websites, etc.), the proficiency data extraction module 356 extracts antivirus related laws, regulations, rules, recommendations, and standards.

From the analysis system database resources, the proficiency data extraction module 356 extracts stored user experiences regarding antivirus techniques and stored industry regulations and standards. From the other systems’ finance departments, the proficiency data extraction module 356 extracts finance department A and B’s antivirus materials and/or information. From the industry publications, the proficiency data extraction module 356 extracts industry protocol information regarding antivirus techniques.

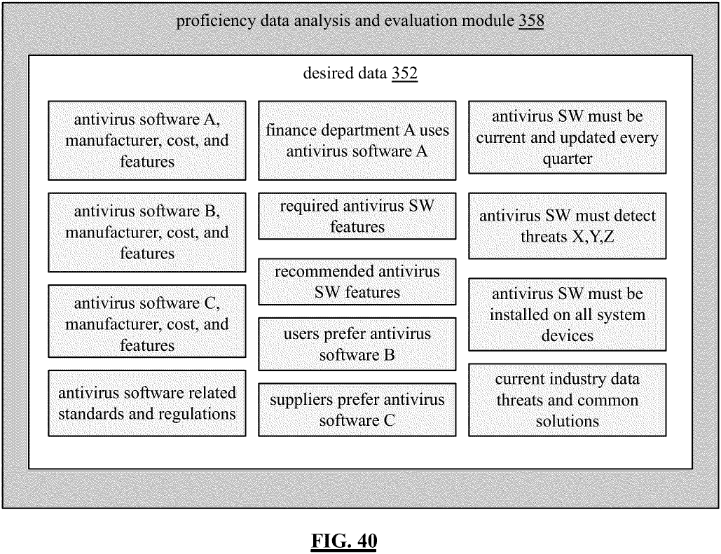

FIG. 40 is a diagram of an example of generating desired data 352 for an evaluation. Continuing the example of FIGS. 38-39, after the proficiency data extraction module 356 uses the proficiency data retrieval parameters 360 to gather system proficiency data 364 from identified data sources, the proficiency data analysis and evaluation module 358 generates desired data 352 based on the gathered system proficiency data 364. FIG. 40 depicts example desired data 352 generated from the gathered system proficiency data 364.

For example, from the antivirus software A-D manuals, the proficiency data analysis and evaluation module 358 extracts relevant characteristics of the proficiency data such as manufacturer information, cost, and features regarding antivirus software A-D as desired data. From the antivirus related reviews, recommendations, and supplier/user preferences regarding antivirus techniques, the proficiency data analysis and evaluation module 358 extracts relevant characteristics of the proficiency data such as the datapoints that users prefer antivirus software B and suppliers prefer antivirus C as desired data.

From the antivirus related laws, regulations, rules, recommendations, and standards, the proficiency data analysis and evaluation module 358 extracts relevant characteristics of the proficiency data such as required antivirus software features, recommended antivirus software features, antivirus software related standards and regulations, that antivirus software must be current and updated every quarter, that antivirus software must detect threats X, Y, and Z, and that antivirus software must be installed on all system devices as desired data.

From the stored user experiences regarding antivirus techniques and stored industry regulations and standards, the proficiency data analysis and evaluation module 358 extracts relevant characteristics of the proficiency data such as further information to enforce the above (e.g., the software regulations, the user preferences, etc.) as desired data. From the finance department A and B’s antivirus materials and/or information, the proficiency data analysis and evaluation module 358 extracts relevant characteristics of the proficiency data such as the fact that finance department A uses antivirus software A as desired data. From the industry protocol information regarding antivirus techniques, the proficiency data analysis and evaluation module 358 extracts relevant characteristics of the proficiency data such as current and/or future industry data threats and common and/or potential solutions as desired data.

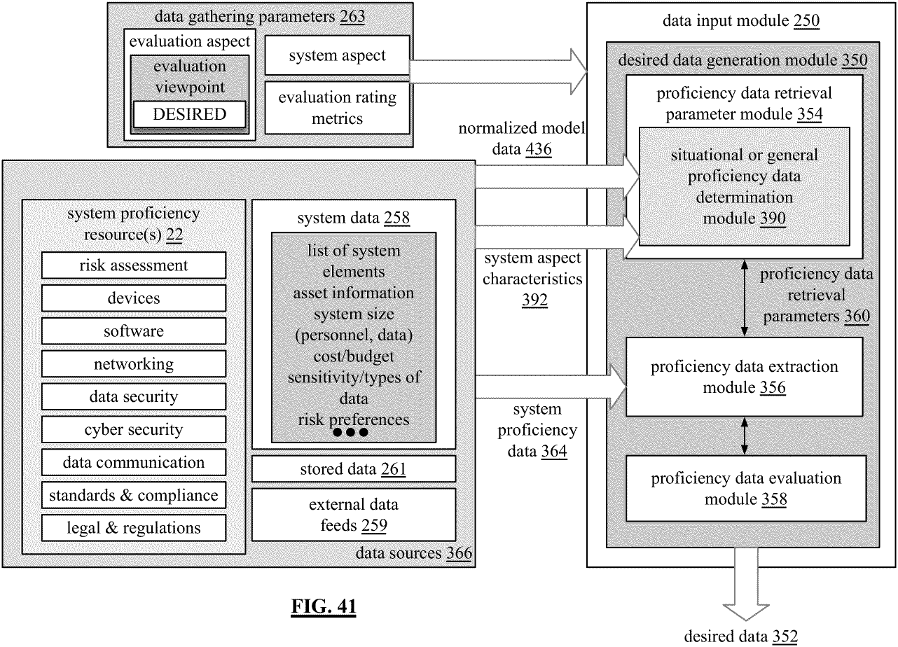

FIG. 41 is a schematic block diagram of an embodiment of a data input module 250 of an analysis system that includes a desired data generation module 350. The desired data generation module 350 includes a proficiency data retrieval parameter module 354, a proficiency data extraction module 356, and a proficiency data evaluation module 358. The data input module 250 of FIG. 41 operates similarly to the data input module 250 of FIG. 34 except that the proficiency data retrieval parameter module 354 is shown to include a situational or general proficiency data determination module 390 and the system data 258 includes more detail.

The data input module 250 receives the data gathering parameters 263 as discussed with reference to FIG. 34. In this example, the data gathering parameters 263 include a system aspect, an evaluation aspect, and one or more evaluation metrics. When the evaluation aspect includes an evaluation viewpoint of desired (e.g., the desired evaluation viewpoint), the desired data generation module 350 is triggered to obtain information from one or more data sources 366 to produce system proficiency data 364. The situational or general proficiency data determination module 390 determines whether the system proficiency data 364 should be situational or general.

General system proficiency data is data that applies to other system aspects similar to the system aspect being evaluated. Situational system proficiency data is data that is more specific to the system aspect that is being evaluated. For example, if the system aspect that is being evaluated is unlike other system aspects (e.g., in size, goals, resources, budget, etc.), situational system proficiency data is needed.

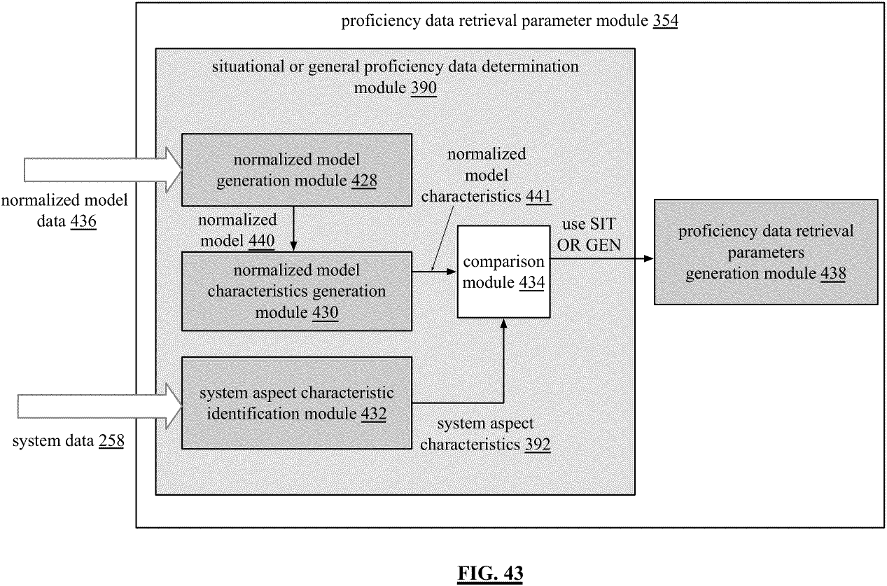

In order to determine whether the system proficiency data 364 should be situational or general, the situational or general proficiency data determination module 390 compares system characteristics 392 of the system aspect (e.g., a list of system elements, asset information, system size (based on personnel, based on data, etc.), cost/budget, sensitivity/types of data, risk preferences, etc.) with a normalized model for the system aspect. For example, the situational or general proficiency data determination module 390 obtains normalized model data 434 from one or more data sources (e.g., stored data, other systems, etc.) to generate the normalized model. When the system characteristics 392 are within a threshold of characteristics of the normalized model, general proficiency data can be used. When the system characteristics 392 are not within a threshold of characteristics of the normalized model, situational proficiency data needs to be used. Generating the normalized model and comparing the system characteristics 392 with the normalized model will be discussed in greater detail with reference to FIGS. 43-52.

The proficiency data extraction module 356 gathers the proficiency data 364 (e.g., either the situational or general proficiency data) from the system proficiency data (e.g., already obtained and/or stored system proficiency data) and/or directly from one or more of the data sources based on the proficiency data retrieval parameters 360. The proficiency data evaluation module 358 analyzes the gathered proficiency data 260 to identify relevant characteristics (e.g., features, functions, cost, performance, reviews, experiences, evaluations, etc.) of the gathered proficiency data 260 as the desired data.

The proficiency data evaluation module 358 also determines the trustworthiness of the gathered proficiency data 364. For example, the proficiency data evaluation module 358 analyzes the gathered data to determine whether the data sources and the resulting data can be trusted based on an analysis level of the data source and the data. When the gathered proficiency data 364 is considered trustworthy, the desired data 352 is generated from the proficiency data 364. Determining the trustworthiness of the gathered proficiency data 364 will be discussed in further detail with reference to FIGS. 63-67.

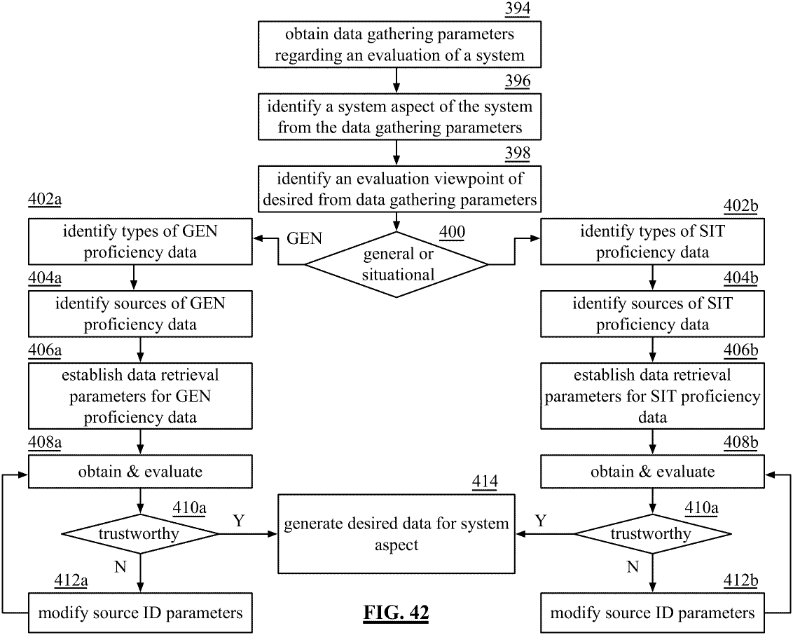

FIG. 42 is a logic diagram of an example of a method of generating desired data for an evaluation of a system aspect. The method of FIG. 42 is similar to the method of FIG. 36 except that either situational or general proficiency data is gathered to generate the desired data. The method begins with step 394 where a data input module of an analysis system obtains data gathering parameters regarding an evaluation of a system. The method continues with step 396 where the data input module identifies a system aspect of the system from the data gathering parameters. The system aspect includes at least one system element of the system for the evaluation, at least one system criteria of the system for the evaluation, and at least one system mode of the system for the evaluation.

As an example, the data gathering parameters indicate a system aspect that includes the system mode of system security (specifically antivirus techniques), a system element of a finance department, and system criteria of a resulting system. As such, the data gathered should be relevant to antivirus techniques of a resulting financial department.

The method continues with step 398 where the data input module identifies an evaluation viewpoint of desired of a set of evaluation viewpoints for the system aspect from the data gathering parameters. The set of evaluation viewpoints include a disclosed viewpoint, a discovered viewpoint, and the desired viewpoint. When the data gathering parameters include the desired viewpoint, the desired data generation module of the data input module is triggered to determine, collect, and generate desired data for the evaluation. Using the example above, the data gathered should be relevant to desired, best-in-class antivirus techniques of a resulting financial department.

The method continues with step 400 where the desired data generation module determines whether to gather situational (SIT) system proficiency data or general (GEN) system proficiency data. General system proficiency data is data that applies to most other system aspects similar to the system aspect being evaluated. Situational system proficiency data is data that is more specific to the system aspect that is being evaluated. For example, if the system aspect that is being evaluated is unlike most other system aspects (e.g., in size, goals, etc.), situational system proficiency data may need to be gathered.

In order to determine whether the system proficiency data should be situational or general, the desired data generation module compares system characteristics of the system aspect (e.g., a list of system elements, asset information, system size (based on personnel, based on data, etc.), cost/budget, sensitivity/types of data, risk preferences, etc.) with a normalized model for the system aspect. When the system characteristics are within a threshold, the method continues with step 402a where general proficiency data can be used and when the system characteristics are no within a threshold, the method continues with step 402b where situational proficiency data is used. Generating the normalized model and comparing the system characteristics with the normalized model will be discussed in greater detail with reference to FIGS. 43-52.

At step 402a the desired data generation module identifies one or more types of general proficiency data regarding the system aspect and the desired evaluation viewpoint. At step 402b, the desired data generation module identifies one or more types of situational proficiency data regarding the system aspect and the desired evaluation viewpoint. The one or more types of proficiency data include products, services, requirements, standards, regulations, and/or protocols related to the system aspect. The requirements, standards, regulations, and/or protocols may be laws set by a government, rules provided by a standards body, and/or industry-based protocols (e.g., what is commonly done in a particular industry).

The method continues with steps 404a or 404b. At step 404a, the desired data generation module identifies one or more sources for retrieving the general proficiency data to produce source identification parameters. At step 404b, the desired data generation module identifies one or more sources for retrieving the situational proficiency data to produce source identification parameters. For example, to gather the products, services, requirements, standards, regulations, and/or protocols, the desired data generation module identifies source identifiers for sources such as product/service providers, forums, manuals, other systems, legal materials (e.g., written laws), standards body materials, industry publications, etc.

The method continues with steps 406a or 406b. At step 406a, the desired data generation module establishes proficiency data retrieval parameters for the general proficiency data based on the one or more types of proficiency data and the source identification parameters. At step 406b, the desired data generation module establishes proficiency data retrieval parameters for the situational proficiency data based on the one or more types of proficiency data and the source identification parameters. The proficiency data retrieval parameters for the situational proficiency data may be based on general proficiency data retrieval parameters but adjusted by a standard deviation based on the system’s comparison to the normalized model. The proficiency data retrieval parameters instruct the desired data generation module to the relevant identified sources to gather the relevant identified information.

The method continues with steps 408a or 408b. At step 408a, the desired data generation module obtains, analyzes, and evaluates the general proficiency data from the identified one or more sources based on the proficiency data retrieval parameters. At step 408b, the desired data generation module obtains, analyzes, and evaluates the situational proficiency data from the identified one or more sources based on the proficiency data retrieval parameters. The desired data generation module analyzes the gathered proficiency data to identify relevant characteristics (e.g., features, functions, cost, performance, reviews, experiences, evaluations, etc.) of the gathered proficiency data as the desired data.

The method continues at step 410a or 410b. At step 410a, the desired data generation module evaluates the gathered general proficiency data to determine the trustworthiness of the gathered general proficiency data. At step 410b, the desired data generation module evaluates the gathered situational proficiency data to determine the trustworthiness of the gathered situational proficiency data. For example, the desired data generation module analyzes the gathered data to determine whether the data sources and the resulting data can be trusted based on an analysis level of the data source and the data.

When the gathered proficiency data is considered trustworthy, the method continues to step 414 where the desired data is generated from the proficiency data. When the gathered proficiency data is not considered trustworthy, the method continues with steps 412a or 412b. At step 412a, the desired data generation module modifies identification parameters for the sources of general proficiency data to produce updated general proficiency data retrieval parameters. The method branches back to step 408a where the desired data generation module obtains, analyzes, and evaluates the general proficiency data from the identified one or more sources based on the updated general proficiency data retrieval parameters.

At step 412b, the desired data generation module modifies identification parameters identification parameters for the sources of situational proficiency data to produce updated situational proficiency data retrieval parameters. The method branches back to step 408b where the desired data generation module obtains, analyzes, and evaluates the situational proficiency data from the identified one or more sources based on the updated situational proficiency data retrieval parameters.

FIG. 43 is a schematic diagram of an embodiment of a proficiency data retrieval parameter module 354 that includes a situational or general proficiency data determination module 362 and a proficiency data retrieval parameters generation module 438. The situational or general proficiency data determination module 362 includes a normalized model generation module 428, a normalized model characteristics generation module 430, a system aspect characteristic identification module 432, and a comparison module 434.

After the data input module identifies the system aspect and the evaluation viewpoint of desired for the evaluation, the situational or general proficiency data determination module 362 of the proficiency data retrieval parameter module 354 of a desired data generation module of the data input module determines whether to gather situational (SIT) system proficiency data or general (GEN) system proficiency data. The normalized model generation module 428 obtains (e.g., requests, receives, accesses, etc.) normalized model data 436 to generate a normalized model for the system aspect.

The normalized model data 436 includes data pertaining to a set of other systems having a similar system aspect to the system aspect under evaluation. For example, the system aspect under evaluation is a resulting financial department’s antivirus techniques. The normalized model data 436 for that example includes antivirus technique information from at least two other systems’ financial departments. The normalized model data 436 can be obtained from the analysis system database, from the other systems, and/or based on previously generated normalized models and/or modeled systems. The normalized model data 436 may include the size of the at least two other systems’ financial departments, the annual or quarterly budget for antivirus techniques for the at least two other systems’ financial departments, the types of antivirus techniques of the at least two other systems’ financial departments, the types of data handled by the at least two other systems’ financial departments, the risk tolerances accepted by the at least two other systems’ financial departments, etc.

The normalized model generation module 428 normalizes the normalized model data 436 to generate a normalized model 440. Normalizing (or standardizing) data makes data across multiple data sets comparable. Normalization techniques include min-max normalization, mean normalization, z-score normalization, scaling to unit length, decimal scaling, feature clipping, and log scaling. In min-max normalization, the normalized model generation module 428 calculates the range of data sets of the normalized model data 436, subtracts the range from a selected data point to generate a new data point, and divides the new data point by the range. This formula is repeated for each data point in a data set. The range can be customized to a lowest and highest value.

In mean normalization, the average of a data set is subtracted by a data point and divided by the difference in the maximum and minimum data points. Z-score normalization is a statistical method for establishing whether a particular piece of data is representative of the data set from which it derives. Z-score normalization can calculate how far a data point is from the average of the whole data set and is appropriate to use when comparing data sets that are likely to be similar. To calculate the z-score, the distribution mean and the standard deviation of a dataset is calculated for each data set, the mean is subtracted from each data set to generate a new data point, and each new data point is divided by its standard deviation.

Scaling to unit length include scaling the components of a data set such that the complete vector has a length of one. Decimal scaling normalizes by moving the decimal point of values of the data where each value of data is divided by the maximum absolute value of the data. Feature clipping is the process of removing data points beyond a certain minimum or maximum to remove extreme outliers in a group. Log scaling is a method that uses logarithms to compress a wide range into a smaller range.

The normalized model generation module 428 provides the normalized model 440 to the normalized model characteristics generation module 430 to extract normalized model characteristics 441 from the normalized model 440. For example, the normalized model characteristics generation module 430 analyzes, processes, and/or simplifies the normalized model 440 to identify characteristics of interest (e.g., system size, data type and/or sensitivity, risk preferences, etc.). To accomplish this, the normalized model characteristics generation module 430 includes analytic tools for searching, querying, describing, summarizing, and classifying datasets.

Meanwhile, subsequently, or previously, the system aspect characteristic identification module 432 obtains system data 258 pertaining to the system aspect via the database or by request and extracts system aspects characteristics 392 for the system aspect. For example, the system aspect characteristic identification module 432 extracts datasets of interest from the system data 258 such as a list of system elements, asset information, system size (based on personnel, based on data, etc.), cost/budget, sensitivity/types of data, and risk preferences.

The comparison module 434 compares the system aspect characteristics and the normalized characteristics to determine whether the system aspect characteristics are within a threshold of the normalized characteristics. For example, the threshold may be a certain deviation from the normalized characteristics where some characteristics are weighted heavier than others (e.g., risk tolerance may be weighted more if the system aspect relates to security). Individual deviations may be considered from characteristic to characteristic and/or an overall deviation may be determined for the entire comparison.

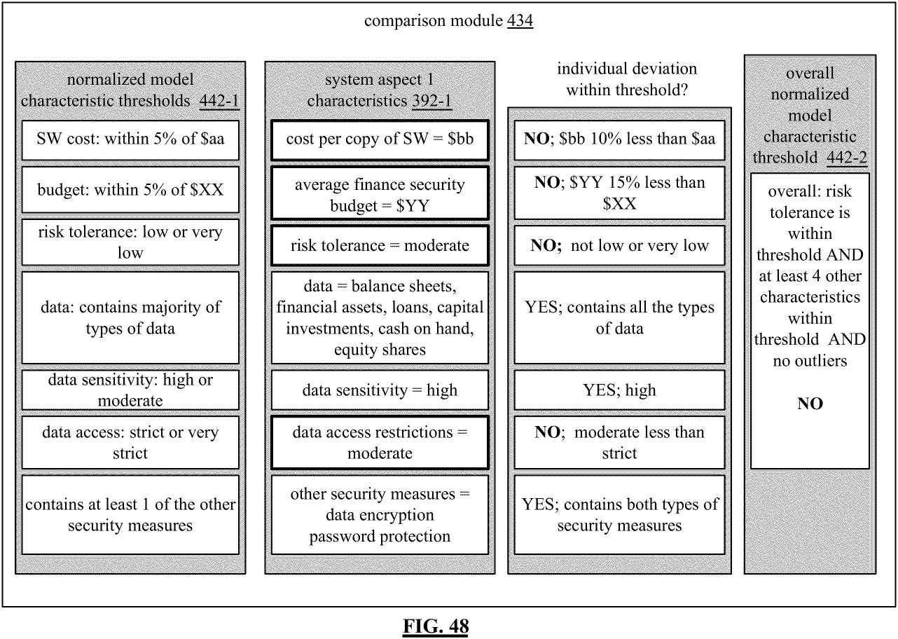

When the system aspect characteristics are within a threshold of the normalized characteristics, the comparison module 434 provides an indication to the proficiency data retrieval parameters generation module 438 to gather general proficiency data for the evaluation of the system aspect. When the system aspect characteristics are not within a threshold of the normalized characteristics, the comparison module 434 provides an indication to the proficiency data retrieval parameters generation module 438 to gather situational proficiency data for the evaluation of the system aspect. The comparison module 434 and its functions will be discussed in greater detail with reference to FIGS. 48, 50, and 52.

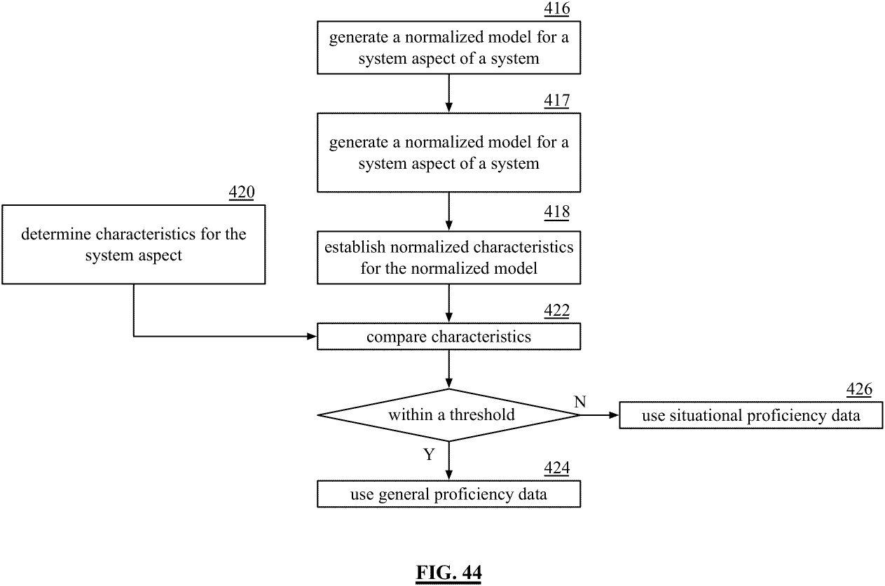

FIG. 44 is a logic diagram of an example of a method of determining whether to gather general proficiency data or situational proficiency data for an evaluation of a system aspect. General system proficiency data is data that applies to most other system aspects similar to the system aspect being evaluated. Situational system proficiency data is data that is more specific to the system aspect that is being evaluated. For example, if the system aspect that is being evaluated is unlike most other system aspects (e.g., in size, goals, etc.), situational system proficiency data may need to be gathered.

The method begins with step 416 where a desired data generation module of a data input module of an analysis system obtains normalized model data for a system aspect of a system under a desired data evaluation. The normalized model data includes data pertaining to a set of other systems having a similar system aspect to the system aspect under evaluation. For example, the system aspect under evaluation is a resulting financial department antivirus techniques. The normalized model data for that example includes antivirus technique information from at least two other systems’ financial departments.

The method continues with step 417 where the desired data generation module generates a normalized model for the system aspect. For example, the desired data generation module normalizes the normalized model data to generate the normalized model. Normalizing (or standardizing) data makes data across multiple data sets comparable. Normalization techniques include min-max normalization, mean normalization, z-score normalization, scaling to unit length, decimal scaling, feature clipping, and log scaling.

The method continues with step 418 where the desired data generation module establishes normalized characteristics for the normalized model. For example, from the normalized model, the desired data generation module extracts data points such as a normalized list of system elements for similar system aspects, normalized asset information for similar system aspects, normalized system size (based on personnel, based on data, etc.) for similar system aspects, normalized cost/budget for similar system aspects, normalized sensitivity/types of data for similar system aspects, and normalized risk preferences for similar system aspects.

The method continues (or occurs concurrently with the steps above) with step 420 where the desired data generation module determines characteristics for the system aspect. For example, the desired data generation module obtains system data pertaining to the system aspect via the database or by request. For example, the desired data generation module extracts data points such as a list of system elements, asset information, system size (based on personnel, based on data, etc.), cost/budget, sensitivity/types of data, and risk preferences.

The method continues with step 422 where the desired data generation module compares the characteristics of the system aspect with the normalized characteristics of the normalized model to determine whether the characteristics of the system aspect are within a threshold of the normalized characteristics. For example, the threshold may be a certain deviation from the normalized characteristics where some characteristics are weighted heavier than others (e.g., risk tolerance may be weighted more if the system aspect relates to security). Individual deviations may be considered from characteristic to characteristic and/or an overall deviation may be determined for the entire comparison.

When the characteristics of the system aspect are within a threshold of the normalized characteristics, the method continues with step 424 where the desired data generation module determines to gather general proficiency data for an evaluation of the system aspect. When the characteristics of the system aspect are not within the threshold of the normalized characteristics for the normalized model, the method continues with step 426 where the desired data generation module determines to gather situational proficiency data for the evaluation of the system aspect.

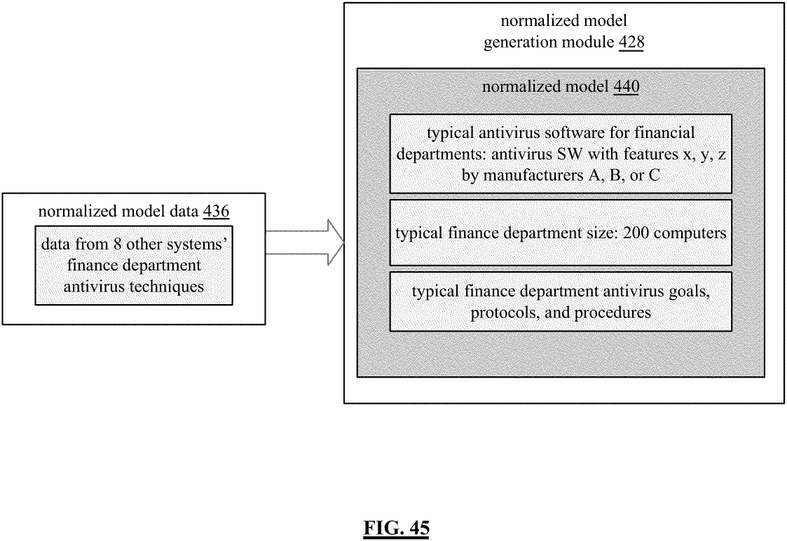

FIG. 45 is a schematic block diagram of an embodiment of a normalized model generation module 428 generating a normalized model 440 for a system aspect. In this example, the system aspect is antivirus techniques of a resulting financial department. The normalized model generation module 428 obtains (e.g., requests, receives, accesses, etc.) normalized model data 436 to generate a normalized model for the system aspect.

The normalized model data 436 includes data pertaining to a set of other systems having a similar system aspect to the system aspect under evaluation. The normalized model data 436 includes antivirus technique information from 8 other systems’ resulting financial departments. The normalized model data 436 can be obtained from the analysis system database, from the other systems, and/or based on previously generated normalized models and/or modeled systems. The normalized model data 436 may include the size of the 8 other systems’ financial departments, the annual or quarterly budgets for antivirus techniques for the at least two other systems’ financial departments, the types of antivirus techniques of the at least two other systems’ financial departments, the types of data handled by the at least two other systems’ financial departments, the risk tolerances accepted by the at least two other systems’ financial departments, etc.

The normalized model generation module 428 normalizes the normalized model data 436 to generate a normalized model 440. Normalizing (or standardizing) data makes data across multiple data sets comparable. In this example, the normalized model 440 of the system aspect includes antivirus software with features x, y, and z, by manufacturers A, B, or C, a finance department size of 200 computers, and normalized finance department antivirus goals, protocols, and procedures.

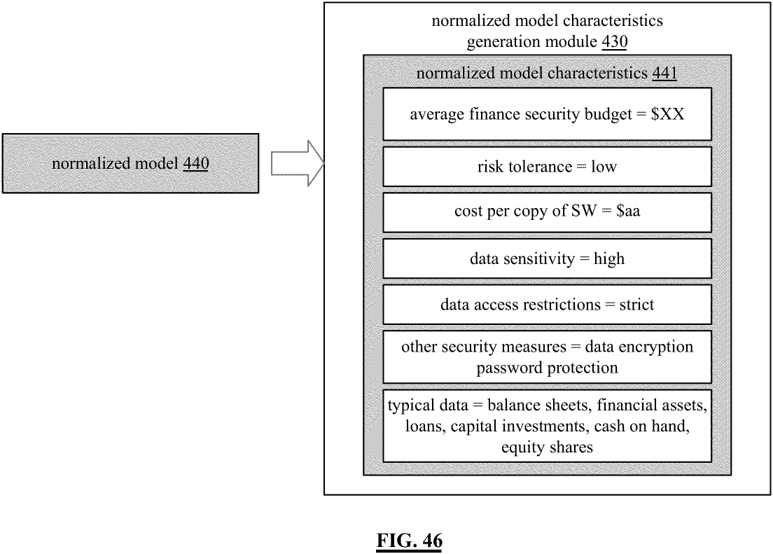

FIG. 46 is a schematic block diagram of an embodiment of a normalized model characteristics generation module 430 generating normalized model characteristics 441 from the normalized model 440 of FIG. 45. The normalized model generation module 428 provides the normalized model 440 to the normalized model characteristics generation module 430 to extract normalized model characteristics 441 from the normalized model 440. For example, the normalized model characteristics generation module 430 analyzes, processes, and/or simplifies the normalized model 440 to identify characteristics of interest (e.g., system size, data type and/or sensitivity, risk preferences, etc.). To accomplish this, the normalized model characteristics generation module 430 includes analytic tools for searching, querying, describing, summarizing, and classifying datasets.

In this example, the normalized model characteristics 441 include an average finance security budget of $XX, a risk tolerance of low, a cost per copy of antivirus software of $aa, a data sensitivity level of high, a data access restrictions level of strict, other security measures such as data encryption and password protection, and typical data of balance sheets, financial assets, loans, capital investments, cash on hand, and equity shares.

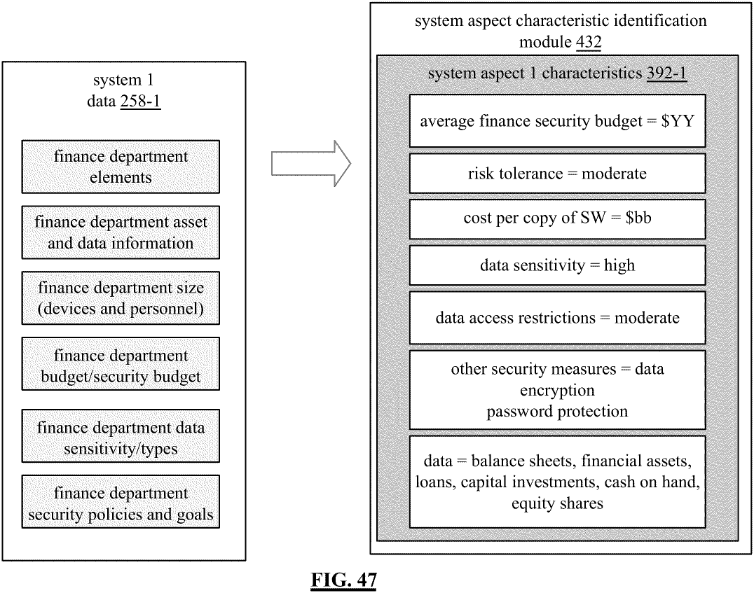

FIG. 47 is a schematic block diagram of an embodiment of a system aspect characteristic identification module 432 generating system aspect characteristics 392-1 for a system aspect 1 of a system 1. The system aspect 1 is antivirus techniques of a resulting financial department of system 1.

The system aspect characteristic identification module 432 obtains system 1 data 258-1 pertaining to the system aspect 1 via the database or by request and extracts system aspect 1 characteristics 392-1 for the system aspect 1. For example, the system aspect characteristic identification module 432 obtains the system data 258-1 such as a list of system elements, asset and data information, system size (based on personnel, based on data, etc.), cost/budget (e.g., for security, overall, etc.), sensitivity/types of data, and security policies and/or security goals.

From the system 1 data, the system aspect characteristic identification module 432 extracts system aspect 1 characteristics 392-1 for the system aspect. For example, the system aspect characteristic identification module 432 extracts system aspect 1 characteristics 392-1 based on default datapoints of interest, based on one or more inputs, and/or based on the normalized model characteristics. In this example, the system aspect 1 characteristics 392-1 include an average finance security budget of $YY, a risk tolerance of moderate, a cost per copy of antivirus software of $bb, a data sensitivity level of high, a data access restrictions level of moderate, other security measures such as data encryption and password protection, and typical data of balance sheets, financial assets, loans, capital investments, cash on hand, and equity shares.

FIG. 48 is a schematic block diagram of an embodiment of a comparison module 434 of a situational or general proficiency data determination module comparing the normalized model characteristics 441 with the system aspect 1 characteristics 392-1 of FIGS. 46-47. The comparison module 434 compares the system aspect 1 characteristics 392-1 and the normalized model characteristics 441 to determine whether the system aspect 1 characteristics 392-1 are within normalized model characteristic thresholds 442-1 and 442-2 (i.e., “thresholds”).

The comparison module 434 generates the normalized model characteristic thresholds 442 based on the type of systems involved, the type of data involved, the type of characteristics involved, and/or the specific system aspect involved. As another example, the comparison module 434 uses a lookup table to establish the normalized model characteristic thresholds 442-1 and 442-2. As another example, another module generates the normalized model characteristic thresholds 442 and provides the normalized model characteristic thresholds 442-1 and 442-2 to the comparison module 434. As another example, the normalized model characteristic thresholds 442 are provided to the comparison module 434 via one or more user data inputs. The normalized model characteristic thresholds 442-1 and 442-2 include a set of individual thresholds pertaining to each of the normalized model characteristics 441 (e.g., normalized model characteristic thresholds 442-1) as well as an overall threshold pertaining to the normalized model characteristics 441 (e.g., overall normalized model characteristic threshold 442-2).

Normalized model characteristic thresholds may vary in range and format from one another (e.g., a percentage deviation, an exact match, a percentage of data items of a set, etc.). For example, the normalized model characteristic thresholds 442-1 include a threshold of within 5% for the cost per copy of antivirus software (SW) and within 5% for the average finance security budget. In contrast, to be considered within the threshold of the normalized model risk tolerance, the system aspect risk tolerance must be “low” or “very low.” A tolerance threshold of “very low” to “very high” is based on certain features. For example, a large amount of money spent on security may indicate a low risk tolerance. As another example, a well-developed risk management program may indicate a low risk tolerance. As another example, the presence of risk prevention procedures (e.g., upgrading and replacing software, implementing whitelists, etc.) and particular security devices (e.g., software inventory management tools, etc.) may indicate a low risk tolerance.

The comparison module 434 compares each system aspect 1 characteristic 392-1 with each of the normalized model characteristic thresholds 442-1 to determine whether a deviation from each normalized model characteristic is within its specified threshold. In this example, the cost per copy of antivirus software of system aspect 1 is not within the threshold of within 5% because $bb is 10% less $aa, the average finance security budget is not within the threshold of within 5% because $YY is 15% less than $XX, the risk tolerance is not within the threshold of low or very low because moderate is greater than low or very low, the data types are within the threshold because the system aspect 1 has at least a majority of similar data types as the normalized model characteristics, the data sensitivity level is within the threshold of high or moderate because it is high, the data access restrictions level is not within the threshold of strict or very strict because moderate is less than strict, and the other security measures are within the threshold of “at least 1 of the other security measures” because the system aspect 1 contains all of other security measures indicated.

The comparison module 434 assesses the individual deviations to determine whether the system aspect 1 characteristics are within an overall threshold compared to the normalized model characteristics. In making this assessment, some characteristics may be weighted more heavily than others. For example, the overall normalized model characteristic threshold 442-2 requires the risk tolerance be within the threshold, that at least 4 other characteristics be within their thresholds, and that there are no outliers (i.e., system aspect characteristics that are extremely far outside of the thresholds) for the system aspect characteristics to be considered within the overall threshold of the normalized model characteristics. Many other examples of individual and overall threshold determinations are possible.

In this example, the comparison module 434 determines that the system aspect 1 characteristics are not within the overall threshold of the normalized model characteristics because the system aspect 1 risk tolerance is not within the individual threshold. Additionally, there are only 3 other characteristics within their thresholds.

Because the characteristics are not within the overall threshold of the normalized model characteristics, the comparison module 434 provides an indication to the proficiency data retrieval parameters generation module 438 to gather situational proficiency data for the evaluation of the system aspect 1. The situational proficiency data includes data that is more tailored to system aspect 1 where the system 1 budget is more important than performance. For example, the comparison module 434 shares the individual deviation information with the proficiency data retrieval parameters generation module 438 such that the proficiency data retrieval parameters generation module 438 can pull desired data related to systems with lower budgets and higher risk tolerances.

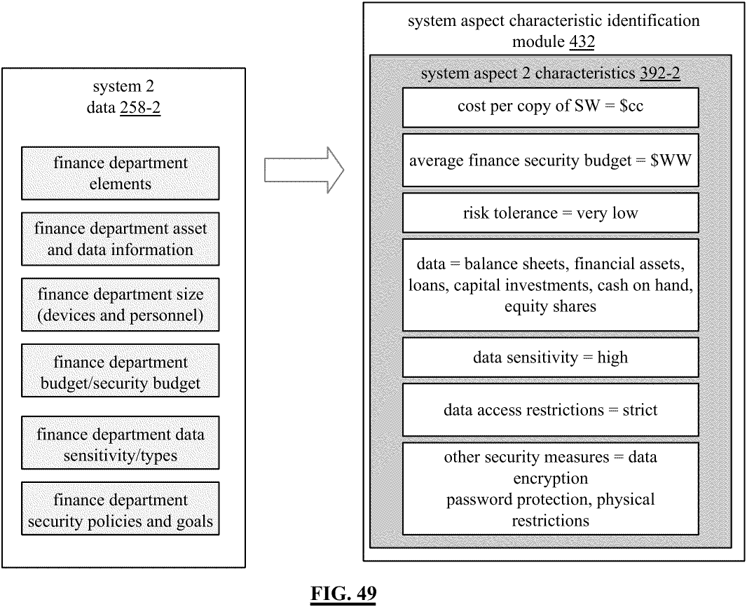

FIG. 49 is a schematic block diagram of an embodiment of a system aspect characteristic identification module 432 generating system aspect characteristics 392-2 for a system aspect 2 of a system 2. The system aspect 2 is antivirus techniques of a resulting financial department of system 2.

The system aspect characteristic identification module 432 obtains system 2 data 258-2 pertaining to the system aspect 2 via the database or by request and extracts system aspect 2 characteristics 392-2 for the system aspect 2. For example, the system aspect characteristic identification module 432 obtains the system data 258-2 such as a list of system elements, asset and data information, system size (based on personnel, based on data, etc.), cost/budget (e.g., for security, overall, etc.), sensitivity/types of data, and security policies and/or security goals.

From the system 2 data, the system aspect characteristic identification module 432 extracts system aspect 2 characteristics 392-2 for the system aspect. For example, the system aspect characteristic identification module 432 extracts system aspect 2 characteristics 392-2 based on default datapoints of interest, based on one or more inputs, and/or based on the normalized model characteristics. For example, the system aspect 2 characteristics 392-2 include a cost per copy of antivirus software of $cc, an average finance security budget of $WW, a risk tolerance of very low, typical data of balance sheets, financial assets, loans, capital investments, cash on hand, and equity shares, a data sensitivity level of high, a data access restrictions level of strict, and other security measures such as data encryption and password protection.

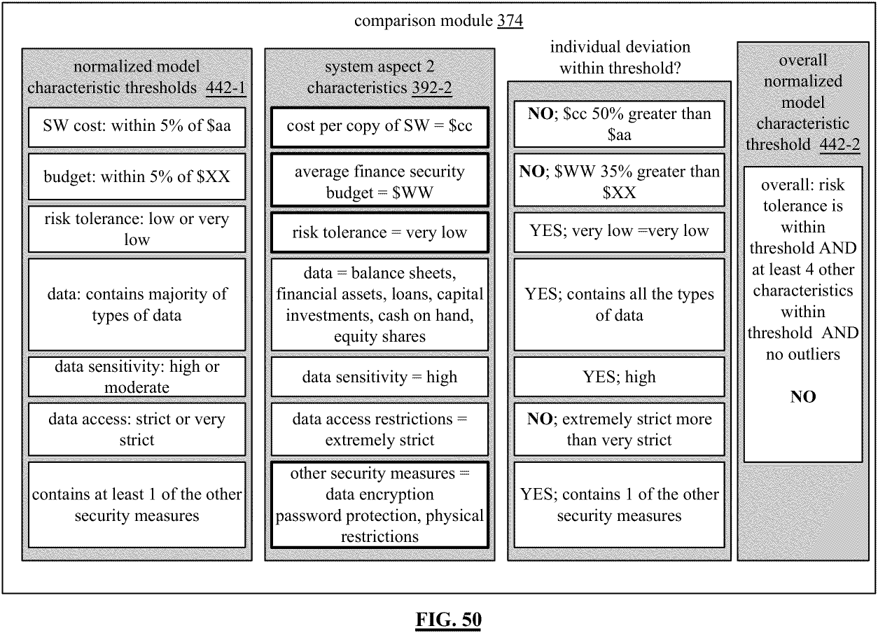

FIG. 50 is a schematic block diagram of an embodiment of a comparison module 434 of a situational or general proficiency data determination module comparing the normalized model characteristics 441 of FIG. 46 with the system aspect 2 characteristics 392-2 of FIG. 49. The comparison module 434 compares the system aspect 2 characteristics 392-2 and the normalized model characteristics 441 to determine whether the system aspect 2 characteristics 392-2 are within normalized model characteristic thresholds 442-1 and 442-2 (i.e., “thresholds”).

The comparison module 434 of FIG. 50 operates similarly to the comparison module 434 of FIG. 48. The comparison module 434 compares each system aspect 2 characteristic 392-2 with each of the normalized model characteristic thresholds 442-1 to determine whether a deviation from each normalized model characteristic is within its specified threshold. In this example, the cost per copy of antivirus software of system aspect 2 is not within the threshold of within 5% because $cc is 50% more than $aa, the average finance security budget is not within the threshold of within 5% because $WW is 35% more than $XX, the risk tolerance is within the threshold of low or very low because the risk tolerance is very low, the data types are within the threshold because the system aspect 2 has at least a majority of similar data types as the normalized model characteristics, the data sensitivity level is within the threshold of high or moderate because it is high, the data access restrictions level is not within the threshold of strict or very strict because extremely strict is higher than strict, and the other security measures are within the threshold of “at least 1 of the other security measures” because the system aspect 1 contains all of other security measures indicated.

The comparison module 434 assesses the individual deviations to determine whether the system aspect 2 characteristics are within an overall threshold compared to the normalized model characteristics. In making this assessment, some characteristics may be weighted more heavily than others. For example, the overall normalized model characteristic threshold 442-2 requires the risk tolerance be within the threshold, that at least 4 other characteristics be within their thresholds, and that there are no outliers (i.e., system aspect characteristics that are extremely far outside of the thresholds) for the system aspect characteristics to be considered within the overall threshold of the normalized model characteristics. Many other examples of individual and overall threshold determinations are possible.

In this example, the comparison module 434 determines that the system aspect 2 characteristics are not within the overall threshold of the normalized model characteristics because the system aspect because there are only 3 other characteristics within their thresholds. Further, the cost per copy of software and the budget are nearly outliers.

Because the characteristics are not within the overall threshold of the normalized model characteristics, the comparison module 434 provides an indication to the proficiency data retrieval parameters generation module 438 to gather situational proficiency data for the evaluation of the system aspect 2. The situational proficiency data includes data that is more tailored to system aspect 2 where the system 2 performance is more important than the budget. For example, the comparison module 434 shares the individual deviation information with the proficiency data retrieval parameters generation module 438 such that the proficiency data retrieval parameters generation module 438 can pull desired data related to systems with higher budgets and lower risk tolerances.

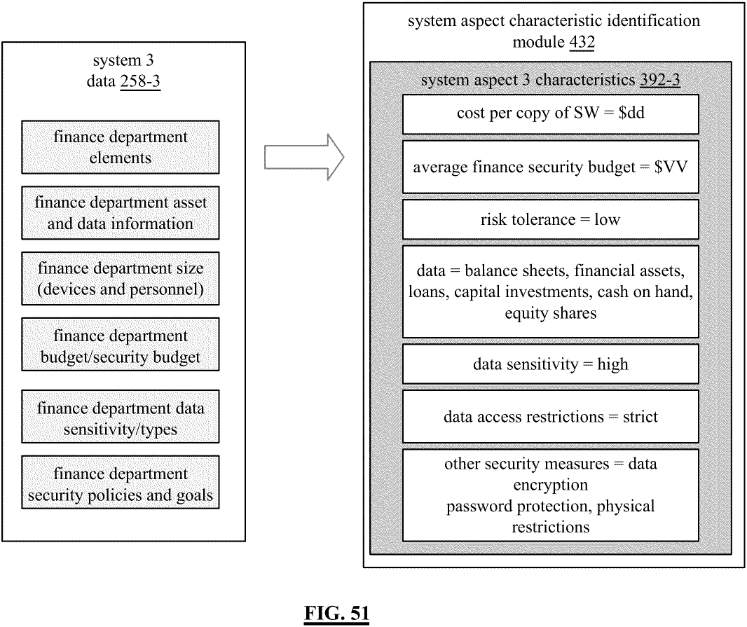

FIG. 51 is a schematic block diagram of an embodiment of a system aspect characteristic identification module 432 generating system aspect characteristics 392-3 for a system aspect 3 of a system 3. The system aspect 3 is antivirus techniques of a resulting financial department of system 3.

The system aspect characteristic identification module 432 obtains system 3 data 258-3 pertaining to the system aspect 3 via the database or by request and extracts system aspect 3 characteristics 392-3 for the system aspect 3. For example, the system aspect characteristic identification module 432 obtains the system data 258-3 such as a list of system elements, asset and data information, system size (based on personnel, based on data, etc.), cost/budget (e.g., for security, overall, etc.), sensitivity/types of data, and security policies and/or security goals.

From the system 3 data, the system aspect characteristic identification module 432 extracts system aspect 3 characteristics 392-3 for the system aspect. For example, the system aspect characteristic identification module 432 extracts system aspect 3 characteristics 392-3 based on default datapoints of interest, based on one or more inputs, and/or based on the normalized model characteristics.

In this example, the system aspect 3 characteristics 392-3 include a cost per copy of antivirus software of $dd, an average finance security budget of $VV, a risk tolerance of low, typical data of balance sheets, financial assets, loans, capital investments, cash on hand, and equity shares, a data sensitivity level of high, a data access restrictions level of strict, and other security measures such as data encryption and password protection.

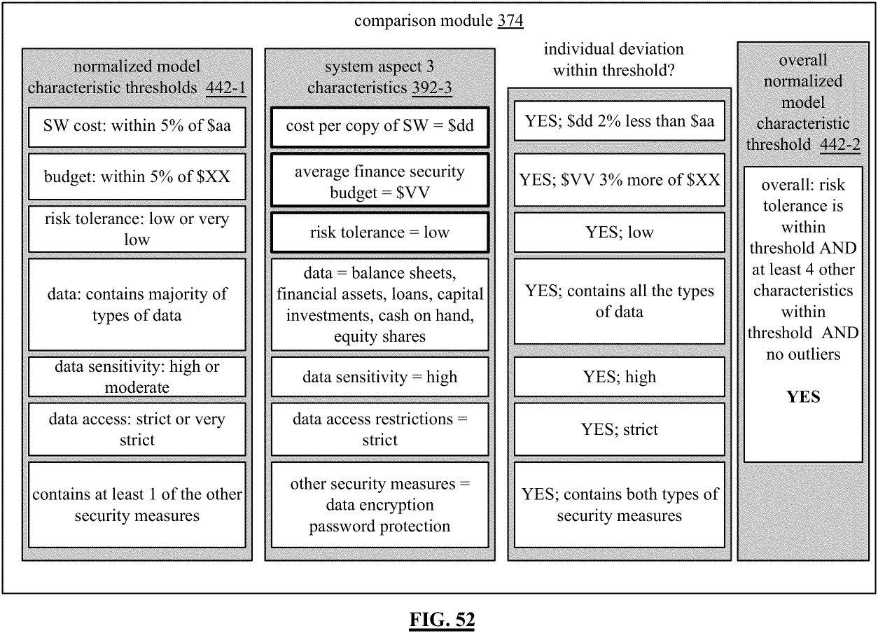

FIG. 52 is a schematic block diagram of an embodiment of a comparison module 434 of a situational or general proficiency data determination module comparing the normalized model characteristics 441 of FIG. 46 with the system aspect 3 characteristics 392-3 of FIG. 51. The comparison module 434 compares the system aspect 3 characteristics 392-3 and the normalized model characteristics 441 to determine whether the system aspect 3 characteristics 392-3 are within normalized model characteristic thresholds 442-1 and 442-2 (i.e., “thresholds”).

The comparison module 434 of FIG. 52 operates similarly to the comparison modules 434 of FIGS. 48 and 50. The comparison module 434 compares each system aspect 3 characteristic 392-3 with each of the normalized model characteristic thresholds 442-1 to determine whether a deviation from each normalized model characteristic is within its specified threshold. In this example, the cost per copy of antivirus software of system aspect 3 is within the threshold of within 5% because $dd is 2% less than $aa, the average finance security budget is within the threshold of within 5% because $VV is 3% more than $XX, the risk tolerance is within the threshold of low or very low because the risk tolerance is low, the data types are within the threshold because the system aspect 2 has at least a majority of similar data types as the normalized model characteristics, the data sensitivity level is within the threshold of high or moderate because it is high, the data access restrictions level is within the threshold of strict or very strict because the data access restrictions level is strict, and the other security measures are within the threshold of “at least 1 of the other security measures” because the system aspect 1 contains all of other security measures indicated.

The comparison module 434 assesses the individual deviations to determine whether the system aspect 2 characteristics are within an overall threshold compared to the normalized model characteristics. In making this assessment, some characteristics may be weighted more heavily than others. For example, the overall normalized model characteristic threshold 442-2 requires the risk tolerance be within the threshold, that at least 4 other characteristics be within their thresholds, and that there are no outliers (i.e., system aspect characteristics that are extremely far outside of the thresholds) for the system aspect characteristics to be considered within the overall threshold of the normalized model characteristics. Many other examples of individual and overall threshold determinations are possible.

In this example, the comparison module 434 determines that the system aspect 3 characteristics are within the overall threshold of the normalized model characteristics because the system aspect’s risk tolerance level is within the threshold, there are 4 other characteristics within their thresholds, and there are no known outliers.

Because the characteristics are within the overall threshold of the normalized model characteristics, the comparison module 434 provides an indication to the proficiency data retrieval parameters generation module 438 to gather general proficiency data for the evaluation of the system aspect 3. The general proficiency data includes data in accordance with the normalized model where there is a balance of spend and performance.

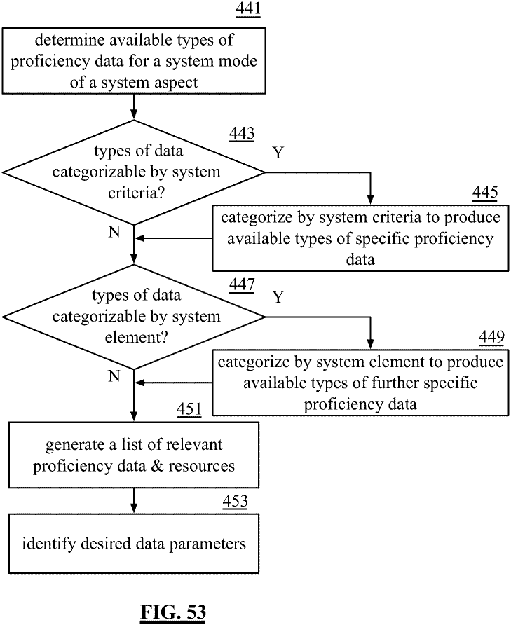

FIG. 53 is a flowchart of an example of a method of identifying desired data parameters for desired data generation. The method begins with step 441 where a proficiency data retrieval parameter module of a desired data generation module of a data input module of an analysis system determines available types of proficiency data for a system mode of a system aspect under an evaluation by the analysis system. Types of proficiency data include products, services, requirements, standards, protocols, and regulations.

The method continues with step 443 where the proficiency data retrieval parameter module determines whether the available types of proficiency data for the system mode can be categorized by a system criteria of the system aspect. When the available types of proficiency data for the system mode can be categorized by the system criteria, the method continues with step 445 where the proficiency data retrieval parameter module categorizes the available types of proficiency data for the system mode by the system criteria to produce available types of specific proficiency data.

The method continues with step 447 where the proficiency data retrieval parameter module determines whether the available types of proficiency data for the system mode can be categorized by a system element of the system aspect. When the available types of proficiency data for the system mode can be categorized by the system element, the method continues with step 449 where the proficiency data retrieval parameter module categorizes the available types of proficiency data for the system mode (and optionally the system criteria) by the system element to produce available types of further specific proficiency data.

The method continues with step 451 where the proficiency data retrieval parameter module generates a list of relevant proficiency data retrieval parameters and resources from one or more of the available types of specific proficiency data and the available types of further specific proficiency data. For example, the list of relevant proficiency data retrieval parameters may include supplier materials, government materials, industry materials etc.

Depending on whether the available types of proficiency data are categorizable by a system mode, system criteria, and/or system element, the proficiency data retrieval parameter module can identify resources relevant to the proficiency data and the system mode, system criteria, and/or system element. For example, when a product is categorizable by a system element, a resource may include system elements of other systems. The method continues with step 453 where the proficiency data retrieval parameter module identifies a list of desired data parameters based on the list of relevant proficiency data retrieval and resource parameters.

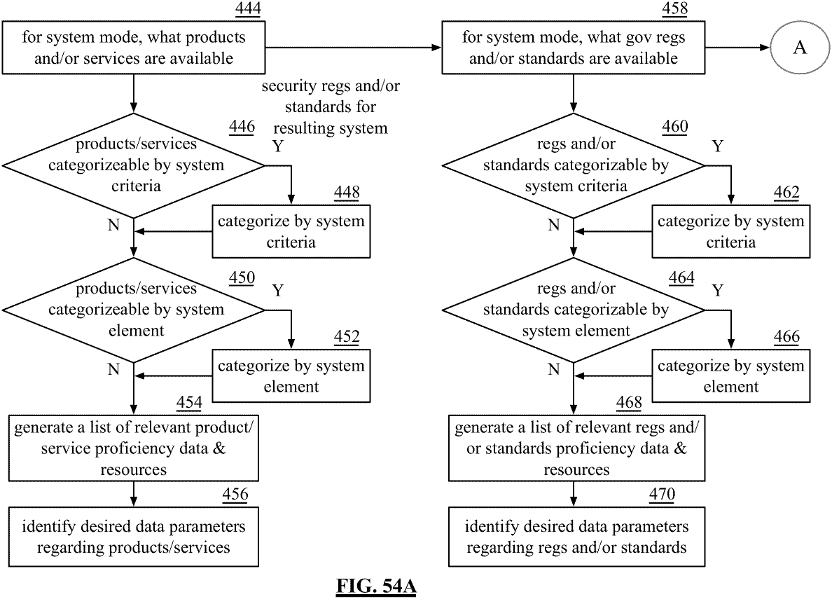

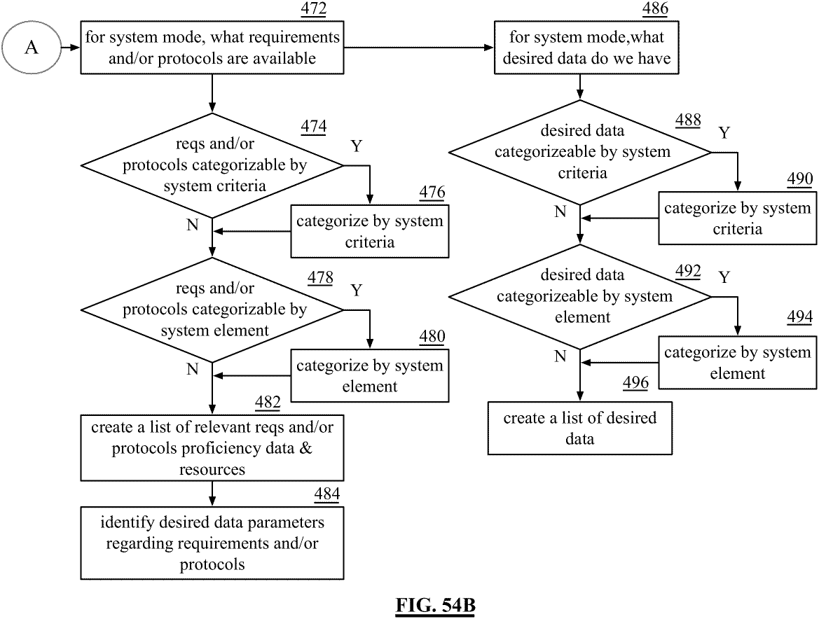

FIGS. 54A-54B are flowcharts of an example of a method of identifying desired data parameters for desired data generation. The method begins with FIG. 54A at step 444 where a proficiency data retrieval parameter module of a desired data generation module of a data input module of an analysis system determines available products and/or services for a system mode of a system aspect under an evaluation by the analysis system. For example, a system mode may include security functions and an available product may be antivirus software.

The method continues with step 446 where the proficiency data retrieval parameter module determines whether the available products and/or services for the system mode can be categorized by a system criteria of the system aspect. When the available products and/or services for the system mode can be categorized by the system criteria, the method continues with step 448 where the proficiency data retrieval parameter module categorizes the available products and/or services for the system mode by the system criteria to produce available specific products and/or services. For example, a system criteria may be a resulting system and an available product may be software related to system operations (e.g., not the design or build of a system).

The method continues with step 450 where the proficiency data retrieval parameter module determines whether the available products and/or services for the system mode can be categorized by a system element of the system aspect. When the available products and/or services for the system mode can be categorized by the system element, the method continues with step 452 where the proficiency data retrieval parameter module categorizes the available products and/or services for the system mode (and optionally the system criteria) by the system element to produce available further specific products and/or services. For example, a system element may be a particular system department and an available product may be software related to that department (e.g., financial department software).

The method continues with step 454 where the proficiency data retrieval parameter module generates a list of relevant products and/or services retrieval parameters and resources from one or more of the available specific products and/or services and the available further specific products and/or services. For example, the list of relevant proficiency data retrieval parameters may include supplier materials and industry materials and the list of resources may include suppliers and industry publications. The method continues with step 456 where the proficiency data retrieval parameter module identifies a list of desired data parameters based on the list of relevant products and/or services retrieval parameters and resources. For example, the desired data parameters include features, costs, and functions of the product.

The method also begins or continues with concurrent, previous, or subsequent steps 458-470. At step 458, the proficiency data retrieval parameter module determines available government regulations and/or standards for the system mode of the system aspect. For example, a system mode may include security functions and available government regulations and/or standards may be antivirus related government regulations and/or standards.

The method continues with step 460 where the proficiency data retrieval parameter module determines whether the government regulations and/or standards for the system mode can be categorized by a system criteria of the system aspect. When the government regulations and/or standards for the system mode can be categorized by the system criteria, the method continues with step 462 where the proficiency data retrieval parameter module categorizes the government regulations and/or standards for the system mode by the system criteria to produce available specific government regulations and/or standards. For example, a system criteria may be a resulting system and available government regulations and/or standards may be government regulations and/or standards related to system operations (e.g., not the design or build of a system).

The method continues with step 464 where the proficiency data retrieval parameter module determines whether the available government regulations and/or standards for the system mode can be categorized by the system element of the system aspect. When the government regulations and/or standards for the system mode can be categorized by the system element, the method continues with step 466 where the proficiency data retrieval parameter module categorizes the available government regulations and/or standards for the system mode (and optionally the system criteria) by the system element to produce available further specific government regulations and/or standards. For example, a system element may be a particular system department and available government regulations and/or standards may be government regulations and/or standards related to that department (e.g., financial department government regulations and/or standards).

The method continues with step 468 where the proficiency data retrieval parameter module generates a list of relevant government regulations and/or standards retrieval parameters and resources from one or more of the available specific government regulations and/or standards and the available further specific government regulations and/or standards. The method continues with step 470 where the proficiency data retrieval parameter module identifies a list of desired data parameters based on the list of relevant government regulations and/or standards retrieval parameters and resources. For example, the desired data parameters include specific rules regarding security functions of a resulting financial department.

The method also begins or continues with a concurrent, previous, or subsequent step A that continues on FIG. 54B. In FIG. 54B, at step A, the method continues with step 472 where the proficiency data retrieval parameter module determines available requirements and/or protocols for the system mode of the system aspect. For example, a system mode may include security functions and requirements and/or protocols may be antivirus related industry requirements and/or protocols.

The method continues with step 474 where the proficiency data retrieval parameter module determines whether the available requirements and/or protocols for the system mode can be categorized by a system criteria of the system aspect. When the available requirements and/or protocols for the system mode can be categorized by the system criteria, the method continues with step 476 where the proficiency data retrieval parameter module categorizes the available requirements and/or protocols for the system mode by the system criteria to produce available specific available requirements and/or protocols. For example, a system criteria may be a resulting system and available requirements and/or protocols may be requirements and/or protocols related to system operations (e.g., not the design or build of a system).

The method continues with step 478 where the proficiency data retrieval parameter module determines whether the available requirements and/or protocols for the system mode can be categorized by the system element of the system aspect. When the requirements and/or protocols for the system mode can be categorized by the system element, the method continues with step 480 where the proficiency data retrieval parameter module categorizes the available requirements and/or protocols for the system mode (and optionally the system criteria) by the system element to produce available further specific requirements and/or protocols. For example, a system element may be a particular system department and available requirements and/or protocols may be requirements and/or protocols related to that department (e.g., financial department industry requirements and/or protocols).

The method continues with step 482 where the proficiency data retrieval parameter module generates a list of relevant requirements and/or protocols retrieval parameters and resources from one or more of the available specific requirements and/or protocols and the available further specific requirements and/or protocols. The method continues with step 484 where the proficiency data retrieval parameter module identifies a list of desired data parameters based on the list of relevant requirements and/or protocols retrieval parameters and resources. For example, the desired data parameters include specific requirements and/or protocols regarding security functions of a resulting financial department.

The method also begins or continues with a concurrent, previous, or subsequent step 486 where the proficiency data retrieval parameter module determines available stored desired data for the system mode of the system aspect. For example, a system mode may include security functions and available stored desired data may include any stored product and/or service information, government regulations, and/or industry protocols related to security functions.

The method continues with step 488 where the proficiency data retrieval parameter module determines whether the available stored desired data for the system mode can be categorized by a system criteria of the system aspect. When the available stored desired data for the system mode can be categorized by the system criteria, the method continues with step 490 where the proficiency data retrieval parameter module categorizes the available requirements and/or protocols for the system mode by the system criteria to produce available specific stored desired data. For example, a system criteria may be a resulting system and available stored desired data may include any stored product and/or service information, government regulations, and/or industry protocols related to system operations (e.g., not the design or build of a system).

The method continues with step 492 where the proficiency data retrieval parameter module determines whether the available stored desired data for the system mode can be categorized by the system element of the system aspect. When the stored desired data for the system mode can be categorized by the system element, the method continues with step 494 where the proficiency data retrieval parameter module categorizes the available stored desired data for the system mode (and optionally the system criteria) by the system element to produce available further specific stored desired data. For example, a system element may be a particular system department and available stored desired data may be any stored product and/or service information, government regulations, and/or industry protocols related to that department (e.g., financial department stored desired data).

The method continues with step 496 where the proficiency data retrieval parameter module generates a list of stored desired data parameters from one or more of the available stored desired data and the available further specific stored desired data. For example, the desired data parameters include specific stored desired data regarding security functions of a resulting financial department.

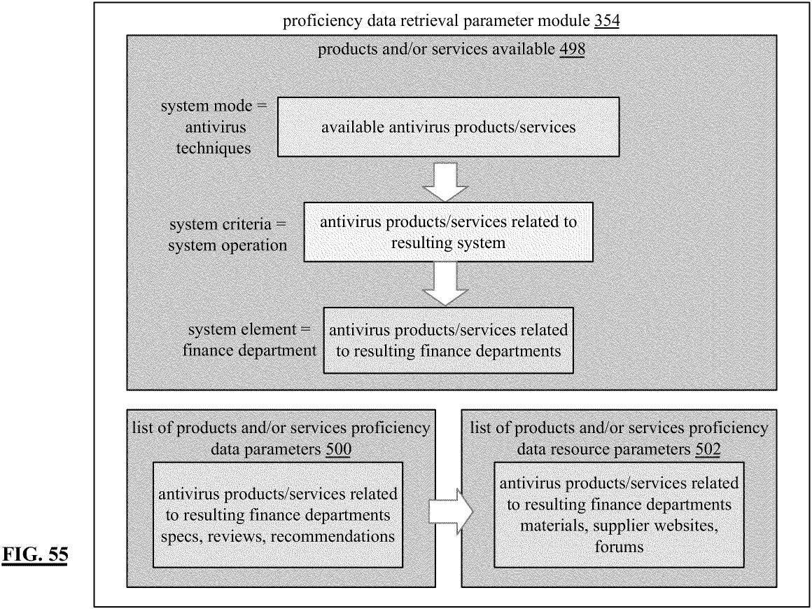

FIG. 55 is a diagram of an example of a proficiency data retrieval parameter module 354 generating a list of products and/or services proficiency data parameters. FIG. 55 depicts a specific example of identifying proficiency data retrieval parameters where the system aspect includes a system mode of antivirus security functions, system criteria of resulting system, and a system element of a finance department. In FIG. 55, the proficiency data retrieval parameter module 354 determines available products and/or services 498 for the system mode of antivirus techniques. For example, the proficiency data retrieval parameter module 354 determines available antivirus software products and/or services such as antivirus software, virtual private networks (VPNs), malware removal tools, password management, etc.

The proficiency data retrieval parameter module determines whether the available antivirus software products and/or services can be categorized by the system criteria of system operation. In this example, the available antivirus software products and/or services are categorized by the system criteria of resulting system to produce available antivirus software products and/or services related to resulting systems. For example, some available antivirus products and/or services may relate to antivirus technique setup, planning, and/or build but, in this case, the available antivirus products and/or services categorized by resulting system relate to antivirus techniques in operation.

When all the available antivirus products and/or services relate to resulting system, then the available antivirus products and/or services related to resulting system and the available antivirus products and/or services are the same. In another example, the available antivirus products and/or services are not categorizable by system operation. For example, the available antivirus products and/or services all relate to system design. In that example, the proficiency data retrieval parameter module will skip to the next step of determining whether the available antivirus software products and/or services can be categorized by financial departments.

The proficiency data retrieval parameter module determines whether the available antivirus products and/or services related to resulting system (or the available antivirus products and/or services related when the previous step is skipped) can be categorized by the system element of finance departments. When the available antivirus products and/or services related to resulting systems can be categorized by finance departments, the proficiency data retrieval parameter module categorizes the available antivirus products and/or services related to resulting systems by finance departments to produce the available antivirus products and/or services related to resulting finance departments. For example, a particular antivirus product may be specifically tailored to the needs of protecting sensitive financial data of financial departments.

The proficiency data retrieval parameter module generates a list of products and/or services proficiency data parameters 500 based on the available antivirus products and/or services related to resulting finance departments. For example, the list of products and/or services proficiency data parameters 500 includes a list of the types of proficiency data desired from the available antivirus products and/or services related to resulting finance departments such as specifications, reviews, and recommendations related to the available antivirus software products and/or services related to resulting finance departments.

The proficiency data retrieval parameter module also generates a list of products and/or services proficiency data resource parameters 502 based on the list of available products and/or services proficiency data parameters 500. For example, based on the list of available products and/or services proficiency data parameters 500, the proficiency data retrieval parameter module identifies a list of resources to gather the types of proficiency data desired from the available antivirus products and/or services related to resulting finance departments. For example, the list of products and/or services proficiency data resource parameters 502 includes a list of resources such as antivirus product and/or services other system’s materials, supplier websites, and forums.

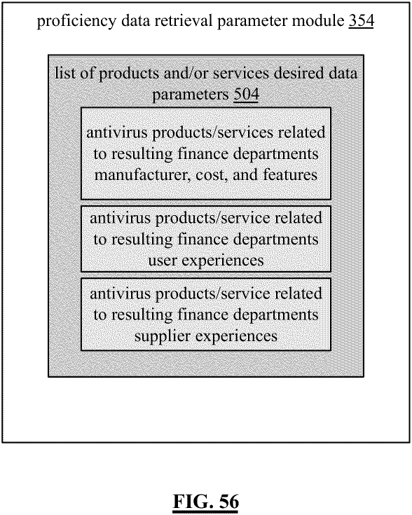

FIG. 56 is a diagram of an example of a proficiency data retrieval parameter module 354 generating a list of products and/or services desired data parameters 504. FIG. 56 continues the example of FIG. 55. Based on the list of available products and/or services proficiency data parameters 500 and the list of products and/or services proficiency data resource parameters 502 from FIG. 55, the proficiency data retrieval parameter module 354 determines the list of products and/or services desired data parameters 504.

For example, the proficiency data retrieval parameter module 354 determines to gather data regarding the specifications such as manufacturer, cost, and features of the antivirus products and/or services related to resulting finance departments (e.g., from the product/service manual resources). The proficiency data retrieval parameter module 354 further determines to gather data pertaining to reviews and recommendations such as user and supplier experiences of the antivirus products and/or services related to resulting finance departments (e.g., from the reviews and recommendations resources). The proficiency data retrieval parameter module 354 makes the determination of what desired data is necessary based on default parameters, an analytic model, data inputs, and/or an analysis of the system aspect.

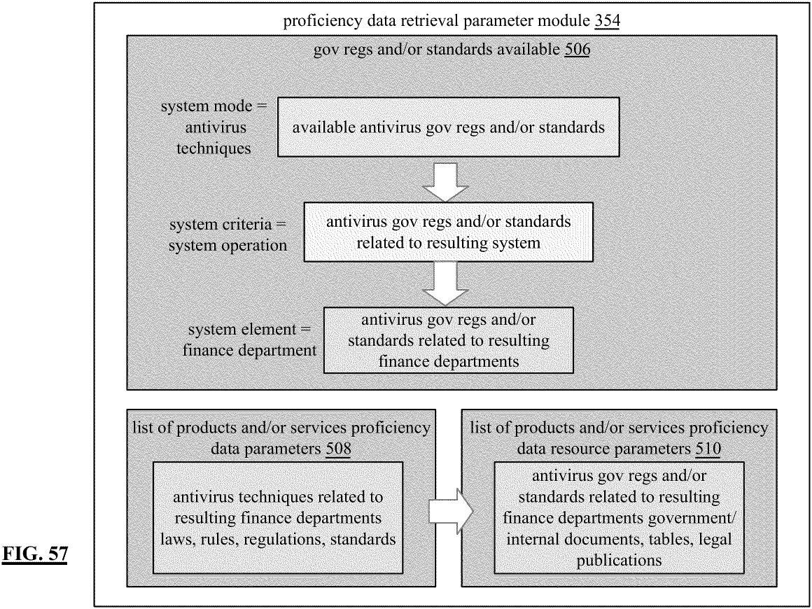

FIG. 57 is a diagram of an example of a proficiency data retrieval parameter module 354 generating a list of government (govt) regulations (regs) and/or standards proficiency data parameters. FIG. 57 depicts a specific example of identifying proficiency data retrieval parameters where the system aspect includes a system mode of antivirus techniques, system criteria of resulting system, and a system element of a finance department. In FIG. 57, the proficiency data retrieval parameter module 354 determines available government regulations and/or standards 506 for the system mode of antivirus techniques. For example, the proficiency data retrieval parameter module 354 determines available antivirus laws, rules, regulations, and/or standards.

The proficiency data retrieval parameter module determines whether the available antivirus government regulations and/or standards can be categorized by the system criteria of resulting system. In this example, the available antivirus government regulations and/or standards are categorized by the system criteria of resulting system to produce available antivirus government regulations and/or standards related to resulting system. For example, some available antivirus government regulations and/or standards may relate to antivirus technique setup, planning, and/or setup but, in this case, the available antivirus government regulations and/or standards categorized by resulting system relate to antivirus techniques in operation.

When all the available antivirus government regulations and/or standards relate to resulting system, then the available antivirus government regulations and/or standards related to resulting system and the available antivirus government regulations and/or standards are the same. In another example, the available antivirus government regulations and/or standards are not categorizable by resulting system. For example, the available antivirus government regulations and/or standards all relate to system design. In that example, the proficiency data retrieval parameter module will skip to the next step of determining whether the available antivirus government regulations and/or standards can be categorized by a system element of financial departments.

The proficiency data retrieval parameter module determines whether the available antivirus government regulations and/or standards related to resulting system (or the available antivirus government regulations and/or standards related when the previous step is skipped) can be categorized by finance departments. When the available antivirus government regulations and/or standards related to resulting system can be categorized by finance departments, the proficiency data retrieval parameter module categorizes the available antivirus government regulations and/or standards related to resulting systems by finance departments to produce the available antivirus government regulations and/or standards related to resulting finance departments. For example, a particular law may apply to protecting sensitive financial data.

The proficiency data retrieval parameter module generates a list of government regulations and/or standards proficiency data parameters 508 based on the available antivirus government regulations and/or standards related to resulting finance departments. For example, the list of government regulations and/or standards proficiency data parameters 508 includes a list of the types of proficiency data desired from the available antivirus government regulations and/or standards related to resulting finance departments such as laws, rules, regulations, and standards related to antivirus techniques related to resulting finance departments.

The proficiency data retrieval parameter module also generates a list of government regulations and/or standards proficiency data resource parameters 510 based on the list of available government regulations and/or standards proficiency data parameters 508. For example, based on the list of available government regulations and/or standards proficiency data parameters 508, the proficiency data retrieval parameter module identifies a list of resources to gather the types of proficiency data desired from the available antivirus government regulations and/or standards related to resulting finance departments. For example, the list of government regulations and/or standards proficiency data resource parameters 510 includes a list of resources such as government documents, internal documents, tables, and legal publications.

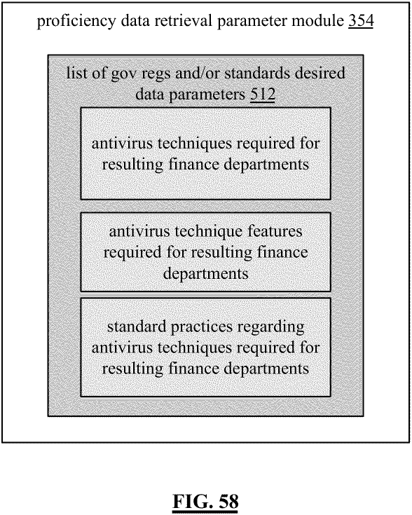

FIG. 58 is a diagram of an example of a proficiency data retrieval parameter module 354 generating a list of government regulations and/or standards desired data parameters 512. FIG. 58 continues the example of FIG. 57. Based on the list of available government regulations and/or standards proficiency data parameters 508 and the list of government regulations and/or standards proficiency data resource parameters 510 from FIG. 57, the proficiency data retrieval parameter module 354 determines the list of government regulations and/or standards desired data parameters 512.

For example, the proficiency data retrieval parameter module 354 determines to gather data regarding the required antivirus techniques for resulting finance departments (e.g., from the laws, rules, and regulations). The proficiency data retrieval parameter module 354 further determines to gather data pertaining to data regarding the required antivirus technique features for resulting finance departments (e.g., from the laws, rules, and regulations). The proficiency data retrieval parameter module 354 further determines to gather data pertaining to data regarding standard practices regarding antivirus techniques for resulting finance departments (e.g., from the standards). The proficiency data retrieval parameter module 354 makes the determination of what desired data is necessary based on default parameters, an analytic model, data inputs, and/or an analysis of the system aspect.

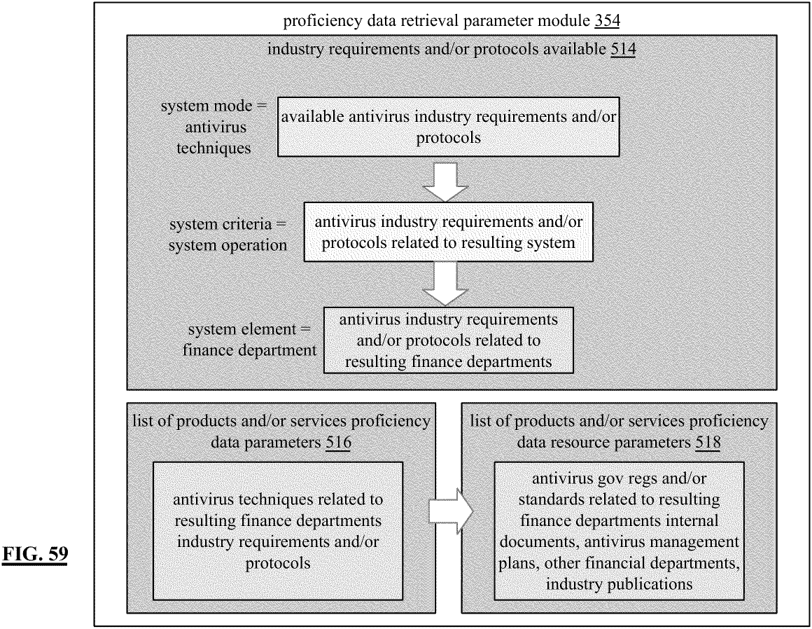

FIG. 59 is a diagram of an example of a proficiency data retrieval parameter module 354 generating a list of industry requirements and/or protocols proficiency data parameters. FIG. 59 depicts a specific example of identifying proficiency data retrieval parameters where the system aspect includes a system mode of antivirus techniques, system criteria of resulting system, and a system element of a finance department. In FIG. 59, the proficiency data retrieval parameter module 354 determines available industry requirements and/or protocols 514 for the system mode of antivirus techniques. For example, the proficiency data retrieval parameter module 354 determines available antivirus industry requirements, protocols, standards, and practices.

The proficiency data retrieval parameter module determines whether the available antivirus industry requirements and/or protocols can be categorized by the system criteria of system operation. In this example, the available antivirus industry requirements and/or protocols are categorized by the system criteria of resulting system to produce available antivirus industry requirements and/or protocols related to resulting system. For example, some available antivirus industry requirements and/or protocols may relate to antivirus technique setup, planning, and/or setup but, in this case, the available antivirus industry requirements and/or protocols categorized by system operation relate to antivirus techniques in operation.

When all the available antivirus industry requirements and/or protocols relate to resulting system, then the available antivirus industry requirements and/or protocols related to resulting system and the available antivirus industry requirements and/or protocols are the same. In another example, the available antivirus industry requirements and/or protocols are not categorizable by resulting systems. For example, the available antivirus industry requirements and/or protocols all relate to system design. In that example, the proficiency data retrieval parameter module will skip to the next step of determining whether the available antivirus industry requirements and/or protocols can be categorized by the system element of financial departments.

The proficiency data retrieval parameter module determines whether the available antivirus industry requirements and/or protocols related to resulting system (or the available antivirus industry requirements and/or protocols related when the previous step is skipped) can be categorized by finance departments. When the available industry requirements and/or protocols related to resulting system can be categorized by finance departments, the proficiency data retrieval parameter module categorizes the available antivirus industry requirements and/or protocols related to resulting system by finance departments to produce the available antivirus industry requirements and/or protocols related to resulting system and finance departments. For example, a particular industry standard may apply to protecting sensitive financial data.

The proficiency data retrieval parameter module generates a list of industry requirements and/or protocols proficiency data parameters 516 based on the available antivirus industry requirements and/or protocols related to resulting finance departments. For example, the list of industry requirements and/or protocols proficiency data parameters 516 includes a list of the types of proficiency data desired from the available antivirus industry requirements and/or protocols related to resulting finance departments such as industry requirements and protocols related to antivirus techniques related to resulting finance departments.

The proficiency data retrieval parameter module also generates a list of industry requirements and/or protocols proficiency data resource parameters 518 based on the list of available industry requirements and/or protocols data parameters 516. For example, based on the list of available industry requirements and/or protocols proficiency data parameters 516, the proficiency data retrieval parameter module identifies a list of resources to gather the types of proficiency data desired from the available antivirus industry requirements and/or protocols related to resulting finance departments. For example, the list of industry requirements and/or protocols proficiency data resource parameters 518 includes a list of resources such as internal documents, antivirus management plans, other financial departments, and industry publications.

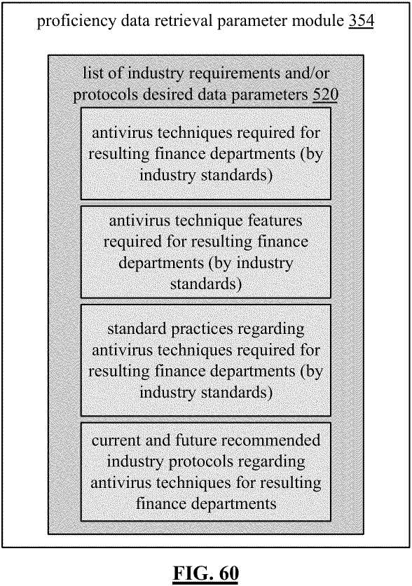

FIG. 60 is a diagram of an example of a proficiency data retrieval parameter module 354 generating a list of industry requirements and/or protocols desired data parameters 520. FIG. 60 continues the example of FIG. 59. Based on the list of available industry requirements and/or protocols proficiency data parameters 516 and the list of industry requirements and/or protocols proficiency data resource parameters 518 from FIG. 59, the proficiency data retrieval parameter module 354 determines the list of industry requirements and/or protocols desired data parameters 520.

For example, the proficiency data retrieval parameter module 354 determines to gather data regarding the required antivirus techniques for resulting finance departments (e.g., from the antivirus management plans, etc.) according to industry standards (i.e., not legal standards). The proficiency data retrieval parameter module 354 further determines to gather data pertaining to data regarding the required antivirus technique features for resulting finance departments (e.g., from the other financial departments, industry publications, etc.). The proficiency data retrieval parameter module 354 further determines to gather data pertaining to data regarding standard industry practices regarding antivirus techniques for resulting finance departments (e.g., from the antivirus management plans, internal documents, other financial departments, industry publications, etc.).

The proficiency data retrieval parameter module 354 further determines to gather data pertaining to data regarding current and future recommended industry protocols regarding antivirus techniques for resulting finance departments (e.g., from industry publications, etc.). The proficiency data retrieval parameter module 354 makes the determination of what desired data is necessary based on default parameters, an analytic model, data inputs, and/or an analysis of the system aspect.

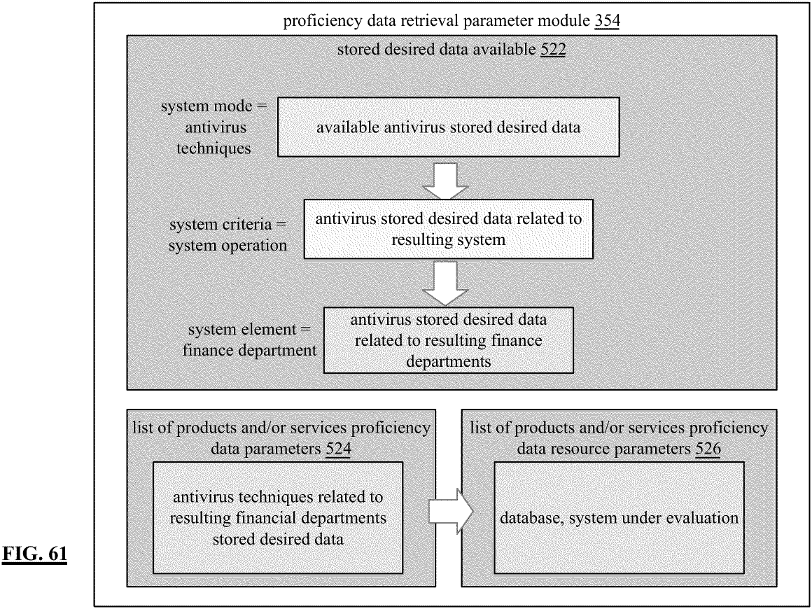

FIG. 61 is a diagram of an example of a proficiency data retrieval parameter module 354 generating a list of stored desired data proficiency data parameters. FIG. 61 depicts a specific example of identifying proficiency data retrieval parameters where the system aspect includes a system mode of antivirus techniques, system criteria of resulting system, and a system element of a finance department. In FIG. 61, the proficiency data retrieval parameter module 354 determines available stored desired data 522 for the system mode of antivirus techniques. For example, the proficiency data retrieval parameter module 354 determines available antivirus stored desired data.

The proficiency data retrieval parameter module determines whether the available antivirus stored desired data can be categorized by the system criteria of resulting system. In this example, the available antivirus stored desired data are categorized by the system criteria of resulting system to produce available antivirus stored desired data related to resulting systems. For example, some available antivirus stored desired data may relate to antivirus technique setup, planning, and/or setup but, in this case, the available antivirus stored desired data categorized by resulting systems relate to antivirus techniques in operation.

The proficiency data retrieval parameter module determines whether the available antivirus stored desired data related to resulting system (or the available antivirus stored desired data related when the previous step is skipped) can be categorized by the system element of finance departments. When the available stored desired data related to resulting system can be categorized by finance departments, the proficiency data retrieval parameter module categorizes the available antivirus stored desired data related to resulting system by finance departments to produce the available antivirus stored desired data related to resulting system and finance departments. For example, stored desired data may apply to protecting sensitive financial data.

The proficiency data retrieval parameter module generates a list of stored desired data proficiency data parameters 524 based on the available antivirus stored desired data related to resulting system and finance departments. For example, the list of stored desired data proficiency data parameters 524 includes a list of the types of proficiency data desired from the available antivirus stored desired data related to resulting finance departments such as antivirus techniques related to resulting finance departments.

The proficiency data retrieval parameter module also generates a list of stored desired data proficiency data resource parameters 526 based on the list of available stored desired data parameters 524. For example, based on the list of available stored desired data proficiency data parameters 524, the proficiency data retrieval parameter module identifies a list of resources to gather the types of proficiency data desired from the available stored desired data related to resulting finance departments. For example, the list of stored desired data proficiency data resource parameters 526 includes the analysis system database, and the system under evaluation.

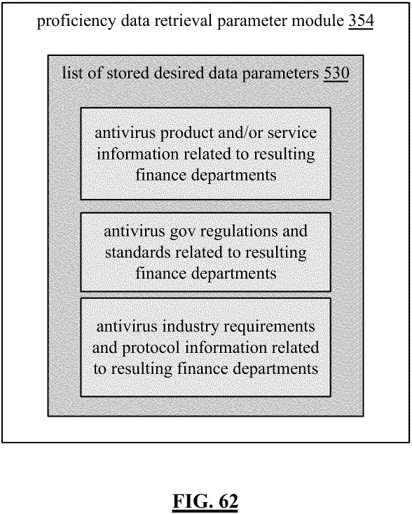

FIG. 62 is a diagram of an example of a proficiency data retrieval parameter module 354 generating a list of stored desired data parameters 530. FIG. 62 continues the example of FIG. 61. Based on the list of available stored desired data proficiency data parameters 524 and the list of stored desired data proficiency data resource parameters 526 from FIG. 61, the proficiency data retrieval parameter module 354 determines the list of stored desired data parameters 530.

For example, the proficiency data retrieval parameter module 354 determines to gather stored desired data regarding antivirus products and/or services regarding resulting finance departments (e.g., from the database). The proficiency data retrieval parameter module 354 further determines to gather stored desired data regarding antivirus government regulations and/or standards regarding resulting finance departments (e.g., from the database). The proficiency data retrieval parameter module 354 further determines to gather stored desired data regarding antivirus industry requirements and/or protocols regarding resulting finance departments (e.g., from the database).

The proficiency data retrieval parameter module 354 makes the determination of what desired data is necessary based on default parameters, an analytic model, data inputs, and/or an analysis of the system aspect.

The proficiency data retrieval parameter module 354 may determine to test one or more of the list of products and/or services desired data parameters 504, the list of stored desired data parameters 530, the list of government regulations and/or standards desired data parameters 512, the list of industry requirements and/or protocols desired data parameters 520, and the list of stored desired data parameters 530 to determine whether the list is accurate and/or complete. The proficiency data retrieval parameter module 354 may first determine whether it is beneficial to test the one or more lists based on one or more factors (e.g., amount of data, estimated time of testing, system preferences, etc.). When testing is beneficial, the proficiency data retrieval parameter module 354 tests the one or more lists by one or more of a comparison of the one or more lists to an analytic model, gathering data to determine completeness of the one or more lists, and/or comparing the one or more lists to one or more stored lists. When the testing reveals that the list is inaccurate and/or incomplete, the parameters can be adjusted to correct the issues (e.g., gather additional data, delete certain data, etc.).

FIG. 63 is a schematic block diagram of an embodiment of a data input module 250 of an analysis system that includes a desired data generation module 350. The desired data generation module 350 includes a proficiency data retrieval parameter module 354, a proficiency data extraction module 356, and a proficiency data evaluation module 358. The data input module 250 of FIG. 63 operates similarly to the data input module 250 of FIG. 35 except that the proficiency data retrieval parameter module 354 is shown to include a proficiency data trustworthiness module 532.

The data input module 250 receives the data gathering parameters 263 as discussed with reference to FIG. 34. In this example, the data gathering parameters 263 include a system aspect and an evaluation aspect. When the evaluation aspect includes an evaluation viewpoint of desired (e.g., the desired evaluation viewpoint), the desired data generation module 350 is triggered to obtain information from one or more data sources 366 to gather system proficiency data 364.

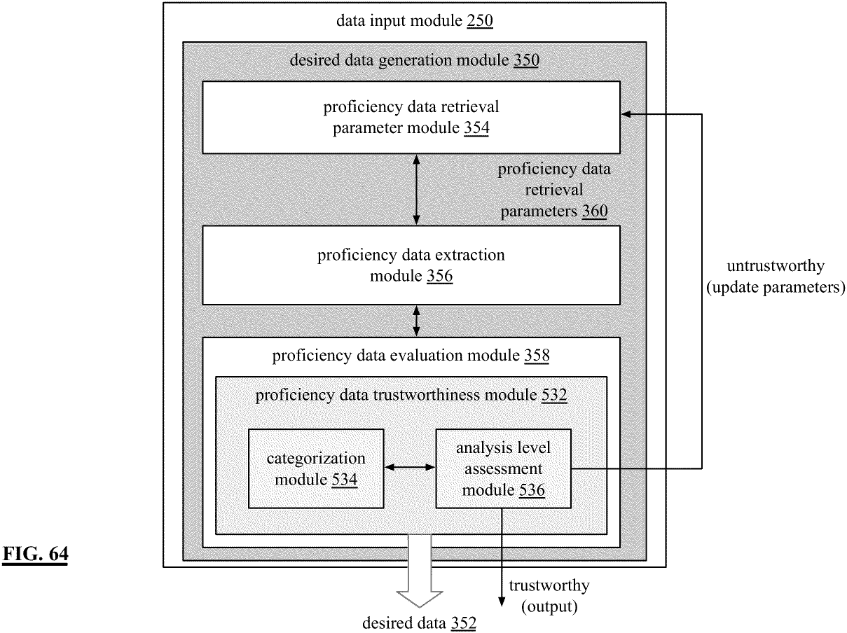

The proficiency data extraction module 356 gathers the proficiency data 364 (e.g., either the situational or general proficiency data) from the system proficiency data (e.g., already obtained and/or stored system proficiency data) and/or directly from one or more of the data sources based on the proficiency data retrieval parameters 360. The proficiency data evaluation module 358 analyzes the gathered proficiency data 260 to identify relevant characteristics (e.g., features, functions, cost, performance, reviews, experiences, evaluations, etc.) of the gathered proficiency data 260 as the desired data. Additionally, the proficiency data trustworthiness module 532 determines the trustworthiness of the gathered proficiency data 364. The proficiency data trustworthiness module 532 will be discussed in further detail with reference to FIGS. 64-67.

FIG. 64 is a schematic diagram of an example of a data input module 250 of an analysis system that includes a desired data generation module 350. The data input module 250 of FIG. 64 operates similarly to the data input module 250 of FIG. 63 except that the proficiency data trustworthiness module 532 is shown in more detail. The proficiency data trustworthiness module 532 includes a categorization module 534 and an analysis level assessment module 536.

The categorization module 534 categorizes the gathered proficiency data 364 into one or more datasets. A dataset is at one data point having at least one common characteristic with one another data point in the set or is the only data point in the data set. For example, the gathered proficiency data 364 may be categorized according to a particular subject matter.

The analysis level assessment module 536 determines an analysis level of a range of analysis levels for each data point of a dataset. The range of analysis levels go from a very favorable level to a very unfavorable level with a median of neutral. An analysis level includes a data favorability level weighted by a source reputability level. For example, a very favorable analysis level means the data point includes very favorable information and is from a reputable source. Factors contributing to whether the datapoint includes favorable information includes whether the information is up to date (e.g., current data is weighted more favorably), whether the information reflects positively of a topic (e.g., a positive rating about an antivirus software), whether the information is consistent (e.g., the same or similar from multiple sources), whether the information is thorough (e.g., the information explains a matter completely and/or includes more than one piece of information relevant to the data point), whether the information is cited by other information, whether the information is based on opinion and/or speculation, and/or whether the information is based on facts and/or research.

Factors contributing to whether a data source is reputable include whether the source is up to date, whether the source is well known, whether the source is recommended and/or cited by other sources, whether the types of information provided by the source are opinion-based or fact-based, and/or whether the source filters, monitors, and/or researches information prior to or while sharing the information.

The analysis level assessment module 536 analyzes whether the data points of a dataset are clustered around an analysis level or spread out around two or more analysis levels to determine whether the data set is trustworthy. For example, if one data point of a dataset has favorable information from a reputable source, another data point of the dataset has unfavorable information from a reputable source, and another data point of the dataset has favorable information from a source that is not reputable, the dataset may be considered untrustworthy due to the lack of consistency of the data.

When the gathered proficiency data 364 is considered trustworthy, the desired data 352 is generated from the proficiency data 364 and outputted. When the gathered proficiency data 364 is considered untrustworthy, the analysis level assessment module 536 communicates with the proficiency data retrieval parameter module 354 to adjust the source identification parameters. For example, with the example above, additional reputable source identifiers may be added to the source parameters and the source that is not reputable may be removed. When the proficiency data retrieval parameters are updated, the proficiency data extraction module 356 obtains new information according to the updated proficiency data retrieval parameter. In another example, when the data set includes obvious outliers (e.g., one data point is way off from the others), the data point may be deleted to render the dataset trustworthy.

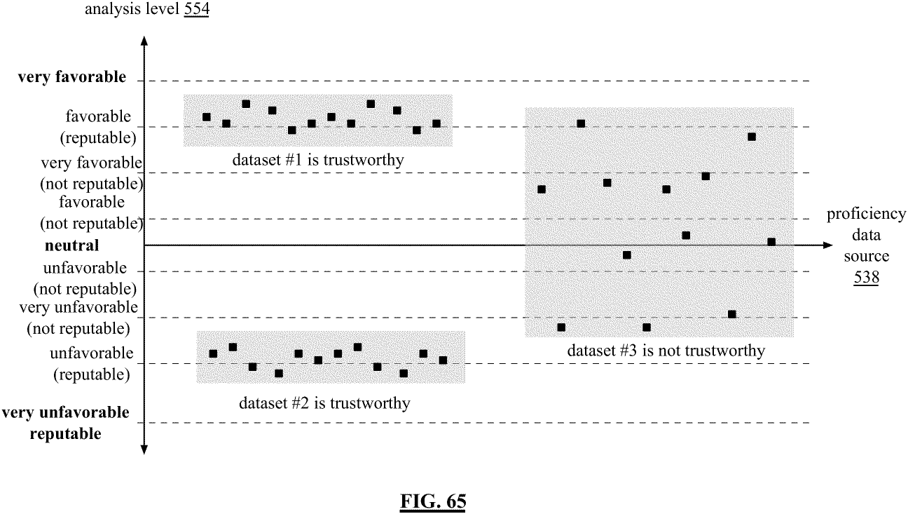

FIG. 65 is a diagram of an example of determining trustworthiness of proficiency data. The proficiency data trustworthiness module of a proficiency data evaluation module of a desired data generation module categorizes gathered proficiency data into datasets. In this example, the proficiency data trustworthiness module categories the gathered proficiency data into three datasets (e.g., datasets #1-#3). A dataset is a set of data points that have at least one common characteristic with one another. For example, the gathered proficiency data may be categorized according to a particular subject matter.

The proficiency data trustworthiness module plots each data point based on an analysis level of a range of analysis levels and proficiency data sources 538. The range of analysis levels go from a very favorable level to a very unfavorable level with a median of neutral. An analysis level includes a data favorability level weighted by a source reputability level. A very favorable analysis level means the data point reflects very favorable information and is from a reputable source. At a lower level than very favorable, a favorable analysis level means the data point reflects favorable information and is from a reputable source. At a lower level or equal to the favorable analysis level, the favorable analysis level also could mean that the data point reflects very favorable information and is not from a reputable source. At a lower level to the favorable analysis level and closer to neutral, a lower favorable analysis level means the data point reflects favorable information and is not from a reputable source.

A neutral analysis level is an analysis level below favorable and above unfavorable. For example, a data point at the neutral analysis level may reflect neutral information and be from a neutral source (e.g., not considered reputable or unreputable). A very unfavorable analysis level means the data point reflects very unfavorable information and is from a reputable source. At a higher level than very unfavorable, an unfavorable analysis level means the data point reflects unfavorable information and is from a reputable source. At a higher level or equal to the unfavorable analysis level, the unfavorable analysis level also means the data point reflects very unfavorable information and is not from a reputable source. At a higher level than the unfavorable analysis level and closer to neutral, a lower unfavorable analysis level means the data point reflects unfavorable information and is not from a reputable source.

Factors contributing to whether the datapoint reflects favorable information include whether the information is up to date (e.g., current data is weighted more favorably), whether the information reflects positively of a topic (e.g., a positive rating about an antivirus software), whether the information is consistent (e.g., the same or similar from multiple sources), whether the information is thorough (e.g., the information explains a matter completely and/or includes more than one piece of information relevant to the data point), whether the information is cited by other information, whether the information is based on opinion and/or speculation, and/or whether the information is based on facts and/or research. Factors contributing to whether a data source is reputable include whether the source is up to date, whether the source is well known, whether the source is recommended and/or cited by other sources, whether the types of information provided by the source are opinion-based or fact-based, and/or whether the source filters, monitors, and/or researches information prior to or while sharing the information.

The proficiency data trustworthiness module analyzes whether the data points of a dataset are clustered around an analysis level or spread out around multiple analysis levels to determine whether the data set is trustworthy. For example, the data points of dataset #1 are clustered around a higher favorability analysis level, the data points of dataset #2 are clustered around a lower unfavourability analysis level, and the data points of dataset #3 are spread out from a higher favorability analysis level to a lower unfavourability analysis level. Because datasets #1 and #2 are clustered around an analysis level, datasets #1 and #2 are considered trustworthy. Because dataset #3 is not clustered around an analysis level, the dataset #3 is not considered trustworthy.

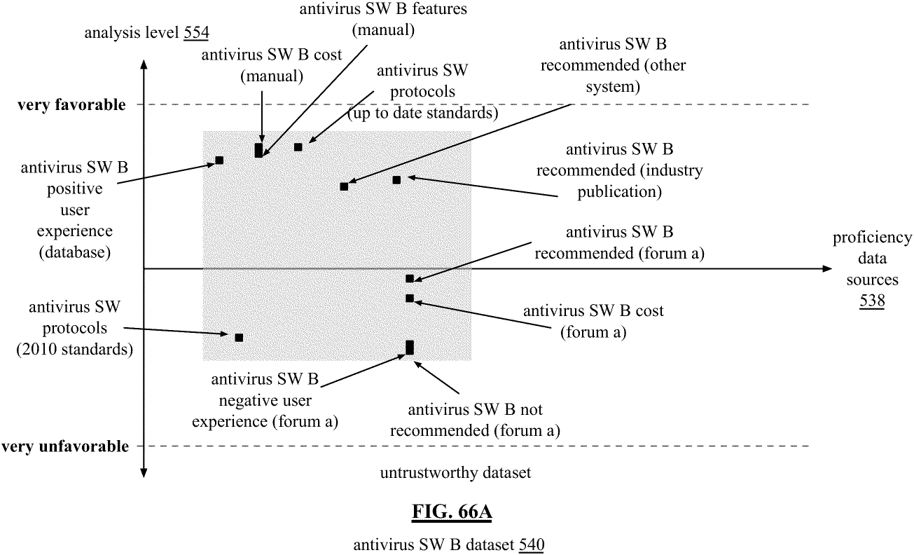

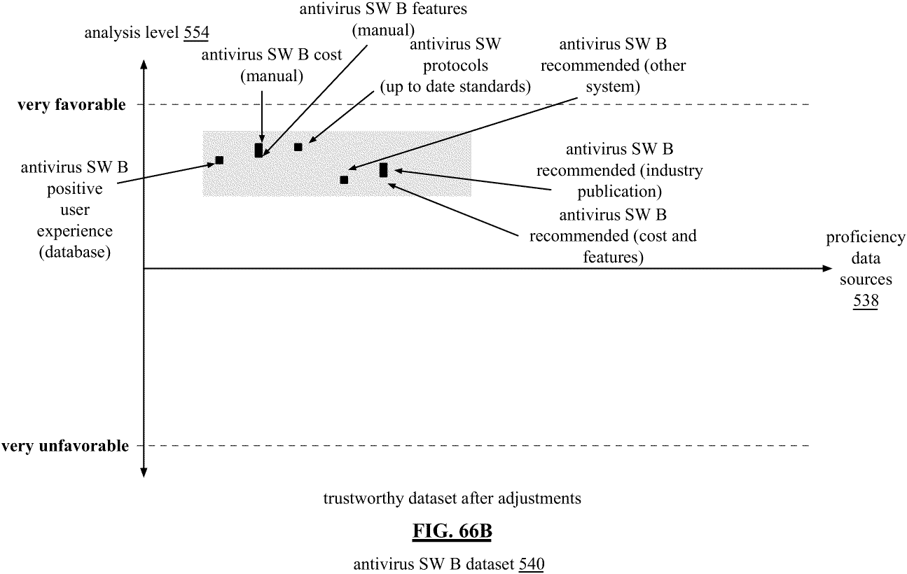

FIGS. 66A-66B are diagrams of an example of adjusting an untrustworthy data set. In FIG. 66A, the proficiency data trustworthiness module plots each data point of an antivirus software (SW) B dataset 540 based on an analysis level of a range of analysis levels for each data point of a dataset and proficiency data sources 538. In this example, the proficiency data sources 538 include an antivirus software B manual, up to date standards regarding antivirus software B, another system using antivirus software B, an industry publication mentioning antivirus software B, a forum “a” discussing antivirus software B, the analysis system database, and 2010 standards regarding antivirus software B.

From the antivirus software B manual, data points regarding antivirus software B cost and features are plotted near the favorable analysis level. These data points are plotted near the favorable analysis level because the information is favorable and the source is reputable. The information is favorable and the source is reputable because the information and source are up to date, the information is thorough, the information is based on facts, and the source is well known.

From the up to date standards, a datapoint regarding antivirus software B protocols is plotted near the favorable analysis level. This data point is plotted near the favorable analysis level because the information is favorable and the source is reputable. The information is favorable and the source is reputable because the information and source are up to date, the information is thorough, the information is based on facts, the source is well known, and the source is recommended and/or cited by other sources.

From another system using antivirus software B, a datapoint regarding the opinion that the antivirus software B is recommended is plotted near a lower favorable analysis level. This data point is plotted near the lower favorable analysis level because the information is somewhat favorable and the source is somewhat reputable. The information is somewhat favorable and the source is somewhat reputable because the information is positive regarding antivirus software B, the information is based on opinions, information is not based on facts and/or research, and the source is well known.

From the analysis system database, a datapoint regarding a positive user experience with the antivirus software B is plotted near a favorable analysis level. This data point is plotted near the favorable analysis level because the information is somewhat favorable and the source is reputable. The information is somewhat favorable and the source is reputable because the information is positive regarding antivirus software B, the information is based on opinions, information is not based on facts and/or research, the source is well known (e.g., a special weighting factor may be given to the analysis system’s own data), and/or the source filters, monitors, and the source researches information prior to or while sharing the information.

From the industry publication, a datapoint regarding the opinion that the antivirus software B is recommended is plotted near a favorable analysis level. This data point is plotted near the favorable analysis level because the information is somewhat favorable and the source is reputable. The information is somewhat favorable and the source is reputable because the information is positive regarding antivirus software B, the information is based on opinions, information is not based on facts and/or research, the source is well known, and the source filters, monitors, and/or researches information prior to or while sharing the information.

From the 2010 standards, a datapoint regarding antivirus software B protocols is plotted near the unfavorable analysis level. This data point is plotted near the unfavorable analysis level because the information is unfavorable and the source is not reputable. The information is unfavorable and the source is not reputable because the information and source are not up to date.

From the forum “a”, data points regarding a negative user experience and an opinion that the antivirus software B is not recommended are plotted near the unfavorable analysis level. These data points are plotted near the unfavorable analysis level because the information is unfavorable and the source is not reputable. The information is unfavorable and the source is not reputable because the information and source are opinion based, data from the source is inconsistent, data from the source is unfiltered and unresearched, and the information reflects negatively on the antivirus software B.

From the forum “a”, datapoints regarding an opinion that the antivirus software B is recommended and the cost of the antivirus software B are plotted near at an unfavorable analysis level closer to the neutral analysis level. These data points are plotted at the unfavorable analysis level closer to the neutral analysis level because the information is somewhat unfavorable and the source is not reputable. The information is somewhat unfavorable and the source is not reputable because the information and source are opinion based, data from the source is inconsistent, data from the source is unfiltered and unresearched, and the information reflects somewhat positively or neutral on the antivirus software B.

The proficiency data trustworthiness module analyzes whether the data points of the dataset are clustered around an analysis level or spread out around multiple analysis levels to determine whether the data set is trustworthy. Because the antivirus software B dataset 540 is not clustered around an analysis level, the antivirus software B dataset 540 is not considered trustworthy.

In FIG. 66B, the proficiency data trustworthiness module communicates with the proficiency data retrieval parameter module to adjust the source parameters. In this example, forum “a” is deleted from the source parameters and more information regarding the cost and features of the antivirus software B is requested from the industry publication. When the proficiency data retrieval parameters are updated, the proficiency data extraction module 356 obtains new information according to the updated proficiency data retrieval parameters. In another example, when the data set includes obvious outliers (e.g., the forum “a” data), the data points may be deleted to render the data set trustworthy.

Based on the new information according to the updated proficiency data retrieval parameters, the proficiency data trustworthiness module analyzes the antivirus software B dataset 540 plots the new data points and determines whether the data points are clustered around an analysis level.

From the industry publication, a datapoint regarding the cost and features of the antivirus software B is plotted near a favorable analysis level. This data point is plotted near the favorable analysis level because the information is somewhat favorable and the source is reputable. The information is somewhat favorable and the source is reputable because the information is neutral regarding antivirus software B, the information is based on facts, the source is well known, and the source filters, monitors, and/or researches information prior to or while sharing the information.

Because the antivirus software B dataset 540 is now clustered around an analysis level, the antivirus software B dataset 540 is considered trustworthy. The desired data can then be generated from this proficiency data and outputted.

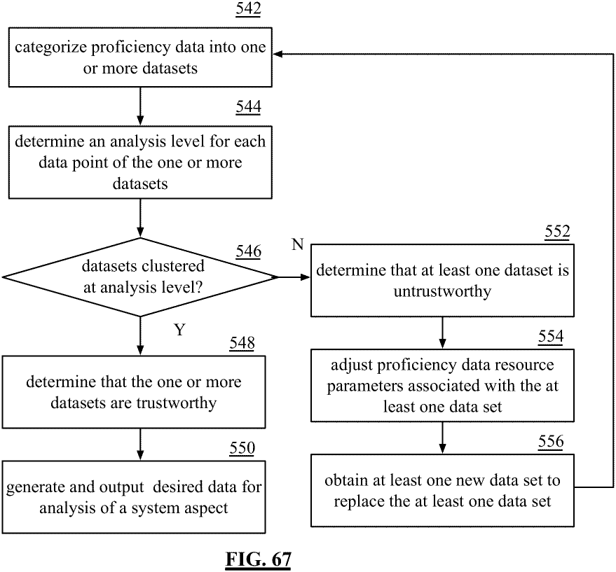

FIG. 67 is a flowchart of an example of a method of determining trustworthiness of proficiency data for a desired data evaluation. The method begins with step 542 where a proficiency data trustworthiness module of a proficiency data evaluation module of a desired data generation module categorizes gathered proficiency data into datasets. A dataset is a group of data points that have at least one common characteristic with one another. For example, the gathered proficiency data may be categorized according to a particular subject matter.

The method continues with step 544 where the proficiency data trustworthiness module determines an analysis level of a range of analysis levels for each data point of a dataset. The range of analysis levels go from a very favorable level to a very unfavorable level with a median of neutral. An analysis level includes a data favorability level weighted by a source reputability level. For example, a very favorable analysis level means the datapoint reflects very favorable information and is from a reputable source.

Factors contributing to whether the datapoint reflects favorable information include whether the information is up to date (e.g., current data is weighted more favorably), whether the information reflects positively of a topic (e.g., a positive rating about an antivirus software), whether the information is consistent (e.g., the same or similar from multiple sources), whether the information is thorough (e.g., the information explains a matter completely and/or includes more than one piece of information relevant to the data point), whether the information is cited by other information, whether the information is based on opinion and/or speculation, and/or whether the information is based on facts and/or research.

Factors contributing to whether a data source is reputable include whether the source is up to date, whether the source is well known, whether the source is recommended and/or cited by other sources, whether the types of information provided by the source are opinion-based or fact-based, and/or whether the source filters, monitors, and/or researches information prior to or while sharing the information.

The method continues with step 546 where the proficiency data trustworthiness module analyzes whether the data points of a dataset are clustered around an analysis level or spread out around multiple analysis levels. For example, if one data point of a data set has favorable information from a reputable source, another data point of the data set has unfavorable information from a reputable source, and another data point of the data set has favorable information from a source that is not reputable, the data set may be considered untrustworthy due to the lack of consistency of the data.

When the proficiency data trustworthiness module determines that the data points of a dataset are clustered around an analysis level, the method continues with step 548 where the gathered proficiency data is considered trustworthy. The method continues with step 550 where the desired data 352 is generated from the proficiency data 364 and outputted.

When the proficiency data trustworthiness module determines that the data points of a dataset are not clustered around an analysis level, the method continues with step 552 where the gathered proficiency data is considered untrustworthy. The method continues with step 554 where the proficiency data trustworthiness module communicates with the proficiency data retrieval parameter module to adjust the source parameters. For example, additional reputable source identifiers may be added to the source parameters and the source(s) that is not reputable may be removed.

When the proficiency data retrieval parameters are updated, the method continues with step 556 where the proficiency data trustworthiness module obtains new information according to the updated proficiency data retrieval parameters. In another example, when the data set includes obvious outliers (e.g., one data point is way off from the others), the data point may be deleted to render the dataset trustworthy. When the proficiency data trustworthiness module obtains new information according to the updated proficiency data retrieval parameters the method branches back to step 542 where the proficiency data trustworthiness module repeats the steps to determine the trustworthiness of the new data.

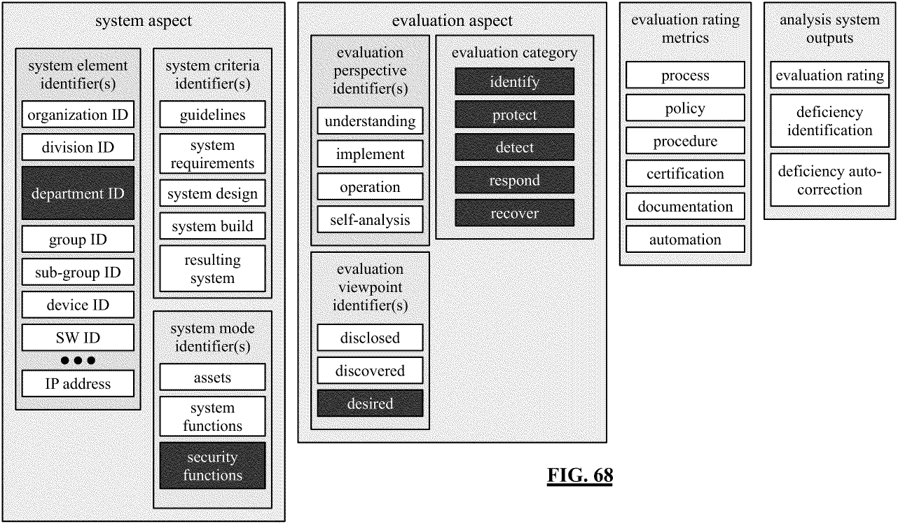

FIG. 68 is a diagram of an example of system aspect, evaluation aspect, evaluation rating metric, and analysis system output options of an analysis system for analyzing a system, or portion thereof. The diagram of FIG. 68 is similar to the diagram of FIGS. 33 and 37 and depicts a specific example of data gathering parameters for an evaluation.

The system aspect corresponds to what part of the system is to be evaluated by the analysis system. The evaluation aspect indicates how the system aspect is to be evaluated. The evaluation rating metric indicates the manner of evaluation of the system aspect in accordance with the evaluation aspect. The analysis system output indicates the type of output to be produced by the analysis system based on the evaluation of the system aspect in accordance with the evaluation aspect as per the evaluation rating metric.

The system aspect includes system elements, system criteria, and system modes. A system element is one or more physical assets and/or a conceptual assets. For example, a physical asset is a computing entity, a computing device, a user software application, a system software application (e.g., operating system, etc.), a software tool, a network software application, a security software application, a system monitoring software application, and the like. As another example, a conceptual asset is a hardware architecture (e.g., identification of a system’s physical components, their capabilities, and their relationship to each other) and/or sub-architectures thereof and a software architecture (e.g., fundamental structures for the system’s software, their requirements, and inter-relational operations) and sub-architectures thereof.

A system element is identifiable in a variety of ways. For example, it can be identified by an organization identifier (ID), which would be associated with most, if not all, system elements of a system. As another example, a system element can be identified by a division ID, where the division is one of a plurality of divisions in the organization. As another example, a system element can be identified by a department ID, where the department is one of a plurality of departments in a division. As yet another example, a system element can be identified by a department ID, where the department is one of a plurality of departments in a division. As a further example, a system element can be identified by a group ID, where the department is one of a plurality of groups in a department. As a still further example, a system element can be identified by a sub-group ID, where the department is one of a plurality of sub-groups in a group. With this type of identifier, a collection of system elements can be selected for evaluation by using an organization ID, a division ID, a department ID, a group ID, or a sub-group ID.

A system element may also be identified based on a user ID, a serial number, vendor data, an IP address, etc. For example, a computing device has a serial number and vendor data. As such, the computing device can be identified for evaluation by its serial number and/or the vendor data. As another example, a software application has a serial number and vendor data. As such, the software application can be identified for evaluation by its serial number and/or the vendor data.

In addition, an identifier of one system element may link to one or more other system elements. For example, computing device has a device ID, a user ID, and/or a serial number to identify it. The computing device also includes a plurality of software applications, each with its own serial number. In this example, the software identifiers are linked to the computing device identifier since the software is loaded on the computing device. This type of an identifier allows a single system element to be identified for evaluation.

In this example, the system element of the system aspect includes all the physical and conceptual assets of a particular department (e.g., a finance department) and is identifiable by a department identifier (ID).

The system criteria include information regarding the development, operation, and/or maintenance of the system 11. For example, a system criterion is a guideline, a system requirement, a system design component, a system build component, the system, and system operation. In this example, the system criteria are not evaluated.

The system mode indicates the assets of the system, the system functions of the system, and/or the security functions of the system are to be evaluated. In this example, the system mode is all security functions of a particular system element.

The evaluation aspect, which indicates how the system aspect is to be evaluated, includes evaluation perspective, evaluation viewpoint, and evaluation category. The evaluation perspective includes understanding (e.g., how well the system is known, should be known, etc.); implementation, which includes design and/or build, (e.g., how well is the system designed, how well should it be designed); system performance, and/or system operation (e.g., how well does the system perform and/or operate, how well should it perform and/or operate); and self-analysis (e.g., how self-aware is the system, how self-healing is the system, how self-updating is the system). In this example, the evaluation perspective is not considered.

The evaluation viewpoint includes disclosed data, discovered data, and desired data. Disclosed data is the known data of the system at the outset of an analysis, which is typically supplied by a system administrator and/or is obtained from data files of the system. In this example, the evaluation viewpoint is desired data. In this example, the desired data is the data obtained by the analysis system from system proficiency resources regarding system operation. Differences in disclosed, discovered, and desired data are evaluated to support generating an evaluation rating, to identify deficiencies, and/or to determine and provide auto-corrections.

The evaluation category includes an identify category, a protect category, a detect category, a respond category, and a recover category. In general, the identify category is regarding identifying assets, system functions, and/or security functions of the system; the protect category is regarding protecting assets, system functions, and/or security functions of the system from issues that may adversely affect; the detect category is regarding detecting issues that may, or have, adversely affect assets, system functions, and/or security functions of the system; the respond category is regarding responding to issues that may, or have, adversely affect assets, system functions, and/or security functions of the system; and the recover category is regarding recovering from issues that have adversely affect assets, system functions, and/or security functions of the system. Each category includes one or more sub-categories and each sub-category may include one or more sub-sub categories. In this example, all evaluation categories are considered.

The evaluation rating metric includes process, policy, procedure, certification, documentation, and automation. The evaluation rating metric may include more or less topics. The analysis system output options include evaluation rating, deficiency identification, and deficiency auto-correction. In this example, the evaluation rating metrics and the analysis output are not considered.

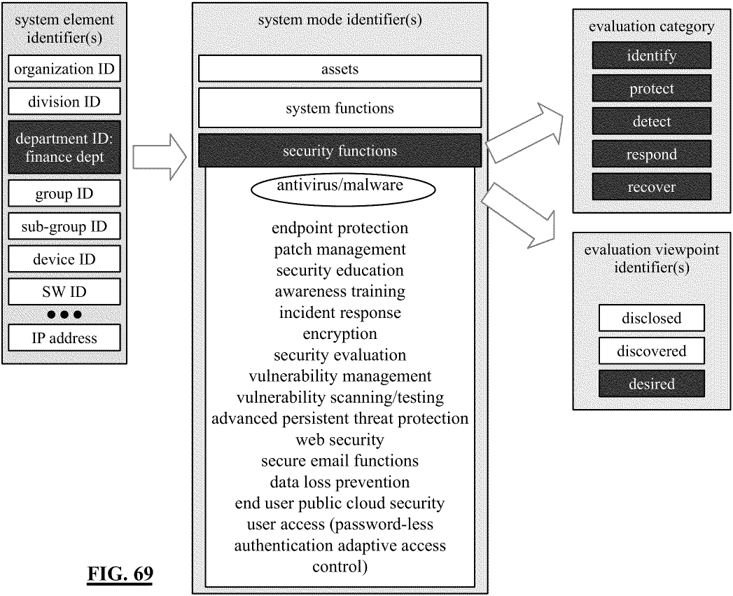

FIG. 69 is a diagram of system elements, system modes, evaluation categories, and evaluation viewpoints for an evaluation. FIG. 69 is similar to FIG. 68 except is shows security functions in more detail. Within the system mode identifiers, the security functions include antivirus/malware, endpoint protection, patch management, security education, awareness training, incident response, encryption, security evaluation, vulnerability management, vulnerability scanning/testing, advanced persistent threat protection, web security, secure email functions, data loss prevention, end user public cloud security, and user access (e.g., password-lass authentication adaptive access control). Other security functions are possible.

For this particular evaluation, a system element of finance department is selected and a security function of antivirus/malware is selected. All of the evaluation categories are selected for the evaluation. The evaluation viewpoint is a desired viewpoint such that desired data is generated for the evaluation.

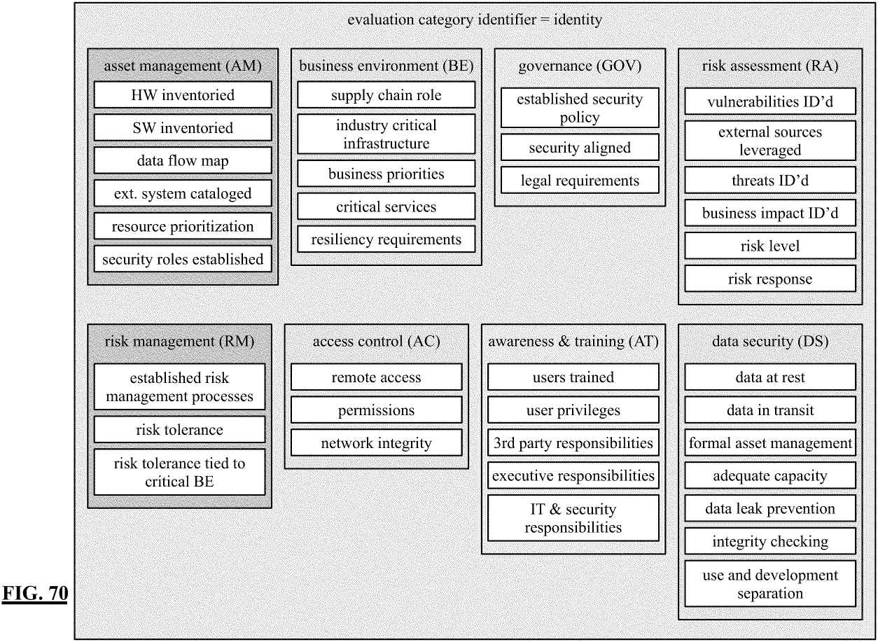

FIG. 70 is a diagram of an example of an identify evaluation category that includes a plurality of sub-categories and each sub-category includes its own plurality of sub-sub-categories. The identify category includes the sub-categories of asset management, business environment, governance, risk management, access control, awareness & training, and data security.

The asset management sub-category includes the sub-sub categories of HW inventoried, SW inventoried, data flow mapped out, external systems cataloged, resources have been prioritized, and security roles have been established. The business environment sub-category includes the sub-sub categories of supply chain roles defined, industry critical infrastructure identified, business priorities established, critical services identified, and resiliency requirements identified.

The governance sub-category includes the sub-sub categories of security policies are established, security factors aligned, and legal requirements are identified. The risk assessment sub-category includes the sub-sub categories of vulnerabilities identified, external sources are leveraged, threats are identified, business impacts are identified, risk levels are identified, and risk responses are identified. The risk management sub-category includes the sub-sub categories of risk management processes are established, risk tolerances are established, and risk tolerances are tied to business environment.

The access control sub-category includes the sub-sub categories of remote access control is defined, permissions are defined, and network integrity is defined. The awareness & training sub-category includes the sub-sub categories of users are trained, user privileges are known, third party responsibilities are known, executive responsibilities are known, and IT and security responsibilities are known. The data security sub-category includes the sub-sub categories of data at rest protocols are established, data in transit protocols are established, formal asset management protocols are established, adequate capacity of the system is established, data leak prevention protocols are established, integrity checking protocols are established, and use and development separation protocols are established.

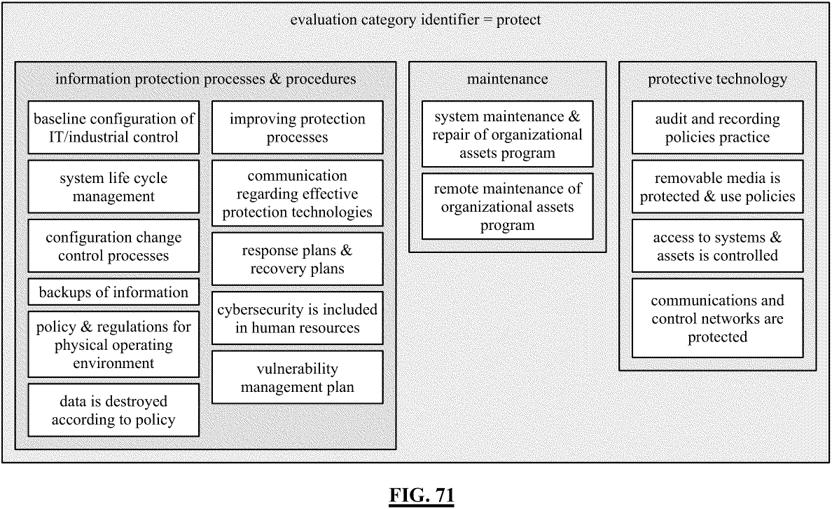

FIG. 71 is a diagram of an example of a protect evaluation category that includes a plurality of sub-categories and each sub-category includes its own plurality of sub-sub-categories. The protect category includes the sub-categories of information protection processes and procedures, maintenance, and protective technology.

The information protection processes and procedures sub-category includes the sub-sub categories of baseline configuration of IT/industrial controls are established, system life cycle management is established, configuration control processes are established, backups of information are implemented, policy & regulations for physical operation environment are established, improving protection processes are established, communication regarding effective protection technologies is embraced, response and recovery plans are established, cybersecurity in is including in human resources, and vulnerability management plans are established.

The maintenance sub-category includes the sub-sub categories of system maintenance & repair of organizational assets programs are established and remote maintenance of organizational assets is established. The protective technology sub-category includes the sub-sub-categories of audit and recording policies are practiced, removable media is protected & use policies are established, access to systems and assets is controlled, and communications and control networks are protected.

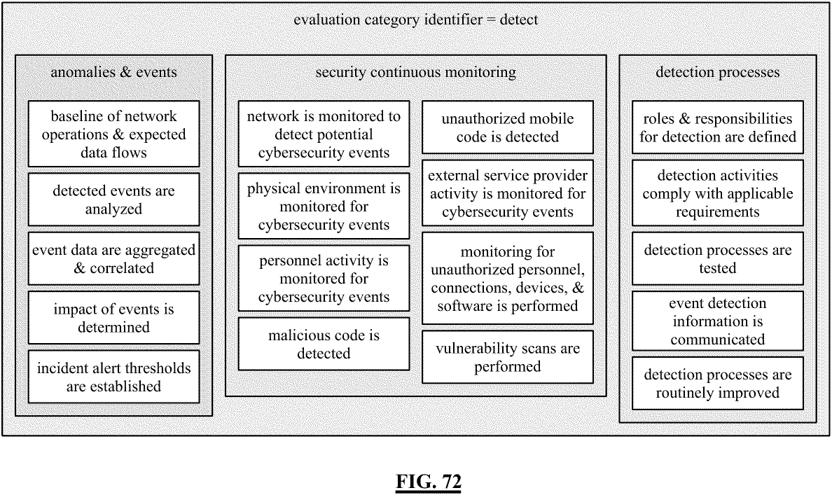

FIG. 72 is a diagram of an example of a detect evaluation category that includes a plurality of sub-categories and each sub-category includes its own plurality of sub-sub-categories. The detect category includes the sub-categories of anomalies and events, security continuous monitoring, and detection processes.

The anomalies and events sub-category includes the sub-sub categories of baseline of network operations and expected data flows are monitored, detected events are analyzed, event data are aggregated and correlated, impact of events is determined, and incident alert thresholds are established. The security continuous monitoring sub-category includes the sub-sub categories of network is monitored to detect potential cybersecurity attacks, physical environment is monitored for cybersecurity events, personnel activity is monitored for cybersecurity events, malicious code is detected, unauthorized mobile codes is detected, external service provider activity is monitored for cybersecurity events, monitoring for unauthorized personnel, connections, devices, and software is performed, and vulnerability scans are performed. The detection processes sub-category includes the sub-sub categories of roles and responsibilities for detection are defined, detection activities comply with applicable requirements, detection processes are tested, event detection information is communicated, and detection processes are routinely improved.

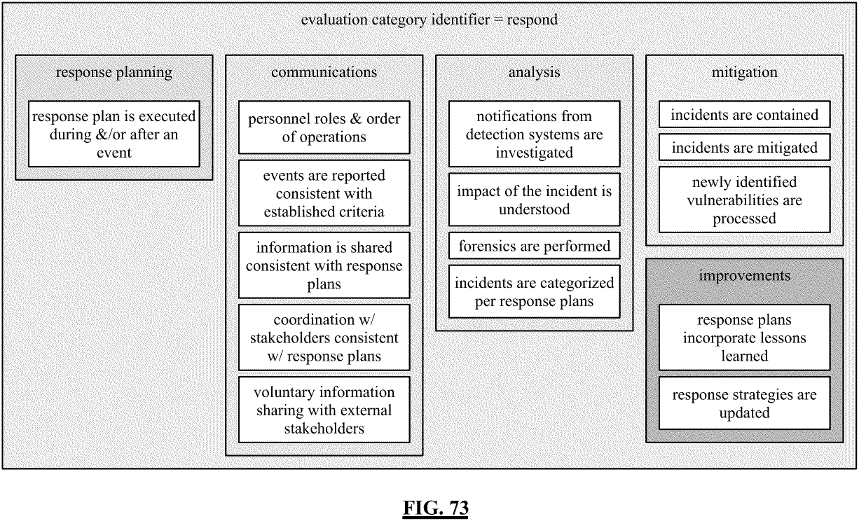

FIG. 73 is a diagram of an example of a respond evaluation category that includes a plurality of sub-categories and each sub-category includes its own plurality of sub-sub-categories. The respond category includes the sub-categories of response planning, communications, analysis, mitigation, and improvements.

The response planning sub-category includes the sub-sub category of response plan is executed during and/or after an event. The communications sub-category includes the sub-sub category of personnel roles and order of operation are established, events are reported consistent with established criteria, information is shared consistently per the response plan, coordination with stakeholders is consistent with the response plan, and voluntary information is shared with external stakeholders.

The analysis sub-category includes the sub-sub categories of notifications form detection systems are investigated, impact of the incident is understood, forensics are performed, and incidents are categorized per response plan. The mitigation sub-category includes the sub-sub categories of incidents are contained, incidents are mitigated, and newly identified vulnerabilities are processed. The improvements sub-categories includes the sub-sub categories of response plans incorporate lessons learned, and response strategies are updated.

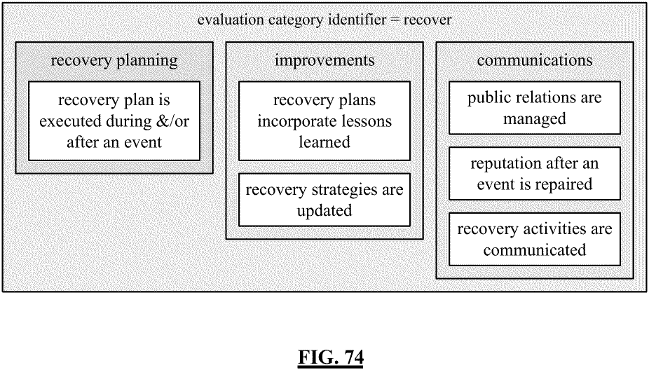

FIG. 74 is a diagram of an example of a recover evaluation category that includes a plurality of sub-categories and each sub-category includes its own plurality of sub-sub-categories. The recover category includes the sub-categories of recovery plan, improvements, and communication. The recovery plan sub-category includes the sub-sub category of recovery plan is executed during and/or after an event.

The improvement sub-category includes the sub-sub categories of recovery plans incorporate lessons learned and recovery strategies are updated. The communications sub-category includes the sub-sub categories of public relations are managed, reputations after an event is repaired, and recovery activities are communicated.

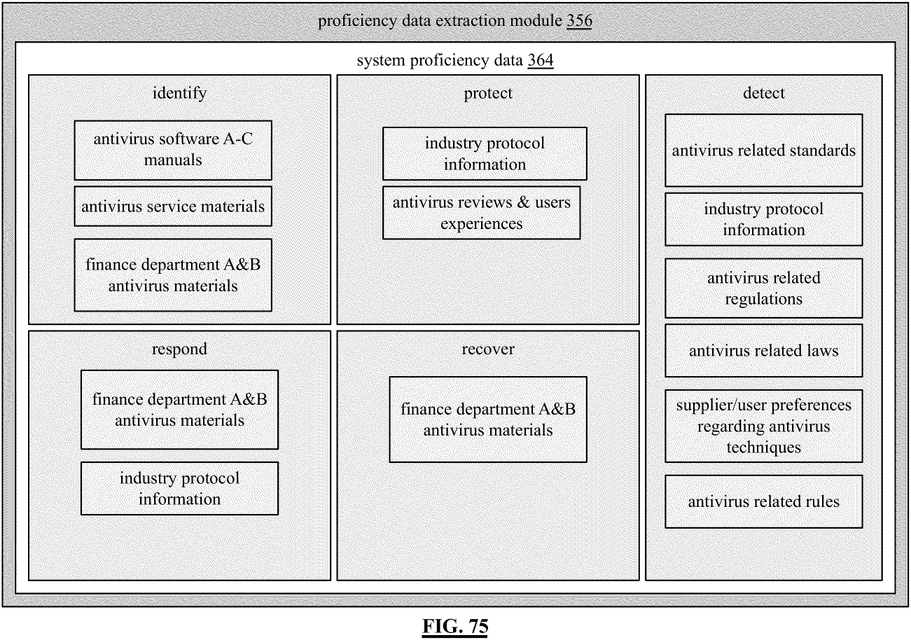

FIG. 75 is a diagram of an example of extracting system proficiency data 356. Using the example of FIGS. 68-69, after the proficiency data retrieval parameters are generated by the proficiency data retrieval parameter module, the proficiency data extraction module 356 uses the proficiency data retrieval parameters 360 to gather system proficiency data 364 from identified data sources in accordance with the set of evaluation categories. FIG. 75 depicts example proficiency data 364 extracted from the identified data sources.

For example, with respect to the identify evaluation category, the proficiency data extraction module 356 extracts antivirus software A-C manuals and antivirus service materials from identified antivirus product and service supplier sources (e.g., supplier websites, supplier resources, stored data, etc.). With respect to the identify, respond, and recover evaluation categories, the proficiency data extraction module 356 extracts finance department A and B antivirus materials and/or information from a system A and B’s finance departments.

With respect to the protect, respond, and detect evaluation categories, the proficiency data extraction module 356 extracts industry protocol information from one or more industry publications and/or other industry resources.

With respect to the protect and detect evaluation categories, the proficiency data extraction module 356 extracts antivirus reviews and/or user/supplier experiences from antivirus related forums and stored data. With respect to the detect evaluation category, the proficiency data extraction module 356 extracts antivirus related laws, regulations, rules, recommendations, and standards from government bodies and standards bodies.

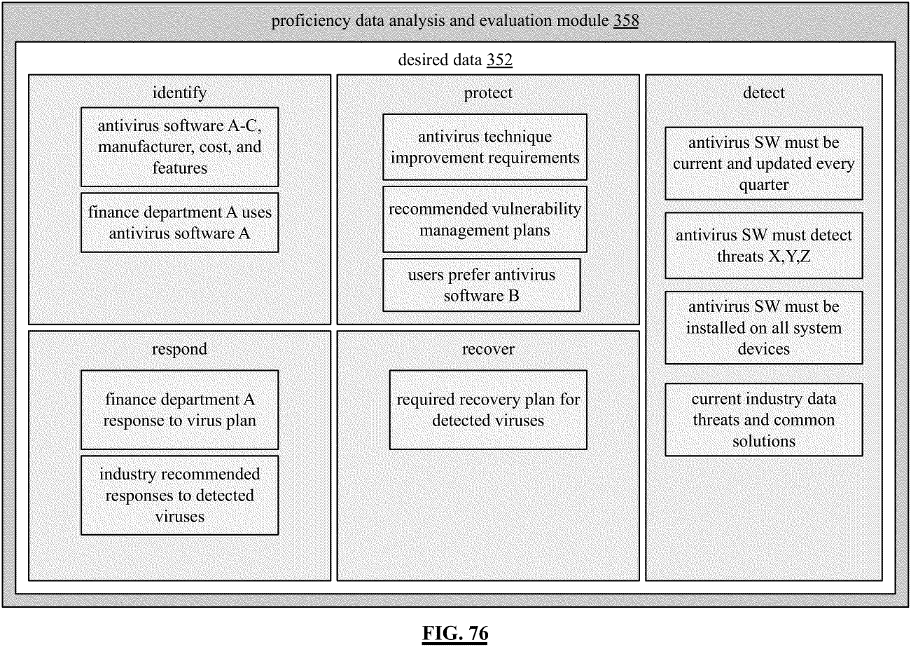

FIG. 76 is a diagram of an example of generating desired data 352 for an evaluation. Using the example of FIGS. 68-69 and continuing the example of FIG. 75, after the proficiency data extraction module uses the proficiency data retrieval parameters to gather system proficiency data from identified data sources, the proficiency data analysis and evaluation module 358 generates desired data 352 based on the gathered system proficiency data 364. FIG. 76 depicts example desired data 352 generated from gathered system proficiency data.

For example, with respect to the identify category, the proficiency data analysis and evaluation module 358 analyzes the antivirus software A-C manuals to determine antivirus software A-C and antivirus service manufacturer information, cost, and features. The proficiency data analysis and evaluation module 358 also analyzes the finance department A and B antivirus materials and/or information to determine that finance department A prefers to use antivirus software A.

With respect to the protect evaluation category, the proficiency data analysis and evaluation module 358 analyzes the industry protocol information to determine antivirus technique improvement requirements and recommended vulnerability management plans. The proficiency data analysis and evaluation module 358 analyzes antivirus reviews and user experiences to determine that users prefer antivirus software B for its protection related features.

With respect to the detect evaluation category, the proficiency data analysis and evaluation module 358 analyzes the antivirus related laws, regulations, rules, recommendations to determine that antivirus software must be current and updated every quarter, that antivirus software must detect threats X, Y, and Z, and that antivirus software must be installed on all system devices. The proficiency data analysis and evaluation module 358 further analyzes the industry protocol information to determine current industry data threats and common solutions.

With respect to the respond evaluation category, the proficiency data analysis and evaluation module 358 analyzes the finance department A antivirus materials and/or information to determine finance department A’s antivirus response to virus plan. The proficiency data analysis and evaluation module 358 further analyzes the industry protocol information to determine industry recommended responses to detected viruses.

With respect to the recover evaluation category, the proficiency data analysis and evaluation module 358 analyzes the finance department A and B antivirus materials and/or information to determine required recovery plans for detected viruses.

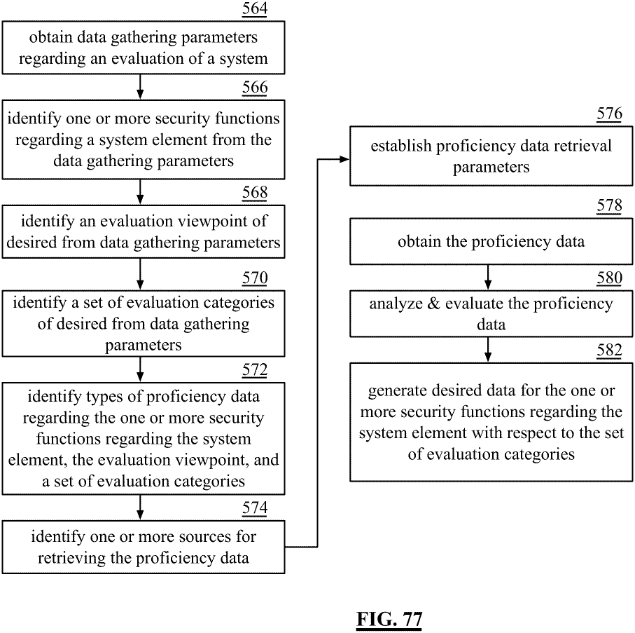

FIG. 77 is a logic diagram of an example of a method of generating desired data for an evaluation of one or more security functions of a system element with respect to a set of evaluation categories. The method begins with step 564 where a data input module of an analysis system obtains data gathering parameters regarding an evaluation of a system. The method continues with step 566 where the data input module identifies a system mode of one or more security functions and at least one system element of the system from the data gathering parameters. The data input module may also identify at least one system criteria of the system for the evaluation.

The at least one system element includes an enterprise identifier, an organization identifier, a division identifier, a department identifier, a group identifier, a sub-group identifier, a device identifier, a software identifier, or an internet protocol address identifier. A system mode of the at least one system mode includes assets, system functions, or system security. System criteria of the at least one system criteria include system guidelines, system requirements, system design, system build, or resulting system.

As an example, the data gathering parameters indicate a system mode of system security functions related to antivirus and/or malware techniques and a system element of a finance department. As such, the data gathered should be relevant to antivirus and/or malware techniques of a financial department.

The method continues with step 568 where the data input module identifies an evaluation viewpoint of desired of a set of evaluation viewpoints for the system element and at least one security function from the data gathering parameters. The set of evaluation viewpoints include a disclosed viewpoint, a discovered viewpoint, and the desired viewpoint. When the data gathering parameters include the desired viewpoint, the desired data generation module of the data input module is triggered to determine, collect, and generate desired data for the evaluation. Using the example above, the data gathered should be relevant to desired, best-in-class antivirus and/or malware techniques of a financial department.

The method continues with step 570 where the data input module identifies a set of evaluation categories for the system element and at least one security function from the data gathering parameters. The set of evaluation categories includes an identify category, a protect category, a detect category, a respond category, and a recover category. As discussed with reference to FIGS. 70-74, each evaluation category includes a plurality of sub-categories and, at least some of the sub-categories include their own sub-categories (e.g., a sub-sub category). For example, the identify category includes the sub-categories of asset management, business environment, governance, risk assessment, risk management, access control, awareness & training, and data security. As a further example, asset management includes the sub-categories of hardware inventory, software inventory, data flow maps, external system cataloged, resource prioritization, and security roles. The analysis system can evaluate the one or more security functions of the system element in light of one more evaluation categories, in light of an evaluation category and one or more sub-categories, or in light of an evaluation category, a sub-category, and one or more sub-sub-categories.

The method continues with step 572 where the desired data generation module identifies one or more types of proficiency data regarding the system element, the at least one security function, the desired evaluation viewpoint, and with respect to the set of evaluation categories. The one or more types of proficiency data include products, services, requirements, standards, regulations, and/or protocols related to the system aspect. The requirements, standards, regulations, and/or protocols may be laws set by a government, rules provided by a standards body, and/or industry-based protocols (e.g., what is commonly done in a particular industry).

The method continues with step 574 where the desired data generation module identifies one or more sources for retrieving the proficiency data to produce source identification parameters. For example, to gather the products, services, requirements, standards, regulations, and/or protocols, the desired data generation module identifies source identifiers for sources such as product/service providers, forums, other systems, legal materials (e.g., written laws), standards body materials, industry publications, etc.

The method continues with step 576 where the desired data generation module establishes proficiency data retrieval parameters based on the one or more types of proficiency data and the source identification parameters. The proficiency data retrieval parameters instruct the desired data generation module to the relevant identified sources to gather the relevant identified information.

The method continues with step 578 where the desired data generation module obtains the proficiency data from the identified one or more sources based on the proficiency data retrieval parameters. The method continues with step 580 where the desired data generation module analyzes and evaluates the proficiency data. The desired data generation module analyzes the gathered proficiency data to identify relevant characteristics (e.g., features, functions, cost, performance, reviews, experiences, evaluations, etc.) of the gathered proficiency data as the desired data. The desired data generation module may also evaluate the gathered proficiency data to determine the trustworthiness of the gathered proficiency data. For example, the desired data generation module analyzes the gathered data to determine whether the data sources and the resulting data can be trusted based on an analysis level of the data source and the data.

The method continues with step 582 where the desired data for the one or more security functions regarding the system element with respect to the set of evaluation categories is generated from the proficiency data.

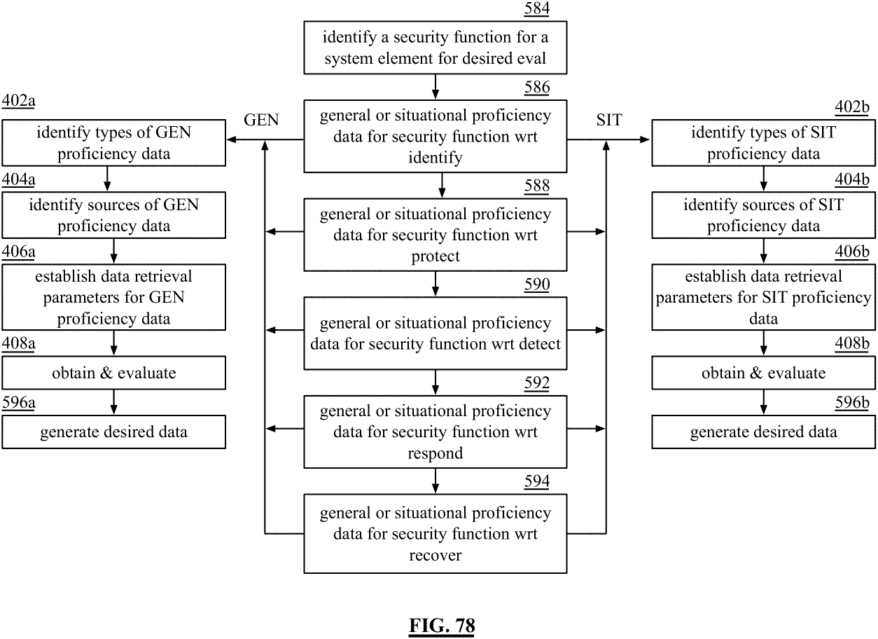

FIG. 78 is a logic diagram of an example of a method of generating desired data for an evaluation of one or more security functions of a system element with respect to a set of evaluation categories. The method of FIG. 78 is similar to the method of FIG. 77 except that either situational or general proficiency data is gathered for each evaluation category to generate the desired data. The method begins with step 584 where a data input module of an analysis system identifies a security solution for a system element for a desired evaluation viewpoint and a set of evaluation categories from data gathering parameters.

As an example, the data gathering parameters indicate a security function of antivirus and/or malware functions security, a system element of a finance department, and a set of evaluation categories including identify, protect, detect, respond, and recover. A system criteria such as a resulting system may also be considered. As such, the data gathered should be relevant to antivirus and/or malware techniques of a financial department with respect to the identify, protect, detect, respond, and recover categories. When the data gathering parameters include the desired viewpoint, the desired data generation module of the data input module is triggered to determine, collect, and generate desired data for the evaluation. Using the example above, the data gathered should be relevant to desired, best-in-class antivirus techniques of a financial department with respect to identify, protect, detect, respond, and recover.

The method continues with step 586 where the desired data generation module determines whether to gather situational (SIT) system proficiency data or general (GEN) system proficiency data for the security function with respect to the identify evaluation category. General system proficiency data is data that applies to most other system elements similar to the system element being evaluated. Situational system proficiency data is data that is more specific to the system element that is being evaluated. For example, if the system element that is being evaluated is unlike most other system aspects (e.g., in size, goals, etc.), situational system proficiency data may need to be gathered.

In order to determine whether the system proficiency data should be situational or general, the desired data generation module compares system characteristics of the system element (e.g., a list of system elements, asset information, system size (based on personnel, based on data, etc.), cost/budget, sensitivity/types of data, risk preferences, etc.) with a normalized model for the system element. When the system characteristics meet a threshold, the method continues with steps 402a-408a of FIG. 42 and 596a where general proficiency data can be used to generate the desired data and when the system characteristics do not meet a threshold, the method continues with steps 402b-408b of FIG. 42 and 596b where situational proficiency data can be used to generate the desired data. Generating the normalized model and comparing the system characteristics with the normalized model is discussed in greater detail with reference to FIGS. 43-52.

At step 402a the desired data generation module identifies one or more types of general proficiency data regarding the security function of the system element with respect to an evaluation category and the desired evaluation viewpoint. At step 402b, the desired data generation module identifies one or more types of situational proficiency data regarding the security function of the system element with respect to an evaluation category and the desired evaluation viewpoint. The one or more types of proficiency data include products, services, requirements, standards, regulations, and/or protocols related to the system aspect. The requirements, standards, regulations, and/or protocols may be laws set by a government, rules provided by a standards body, and/or industry-based protocols (e.g., what is commonly done in a particular industry).

At step 404a, the desired data generation module identifies one or more sources for retrieving the general proficiency data to produce source identification parameters. At step 404b, the desired data generation module identifies one or more sources for retrieving the situational proficiency data to produce source identification parameters. For example, to gather the products, services, requirements, standards, regulations, and/or protocols, the desired data generation module identifies source identifiers for sources such as product/service providers, forums, other systems, legal materials (e.g., written laws), standards body materials, industry publications, etc.

At step 406a, the desired data generation module establishes proficiency data retrieval parameters for the general proficiency data based on the one or more types of proficiency data and the source identification parameters. At step 406b, the desired data generation module establishes proficiency data retrieval parameters for the situational proficiency data based on the one or more types of proficiency data and the source identification parameters. The proficiency data retrieval parameters instruct the desired data generation module to the relevant identified sources to gather the relevant identified information.

At step 408a, the desired data generation module obtains, analyzes, and evaluates the general proficiency data from the identified one or more sources based on the proficiency data retrieval parameters. At step 408b, the desired data generation module obtains, analyzes, and evaluates the situational proficiency data from the identified one or more sources based on the proficiency data retrieval parameters. The desired data generation module analyzes the gathered proficiency data to identify relevant characteristics (e.g., features, functions, cost, performance, reviews, experiences, evaluations, etc.) of the gathered proficiency data. At steps 596a and 596b, the desired data is generated from the proficiency data.

The method continues with step 588 where the desired data generation module determines whether to gather situational (SIT) system proficiency data or general (GEN) system proficiency data for the security function with respect to the protect evaluation category. When the system characteristics meet a threshold, the method continues with steps 402a-408a of FIG. 42 and 596a where general proficiency data can be used to generate the desired data and when the system characteristics do not meet a threshold, the method continues with steps 402b-408b of FIG. 42 and 596b where situational proficiency data can be used to generate the desired data.

The method continues with step 590 where the desired data generation module determines whether to gather situational (SIT) system proficiency data or general (GEN) system proficiency data for the security function with respect to the detect evaluation category. When the system characteristics meet a threshold, the method continues with steps 402a-408a of FIG. 42 and 596a where general proficiency data can be used to generate the desired data and when the system characteristics do not meet a threshold, the method continues with steps 402b-408b of FIG. 42 and 596b where situational proficiency data can be used to generate the desired data.

The method continues with step 590 where the desired data generation module determines whether to gather situational (SIT) system proficiency data or general (GEN) system proficiency data for the security function with respect to the respond evaluation category. When the system characteristics meet a threshold, the method continues with steps 402a-408a of FIG. 42 and 596a where general proficiency data can be used to generate the desired data and when the system characteristics do not meet a threshold, the method continues with steps 402b-408b of FIG. 42 and 596b where situational proficiency data can be used to generate the desired data.

The method continues with step 590 where the desired data generation module determines whether to gather situational (SIT) system proficiency data or general (GEN) system proficiency data for the security function with respect to the recover evaluation category. When the system characteristics meet a threshold, the method continues with steps 402a-408a of FIG. 42 and 596a where general proficiency data can be used to generate the desired data and when the system characteristics do not meet a threshold, the method continues with steps 402b-408b of FIG. 42 and 596b where situational proficiency data can be used to generate the desired data.

It is noted that terminologies as may be used herein such as bit stream, stream, signal sequence, etc. (or their equivalents) have been used interchangeably to describe digital information whose content corresponds to any of a number of desired types (e.g., data, video, speech, text, graphics, audio, etc. any of which may generally be referred to as ‘data’).

As may be used herein, the terms “substantially” and “approximately” provide an industry-accepted tolerance for its corresponding term and/or relativity between items. For some industries, an industry-accepted tolerance is less than one percent and, for other industries, the industry-accepted tolerance is 10 percent or more. Other examples of industry-accepted tolerance range from less than one percent to fifty percent. Industry-accepted tolerances correspond to, but are not limited to, component values, integrated circuit process variations, temperature variations, rise and fall times, thermal noise, dimensions, signaling errors, dropped packets, temperatures, pressures, material compositions, and/or performance metrics. Within an industry, tolerance variances of accepted tolerances may be more or less than a percentage level (e.g., dimension tolerance of less than +/- 1%). Some relativity between items may range from a difference of less than a percentage level to a few percent. Other relativity between items may range from a difference of a few percent to magnitude of differences.

As may also be used herein, the term(s) “configured to”, “operably coupled to”, “coupled to”, and/or “coupling” includes direct coupling between items and/or indirect coupling between items via an intervening item (e.g., an item includes, but is not limited to, a component, an element, a circuit, and/or a module) where, for an example of indirect coupling, the intervening item does not modify the information of a signal but may adjust its current level, voltage level, and/or power level. As may further be used herein, inferred coupling (i.e., where one element is coupled to another element by inference) includes direct and indirect coupling between two items in the same manner as “coupled to”.

As may even further be used herein, the term “configured to”, “operable to”, “coupled to”, or “operably coupled to” indicates that an item includes one or more of power connections, input(s), output(s), etc., to perform, when activated, one or more its corresponding functions and may further include inferred coupling to one or more other items. As may still further be used herein, the term “associated with”, includes direct and/or indirect coupling of separate items and/or one item being embedded within another item.

As may be used herein, the term “compares favorably”, indicates that a comparison between two or more items, signals, etc., provides a desired relationship. For example, when the desired relationship is that signal 1 has a greater magnitude than signal 2, a favorable comparison may be achieved when the magnitude of signal 1 is greater than that of signal 2 or when the magnitude of signal 2 is less than that of signal 1. As may be used herein, the term “compares unfavorably”, indicates that a comparison between two or more items, signals, etc., fails to provide the desired relationship.

As may be used herein, one or more claims may include, in a specific form of this generic form, the phrase “at least one of a, b, and c” or of this generic form “at least one of a, b, or c”, with more or less elements than “a”, “b”, and “c”. In either phrasing, the phrases are to be interpreted identically. In particular, “at least one of a, b, and c” is equivalent to “at least one of a, b, or c” and shall mean a, b, and/or c. As an example, it means: “a” only, “b” only, “c” only, “a” and “b”, “a” and “c”, “b” and “c”, and/or “a”, “b”, and “c”.

As may also be used herein, the terms “processing module”, “processing circuit”, “processor”, “processing circuitry”, and/or “processing unit” may be a single processing device or a plurality of processing devices. Such a processing device may be a microprocessor, microcontroller, digital signal processor, microcomputer, central processing unit, field programmable gate array, programmable logic device, state machine, logic circuitry, analog circuitry, digital circuitry, and/or any device that manipulates signals (analog and/or digital) based on hard coding of the circuitry and/or operational instructions. The processing module, module, processing circuit, processing circuitry, and/or processing unit may be, or further include, memory and/or an integrated memory element, which may be a single memory device, a plurality of memory devices, and/or embedded circuitry of another processing module, module, processing circuit, processing circuitry, and/or processing unit. Such a memory device may be a read-only memory, random access memory, volatile memory, non-volatile memory, static memory, dynamic memory, flash memory, cache memory, and/or any device that stores digital information. Note that if the processing module, module, processing circuit, processing circuitry, and/or processing unit includes more than one processing device, the processing devices may be centrally located (e.g., directly coupled together via a wired and/or wireless bus structure) or may be distributedly located (e.g., cloud computing via indirect coupling via a local area network and/or a wide area network). Further note that if the processing module, module, processing circuit, processing circuitry and/or processing unit implements one or more of its functions via a state machine, analog circuitry, digital circuitry, and/or logic circuitry, the memory and/or memory element storing the corresponding operational instructions may be embedded within, or external to, the circuitry comprising the state machine, analog circuitry, digital circuitry, and/or logic circuitry. Still further note that, the memory element may store, and the processing module, module, processing circuit, processing circuitry and/or processing unit executes, hard coded and/or operational instructions corresponding to at least some of the steps and/or functions illustrated in one or more of the Figures. Such a memory device or memory element can be included in an article of manufacture.

One or more embodiments have been described above with the aid of method steps illustrating the performance of specified functions and relationships thereof. The boundaries and sequence of these functional building blocks and method steps have been arbitrarily defined herein for convenience of description. Alternate boundaries and sequences can be defined so long as the specified functions and relationships are appropriately performed. Any such alternate boundaries or sequences are thus within the scope and spirit of the claims. Further, the boundaries of these functional building blocks have been arbitrarily defined for convenience of description. Alternate boundaries could be defined as long as the certain significant functions are appropriately performed. Similarly, flow diagram blocks may also have been arbitrarily defined herein to illustrate certain significant functionality.

To the extent used, the flow diagram block boundaries and sequence could have been defined otherwise and still perform the certain significant functionality. Such alternate definitions of both functional building blocks and flow diagram blocks and sequences are thus within the scope and spirit of the claims. One of average skill in the art will also recognize that the functional building blocks, and other illustrative blocks, modules and components herein, can be implemented as illustrated or by discrete components, application specific integrated circuits, processors executing appropriate software and the like or any combination thereof.

In addition, a flow diagram may include a “start” and/or “continue” indication. The “start” and “continue” indications reflect that the steps presented can optionally be incorporated in or otherwise used in conjunction with one or more other routines. In addition, a flow diagram may include an “end” and/or “continue” indication. The “end” and/or “continue” indications reflect that the steps presented can end as described and shown or optionally be incorporated in or otherwise used in conjunction with one or more other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

The one or more embodiments are used herein to illustrate one or more aspects, one or more features, one or more concepts, and/or one or more examples. A physical embodiment of an apparatus, an article of manufacture, a machine, and/or of a process may include one or more of the aspects, features, concepts, examples, etc. described with reference to one or more of the embodiments discussed herein. Further, from figure to figure, the embodiments may incorporate the same or similarly named functions, steps, modules, etc. that may use the same or different reference numbers and, as such, the functions, steps, modules, etc. may be the same or similar functions, steps, modules, etc. or different ones.

While the transistors in the above described figure(s) is/are shown as field effect transistors (FETs), as one of ordinary skill in the art will appreciate, the transistors may be implemented using any type of transistor structure including, but not limited to, bipolar, metal oxide semiconductor field effect transistors (MOSFET), N-well transistors, P-well transistors, enhancement mode, depletion mode, and zero voltage threshold (VT) transistors.

Unless specifically stated to the contra, signals to, from, and/or between elements in a figure of any of the figures presented herein may be analog or digital, continuous time or discrete time, and single-ended or differential. For instance, if a signal path is shown as a single-ended path, it also represents a differential signal path. Similarly, if a signal path is shown as a differential path, it also represents a single-ended signal path. While one or more particular architectures are described herein, other architectures can likewise be implemented that use one or more data buses not expressly shown, direct connectivity between elements, and/or indirect coupling between other elements as recognized by one of average skill in the art.

The term “module” is used in the description of one or more of the embodiments. A module implements one or more functions via a device such as a processor or other processing device or other hardware that may include or operate in association with a memory that stores operational instructions. A module may operate independently and/or in conjunction with software and/or firmware. As also used herein, a module may contain one or more sub-modules, each of which may be one or more modules.

As may further be used herein, a computer readable memory includes one or more memory elements. A memory element may be a separate memory device, multiple memory devices, or a set of memory locations within a memory device. Such a memory device may be a read-only memory, random access memory, volatile memory, non-volatile memory, static memory, dynamic memory, flash memory, cache memory, and/or any device that stores digital information. The memory device may be in a form a solid-state memory, a hard drive memory, cloud memory, thumb drive, server memory, computing device memory, and/or other physical medium for storing digital information.

While particular combinations of various functions and features of the one or more embodiments have been expressly described herein, other combinations of these features and functions are likewise possible. The present disclosure is not limited by the particular examples disclosed herein and expressly incorporates these other combinations.

One or more functions associated with the methods and/or processes described herein can be implemented via a processing module that operates via the non-human “artificial” intelligence (AI) of a machine. Examples of such AI include machines that operate via anomaly detection techniques, decision trees, association rules, expert systems and other knowledge-based systems, computer vision models, artificial neural networks, convolutional neural networks, support vector machines (SVMs), Bayesian networks, genetic algorithms, feature learning, sparse dictionary learning, preference learning, deep learning and other machine learning techniques that are trained using training data via unsupervised, semi-supervised, supervised and/or reinforcement learning, and/or other AI. The human mind is not equipped to perform such AI techniques, not only due to the complexity of these techniques, but also due to the fact that artificial intelligence, by its very definition — requires “artificial” intelligence —i.e. machine/non-human intelligence.

One or more functions associated with the methods and/or processes described herein can be implemented as a large-scale system that is operable to receive, transmit and/or process data on a large-scale. As used herein, a large-scale refers to a large number of data, such as one or more kilobytes, megabytes, gigabytes, terabytes or more of data that are received, transmitted and/or processed. Such receiving, transmitting and/or processing of data cannot practically be performed by the human mind on a large-scale within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can require data to be manipulated in different ways within overlapping time spans. The human mind is not equipped to perform such different data manipulations independently, contemporaneously, in parallel, and/or on a coordinated basis within a reasonable period of time, such as within a second, a millisecond, microsecond, a real-time basis or other high speed required by the machines that generate the data, receive the data, convey the data, store the data and/or use the data.

One or more functions associated with the methods and/or processes described herein can be implemented in a system that is operable to electronically receive digital data via a wired or wireless communication network and/or to electronically transmit digital data via a wired or wireless communication network. Such receiving and transmitting cannot practically be performed by the human mind because the human mind is not equipped to electronically transmit or receive digital data, let alone to transmit and receive digital data via a wired or wireless communication network.

One or more functions associated with the methods and/or processes described herein can be implemented in a system that is operable to electronically store digital data in a memory device. Such storage cannot practically be performed by the human mind because the human mind is not equipped to electronically store digital data.

One or more functions associated with the methods and/or processes described herein may operate to cause an action by a processing module directly in response to a triggering event — without any intervening human interaction between the triggering event and the action. Any such actions may be identified as being performed “automatically”, “automatically based on” and/or “automatically in response to” such a triggering event. Furthermore, any such actions identified in such a fashion specifically preclude the operation of human activity with respect to these actions — even if the triggering event itself may be causally connected to a human activity of some kind.

What is claimed is:

1. A method comprises:
obtaining, by a data input module of an analysis system, data gathering parameters regarding an analysis of a system, wherein the analysis system includes one or more computing entities;
identifying, by the data input module, a system aspect of the system from the data gathering parameters;
identifying, by the data input module, an evaluation viewpoint of desired for the system aspect from the data gathering parameters;
identifying, by a desired data generation module of the data input module, one or more types of proficiency data regarding the system aspect and the evaluation viewpoint of desired;
identifying, by the desired data generation module, one or more sources for retrieving the one or more types of proficiency data to produce source identification parameters;
establishing, by the desired data generation module, proficiency data retrieval parameters based on the one or more types of proficiency data and the source identification parameters;
obtaining, by the desired data generation module, proficiency data from the identified one or more sources based on the proficiency data retrieval parameters;
analyzing, by the desired data generation module, the proficiency data to determine relevant characteristics of the relevant proficiency data; and
generating, by the desired data generation module, desired data based on the relevant characteristics of the relevant proficiency data.

2. The method of claim 1, wherein the analyzing the proficiency data further comprises:
evaluating, by the desired data generation module, the proficiency data based on a range of analysis levels to determine whether the proficiency data is trustworthy; and
when the proficiency data is trustworthy:
generating, by the desired data generation module, the desired data.

3. The method of claim 2 further comprises:
when the proficiency data is not trustworthy:
modifying, by the desired data generation module, the source identification parameters to produce updated proficiency data retrieval parameters.

4. The method of claim 1, wherein the system aspect includes:
at least one system element of the system for the evaluation;
at least one system criteria of the system for the evaluation; and
at least one system mode of the system for the evaluation.

5. The method of claim 4 further comprises:
a system element of the at least one system element includes an enterprise identifier, an organization identifier, a division identifier, a department identifier, a group identifier, a subgroup identifier, a device identifier, a software identifier, or an internet protocol address identifier;
a system criteria of the at least one system criteria being system guidelines, system requirements, system design, system build, or resulting system; and
a system mode of the at least one system mode being assets, system functions, or system security.

6. The method of claim 1, wherein the one or more types of proficiency data include one or more of:
products regarding the system aspect;
services regarding the system aspect;
requirements regarding the system aspect;
regulations regarding the system aspect;
standards regarding the system aspect; and
protocols regarding the system aspect.

7. The method of claim 1, wherein one or more sources for retrieving the one or more types of proficiency data include one or more of:
one or more databases of the analysis system;
one or more computing devices associated with one or more systems;
one or more product suppliers;
one or more service suppliers;
one or more governmental bodies;
one or more standards bodies;
one or more forums; and
one or more industry publications.

8. The method of claim 1, wherein the relevant characteristics of the proficiency data include one or more of:
one or more product manual information regarding the system aspect;
one or more service manual information regarding the system aspect;
government laws regarding the system aspect;
government regulations regarding the system aspect;
government standards regarding the system aspect;
industry standards regarding the system aspect; and
industry protocols regarding the system aspect.

9. The method of claim 1, wherein the identifying the one or more types of proficiency data further comprises:
determining, by the desired data generation module, whether the one or more types of proficiency data are general or situational.

10. The method of claim 9 further comprises:
when the one or more types of proficiency data are general:
identifying, by the desired data generation module, one or more types of general proficiency data regarding the system aspect and the desired evaluation viewpoint;
identifying, by the desired data generation module, one or more general proficiency data sources for retrieving the one or more types of general proficiency data to produce general proficiency source identification parameters;
establishing, by the desired data generation module, general proficiency data retrieval parameters based on the one or more types of general proficiency data and the general proficiency source identification parameters;
obtaining, by the desired data generation module, general proficiency data based on the general proficiency data retrieval parameters; and
evaluating, by the desired data generation module, the general proficiency data; and when the general proficiency data is trustworthy:
generating, by the desired data generation module, general desired data for the system aspect from the general proficiency data.

11. The method of claim 9 further comprises:
when the one or more types of proficiency data are situational:
identifying, by the desired data generation module, one or more types of situational proficiency data regarding the system aspect and the desired evaluation viewpoint;
identifying, by the desired data generation module, one or more situational proficiency data sources for retrieving the one or more types of situational proficiency data to produce situational proficiency source identification parameters;
establishing, by the desired data generation module, situational proficiency data retrieval parameters based on the one or more types of situational proficiency data and the situational proficiency source identification parameters;
obtaining, by the desired data generation module, situational proficiency data based on the situational proficiency data retrieval parameters; and
evaluating, by the desired data generation module, the situational proficiency data; and when the situational proficiency data is trustworthy:
generating, by the desired data generation module, situational desired data for the system aspect from the situational proficiency data.

12. A computer readable memory comprises:
a first memory section for storing operational instructions that, when executed by a data input module of an analysis system, cause the data input module to:
obtain data gathering parameters regarding an analysis of a system, wherein the analysis system includes one or more computing entities;
identify a system aspect of the system from the data gathering parameters; and
identify an evaluation viewpoint of desired for the system aspect from the data gathering parameters;
a second memory section for storing operational instructions that, when executed by a desired data generation module of the data input module, cause the desired data generation module to:
identify one or more types of proficiency data regarding the system aspect and the evaluation viewpoint of desired;
identify one or more sources for retrieving the one or more types of proficiency data to produce source identification parameters; and
establish proficiency data retrieval parameters based on the one or more types of proficiency data and the source identification parameters;
a third memory section for storing operational instructions that, when executed by the desired data generation module, cause the desired data generation module to:
obtain proficiency data from the identified one or more sources based on the proficiency data retrieval parameters; and
a fourth memory section for storing operational instructions that, when executed by the desired data generation module, cause the desired data generation module to:
analyze the proficiency data to determine relevant characteristics of the relevant proficiency data; and
generate desired data based on the relevant proficiency data, wherein the desired data includes relevant characteristics of the relevant proficiency data.

13. The computer readable memory of claim 12, wherein the fourth memory section further stores operational instructions that, when executed by the desired data generation module, cause the desired data generation module to analyze the proficiency data by:
evaluating the proficiency data based on a range of analysis levels to determine whether the proficiency data is trustworthy; and
when the proficiency data is trustworthy:
generating the desired data.

14. The computer readable memory of claim 13, wherein the fourth memory section further stores operational instructions that, when executed by the desired data generation module, cause the desired data generation module to:
when the proficiency data is not trustworthy:
modify the source identification parameters to produce updated proficiency data retrieval parameters.

15. The computer readable memory of claim 12, wherein the system aspect includes:
at least one system element of the system for the evaluation;
at least one system criteria of the system for the evaluation; and
at least one system mode of the system for the evaluation.

16. The computer readable memory of claim 15 further comprises:
a system element of the at least one system element includes an enterprise identifier, an organization identifier, a division identifier, a department identifier, a group identifier, a subgroup identifier, a device identifier, a software identifier, or an internet protocol address identifier;
a system criteria of the at least one system criteria being system guidelines, system requirements, system design, system build, or resulting system; and
a system mode of the at least one system mode being assets, system functions, or system security.

17. The computer readable memory of claim 12, wherein the one or more types of proficiency data include one or more of:
products regarding the system aspect;
services regarding the system aspect;
requirements regarding the system aspect;
regulations regarding the system aspect;
standards regarding the system aspect; and
protocols regarding the system aspect.

18. The computer readable memory of claim 12, wherein one or more sources for retrieving the one or more types of proficiency data include one or more of:
one or more databases of the analysis system;
one or more computing devices associated with one or more systems;
one or more product suppliers;
one or more service suppliers;
one or more governmental bodies;
one or more standards bodies;
one or more forums; and
one or more industry publications.

19. The computer readable memory of claim 12, wherein the relevant characteristics of the proficiency data include one or more of:
one or more product manual information regarding the system aspect;
one or more service manual information regarding the system aspect;
government laws regarding the system aspect;
government regulations regarding the system aspect;
government standards regarding the system aspect;
industry standards regarding the system aspect; and
industry protocols regarding the system aspect.

20. The computer readable memory of claim 12, wherein the second memory section further stores operational instructions that, when executed by the desired data generation module, cause the desired data generation module to identify relevant characteristics of the proficiency data by:
determining whether the one or more types of proficiency data are general or situational.

21. The computer readable memory of claim 20 further comprises:
the second memory section further stores operational instructions that, when executed by the desired data generation module, cause the desired data generation module to:
when the one or more types of proficiency data are general:
identify one or more types of general proficiency data regarding the system aspect and the desired evaluation viewpoint;
identify one or more general proficiency data sources for retrieving the one or more types of general proficiency data to produce general proficiency source identification parameters;
establish general proficiency data retrieval parameters based on the one or more types of general proficiency data and the general proficiency source identification parameters;
the third memory section further stores operational instructions that, when executed by the desired data generation module, cause the desired data generation module to:
obtain general proficiency data based on the general proficiency data retrieval parameters; and
the fourth memory section further stores operational instructions that, when executed by the desired data generation module, cause the desired data generation module to:
evaluate the general proficiency data; and
when the general proficiency data is trustworthy:
generate general desired data for the system aspect from the general proficiency data.

22. The computer readable memory of claim 20 further comprises:
the second memory section further stores operational instructions that, when executed by the desired data generation module, cause the desired data generation module to:
when the one or more types of proficiency data are situational:
identify one or more types of situational proficiency data regarding the system aspect and the desired evaluation viewpoint;
identify one or more situational proficiency data sources for retrieving the one or more types of situational proficiency data to produce situational proficiency source identification parameters;
establish situational proficiency data retrieval parameters based on the one or more types of situational proficiency data and the situational proficiency source identification parameters;
the third memory section further stores operational instructions that, when executed by the desired data generation module, cause the desired data generation module to:
obtain situational proficiency data based on the situational proficiency data retrieval parameters; and
the fourth memory section further stores operational instructions that, when executed by the desired data generation module, cause the desired data generation module to:
evaluate the situational proficiency data; and
when the situational proficiency data is trustworthy:
generate situational desired data for the system aspect from the situational proficiency data.
